(19) United States
(12) Patent Application Publication
(10) Pub. No.: US 2022/0245154 A1
(43) Pub. Date: Aug. 4, 2022

(54) TECHNIQUES FOR MANAGING DATA IN A DATA PROCESSING SYSTEM USING DATA ENTITIES AND INHERITANCE

(71) Applicant: Ab Initio Technology LLC., Lexington, MA (US)

(72) Inventors: Halldor Isak Gylfason, Cambridge, MA (US); Robert Parks, Weston, MA (US); Dusan Radivojevic, North Andover, MA (US); Adam Harris Weiss, Lexington, MA (US)

(73) Assignee: Ab Initio Technology LLC., Lexington, MA (US)

(21) Appl. No.: 17/587,130

(22) Filed: Jan. 28, 2022

Related U.S. Application Data
(60) Provisional application No. 63/143,894, filed on Jan. 31, 2021.

(51) Int. Cl. G06F 16/2455; G06F 16/28; G06F 16/27

(52) U.S. Cl. CPC G06F 16/24564; G06F 16/27; G06F 16/288; G06F 16/285

(57) ABSTRACT

Techniques for storing data entities by a data processing system are described herein. The data processing system may store a plurality of data entity instances generated using a plurality of data entities. The plurality of data entity instances may include a first data entity instance generated using a first data entity and a second data entity instance generated using a second data entity. The first data entity instance may include a first attribute that is configured to inherit its value from a second attribute of the second data entity instance. The data processing system may provide the inherited value of the second attribute of the second data entity instance as the value of the first attribute of the first data entity instance.

### CROSS-REFERENCE TO RELATED APPLICATIONS

The present application claims the benefit of priority under 35 U.S.C. 119(e) to U.S. Provisional Patent Application No. 63/143,894; filed on Jan. 31, 2021, and titled “Techniques for Managing Data in a Data Processing System Using Data Entities and Inheritance”, which is hereby incorporated by reference herein in its entirety.

### FIELD

Aspects of the present disclosure relate to techniques for managing data in a data processing system using data entities and data entity instances. In particular, aspects of the present disclosure relate to efficiently storing and accessing data entity instances using inheritance.

### BACKGROUND

Modern data processing systems manage vast amounts of data (e.g., millions, billions, or trillions of data records) and manage how these data may be accessed (e.g., created, updated, read, or deleted). The data managed by a data processing system may be of any suitable type. For example, the data managed by the data processing system may include transactions, documents, tables, files, or any other suitable type of data. As another example, the data managed by the data processing system may include “metadata” which is data that contains information about other data (e.g., stored in the same data processing system and/or another data processing system). For example, a data processing system may store metadata about credit card transaction data stored in a table of a credit card company's database. Non-limiting examples of such metadata include information indicating the size of the table in memory, when the table was created, when the table was last updated, the number of rows and/or columns in the table, where the table is stored, who has permission to read, update, delete or perform any other suitable action(s) with respect to the data table.

### SUMMARY

Some embodiments provide for a method performed by a data processing system for accessing data according to inheritance relationships among attributes of data entities, where such inheritance can be overridden. The method comprises: using at least one computer hardware processor of the data processing system to perform: receiving a request to access a first attribute value of a particular instance of a first data entity, wherein: the first data entity comprises a plurality of attributes including the first attribute, the particular instance comprises a value for zero, one, or more of the plurality of attributes of the first data entity, and the first attribute of the particular instance is configured to inherit its value from a second attribute of another instance of a second data entity different from the first data entity; determining whether the first attribute of the particular instance is configured to override the value inherited from the second attribute; when it is determined that the first attribute is configured to override the value inherited from the second attribute: accessing an overriding value for overriding the value inherited from the second attribute; generating a first response to the request that includes information indicating the overriding value as the first attribute value; and outputting the first response; and when it is determined that the first attribute is not configured to override the value inherited from the second attribute: accessing the value inherited from the second attribute; generating a second response to the request that includes information indicating the value inherited from the second attribute as the first attribute value; and outputting the second response.

Some embodiments provide for a non-transitory transitory computer-readable medium storing instructions that, when executed by a data processing system, cause the data processing system to perform a method for accessing data according to inheritance relationships among attributes of data entities, where such inheritance can be overridden. The method comprises: receiving, by the data processing system, a request to access a first attribute value of a particular instance of a first data entity, wherein: the first data entity comprises a plurality of attributes including the first attribute, the particular instance comprises a value for zero, one, or more of the plurality of attributes of the first data entity, and the first attribute of the particular instance is configured to inherit its value from a second attribute of another instance of a second data entity different from the first data entity; determining whether the first attribute of the particular instance is configured to override the value inherited from the second attribute; when it is determined that the first attribute is configured to override the value inherited from the second attribute: accessing an overriding value for overriding the value inherited from the second attribute; generating a first response to the request that includes information indicating the overriding value as the first attribute value; and outputting the first response; and when it is determined that the first attribute is not configured to override the value inherited from the second attribute: accessing the value inherited from the second attribute; generating a second response to the request that includes information indicating the value inherited from the second attribute as the first attribute value; and outputting the second response.

Some embodiments provide for a data processing system for accessing data according to inheritance relationships among attributes of data entities, where such inheritance can be overridden. The data processing system comprises: at least one computer hardware processor; and at least one non-transitory computer-readable medium storing instructions that, when executed by the at least one computer hardware processor, cause the at least one computer hardware processor to perform a method comprising: receiving a request to access a first attribute value of a particular instance of a first data entity, wherein: the first data entity comprises a plurality of attributes including the first attribute, the particular instance comprises a value for zero, one, or more of the plurality of attributes of the first data entity, and the first attribute of the particular instance is configured to inherit its value from a second attribute of another instance of a second data entity different from the first data entity; determining whether the first attribute of the particular instance is configured to override the value inherited from the second attribute; when it is determined that the first attribute is configured to override the value inherited from the second attribute: accessing an overriding value for overriding the value inherited from the second attribute; generating a first response to the request that includes information indicating the overriding value as the first attribute value; and outputting the first response; and when it is determined that the first attribute is not configured to override the value inherited from the second attribute: accessing the value inherited from the second attribute; generating a second response to the request that includes information indicating the value inherited from the second attribute as the first attribute value; and outputting the second response.

In some embodiments, the first data entity includes information indicating: (i) that the first attribute inherits its value from the second attribute; and (ii) whether the first attribute is configurable to override its inherited value.

In some embodiments, the data processing system comprises at least one data store configured to store instances of the data entities, the instances of the data entities including the particular instance and the other instance; and the request comprises an executable query. In some embodiments, the executable query comprises an executable structured query language (SQL) query.

In some embodiments, the particular instance comprises multiple attribute values, wherein each of at least some of the multiple attribute values is inherited from a respective instance of a different data entity.

In some embodiments, the second attribute of the other instance is configured to inherit its value from a third attribute of an instance of a third data entity different from the second data entity and the first data entity.

In some embodiments, accessing the value inherited from the second attribute comprises: determining whether the second attribute of the other instance is configured to override the value inherited from the third attribute; and when it is determined that the second attribute of the other instance is configured to override the value inherited from the third attribute: accessing another overriding value for overriding the value inherited from the third attribute as the value inherited from the second attribute; and when it is determined that the second attribute of the other instance is not configured to override the value inherited from the third attribute: accessing the value inherited by the second attribute from the third attribute.

In some embodiments, the outputting comprises: generating a graphical user interface (GUI) that displays: the first attribute value; and information indicating whether the first attribute value is inherited.

In some embodiments, the particular instance includes respective values for a first plurality of attributes including the first attribute, the first plurality of attributes being configured to inherit their values from a respective second plurality of attributes of the other instance, wherein the request comprises a request to access the values of the first plurality of attributes, and wherein the method further comprises: grouping the first plurality of attributes into a single group; and generating a single executable query for the single group in accordance with the request, wherein the single executable query, when executed by the data processing system, causes the data processing system to generate a response to the request.

In some embodiments, grouping the first plurality of attributes into the single group comprises grouping the first plurality of attributes into the single group using a grouping criterion. In some embodiments, the grouping criterion is to group attributes that inherit values from a common instance into the single group.

In some embodiments, the data processing system comprises at least one data store configured to store information defining relationships among multiple data entity instances.

In some embodiments, the data processing system manages the data, wherein the data managed by the data processing system comprises information describing data stored in distributed databases of a distributed network of computing systems. In some embodiments, the data processing system is configured to store an instance for each of multiple datasets stored by the distributed databases of the distributed computing system and/or for each of multiple software applications configured to be executed by the distributed computing systems.

In some embodiments, the method further comprises: generating a first portion of a graphical user interface (GUI) indicating the first attribute value; setting the first attribute value indicated by the GUI to the second attribute value; and displaying the GUI.

In some embodiments, the method further comprises: determining whether the first attribute is configurable to override its inherited value; and generating a second portion of the GUI indicating that the first attribute is configurable to override its inherited value when it is determined that the first attribute is configurable to override its inherited value. In some embodiments, generating the second portion of the GUI comprises: enabling a user to specify, through the second portion of the GUI, the overriding value for overriding the value inherited from the second attribute. In some embodiments, the method further comprises: generating a second portion of the GUI indicating that the first attribute is not configurable to override its inherited value when it is determined that the first attribute is not configurable to override its inherited value.

In some embodiments, the method further comprises: preventing overriding of the value inherited from the second attribute of the other instance.

In some embodiments, the method further comprises: generating a GUI allowing a user to configure the first data entity such that the first attribute inherits its value from the second attribute.

In some embodiments, the method further comprises generating a GUI displaying information indicating a source of the first attribute value. In some embodiments, the GUI is configured to display the information indicating the source of the first attribute value in response to a mouse-over event. In some embodiments, the information indicating the source of the first attribute value indicates that the source is the second attribute of the other instance or that the source is an overriding value.

Some embodiments provide for a method performed by a data processing system for accessing data according to inheritance relationships among attributes of data entities. The method comprises: using at least one computer hardware processor of the data processing system to perform: receiving a request to access a first attribute value in a particular instance of a first data entity, wherein: the first data entity comprises a plurality of attributes including the first attribute; and the particular instance comprises a value for zero, one, or more of the plurality of attributes of the first data entity; determining that the first attribute of the particular instance is configured to inherit its value from a second attribute of another instance of a second data entity different from the first data entity; accessing the value inherited from the second attribute; generating a response to the request that includes information indicating the value inherited from the second attribute as the first attribute value; and outputting the generated response.

Some embodiments provide for a non-transitory computer-readable medium storing instructions that, when executed by a data processing system, cause the data processing system to perform a method for accessing data according to inheritance relationships among attributes of data entities. The method comprises: receiving, by the data processing system, a request to access a first attribute value in a particular instance of a first data entity, wherein: the first data entity comprises a plurality of attributes including the first attribute; and the particular instance comprises a value for zero, one, or more of the plurality of attributes of the first data entity; determining that the first attribute of the particular instance is configured to inherit its value from a second attribute of another instance of a second data entity different from the first data entity; accessing the value inherited from the second attribute; generating a response to the request that includes information indicating the value inherited from the second attribute as the first attribute value; and outputting the generated response.

Some embodiments provide for a data processing system for accessing data according to inheritance relationships among attributes of data entities. The data processing system comprises: at least one computer hardware processor; and at least one non-transitory computer-readable medium storing instructions that, when executed by the at least one computer hardware processor, cause the at least one computer hardware processor to perform a method comprising: receiving a request to access a first attribute value in a particular instance of a first data entity, wherein: the first data entity comprises a plurality of attributes including the first attribute; and the particular instance comprises a value for zero, one, or more of the plurality of attributes of the first data entity; determining that the first attribute of the particular instance is configured to inherit its value from a second attribute of another instance of a second data entity different from the first data entity; accessing the value inherited from the second attribute; generating a response to the request that includes information indicating the value inherited from the second attribute as the first attribute value; and outputting the generated response.

In some embodiments, determining that the first attribute of the particular instance is configured to inherit from the second attribute comprises using the first data entity to determine that the first attribute is configured to inherit its value from the second attribute.

In some embodiments, the method further comprises: receiving, by the data processing system, a request to access a third attribute value in the particular instance determining that the third attribute of the particular instance is configured to inherit its value from a fourth attribute of an instance of a third data entity different from the first data entity and the second data entity; accessing the value inherited from the fourth attribute; generating a response to the request that includes information indicating the value inherited from the fourth attribute as the third attribute value; and outputting the generated response.

In some embodiments, accessing the value inherited from the second attribute comprises: determining that the second attribute of the second data entity instance is configured to inherit its value from a third attribute of an instance of a third data entity different from the first data entity and the second data entity; and accessing the value inherited by the second attribute from the third attribute.

In some embodiments, the particular instance includes respective values for a first plurality of attributes including the first attribute, the first plurality of attributes being configured to inherit their values from a respective second plurality of attributes of the other instance, wherein the request comprises a request to access the values of the first plurality of attributes, and wherein the method further comprises: grouping the first plurality of attributes into a single group; and generating a single executable query for the single group in accordance with the request, wherein the single executable query, when executed by the data processing system, causes the data processing system to generate a response to the request.

In some embodiments, grouping the first plurality of attributes into the single group comprises grouping the first plurality of attributes into the single group using a grouping criterion. In some embodiments, the grouping criterion is to group attributes that inherit values from a common instance into the single group.

In some embodiments, the data processing system manages the data, wherein the data managed by the data processing system comprises information describing data stored in distributed databases of a distributed network of computing systems.

In some embodiments, the data processing system is configured to store an instance for each of multiple datasets stored by the distributed databases of the distributed computing system and/or for each of multiple software applications configured to be executed by the distributed computing systems.

Some embodiments provide for a method for obtaining information about data entity instances from a data processing system. The data processing system is configured to store a plurality of data entity instances, the plurality of data entity instances including a first data entity instance having a first plurality of attributes including a first attribute and a second data entity instance having a second plurality of attributes including a second attribute. The method comprises: using at least one computer hardware processor to perform: obtaining a request to obtain information about the first data entity instance, the information including a first value of the first attribute of the first data entity instance, the first attribute of the first data entity instance being configured to inherit its value from the second attribute of the second data entity instance; generating a response to the request, the response including the first value of the first attribute, the generating comprising: determining whether the first attribute of the first data entity instance is configured to override a second value of the second attribute of the second data entity instance; when it is determined that the first attribute is configured to override the second value of the second attribute, accessing an overriding value, and generating the response to include the overriding value as the first value of the first attribute, and when it is determined that the first attribute is not configured to override the second value of the second attribute, accessing the second value of the second attribute, and generating the response to include the second value as the first value of the first attribute; and outputting the generated response.

Some embodiments provide for a data processing system configured to store a plurality of data entity instances, the plurality of data entity instances including a first data entity instance having a first plurality of attributes including a first attribute and a second data entity instance having a second plurality of attributes including a second attribute. The data processing system comprises: at least one processor; and at least one non-transitive computer-readable storage medium storing instructions that, when executed by the at least one processor, cause the at least one processor to perform a method comprising: obtaining a request to obtain information about the first data entity instance, the information including a first value of the first attribute of the first data entity instance, the first attribute of the first data entity instance being configured to inherit its value from the second attribute of the second data entity instance; generating a response to the request, the response including the first value of the first attribute, the generating comprising: determining whether the first attribute of the first data entity instance is configured to override a second value of the second attribute of the second data entity instance; when it is determined that the first attribute is configured to override the second value of the second attribute, accessing an overriding value, and generating the response to include the overriding value as the first value of the first attribute, and when it is determined that the first attribute is not configured to override the second value of the second attribute, accessing the second value of the second attribute, and generating the response to include the second value as the first value of the first attribute; and outputting the generated response.

Some embodiments provide for a non-transitory computer-readable storage medium storing instructions. When executed by at least one processor of a data processing system configured to store a plurality of data entity instances, the plurality of data entity instances including a first data entity instance having a first plurality of attributes including a first attribute and a second data entity instance having a second plurality of attributes including a second attribute, cause the at least one processor to perform a method comprising: obtaining a request to obtain information about the first data entity instance, the information including a first value of the first attribute of the first data entity instance, the first attribute of the first data entity instance being configured to inherit its value from the second attribute of the second data entity instance; generating a response to the request, the response including the first value of the first attribute, the generating comprising: determining whether the first attribute of the first data entity instance is configured to override a second value of the second attribute of the second data entity instance; when it is determined that the first attribute is configured to override the second value of the second attribute, accessing an overriding value, and generating the response to include the overriding value as the first value of the first attribute, and when it is determined that the first attribute is not configured to override the second value of the second attribute, accessing the second value of the second attribute, and generating the response to include the second value as the first value of the first attribute; and outputting the generated response.

Some embodiments provide for a method for obtaining information about data entity instances from a data processing system. The data processing system is configured to store a plurality of data entity instances, the plurality of data entity instances including a first data entity instance having a first plurality of attributes including a first attribute and a second data entity instance having a second plurality of attributes including a second attribute. The method comprises: using at least one computer hardware processor to perform: obtaining a request for a first value of the first attribute of the first data entity instance, the first attribute of the first data entity being configured to inherit its value from the second attribute of the second data entity instance; generating a response to the request, the response including the first value of the first attribute, the generating comprising: accessing a second value of the second attribute; and generating the response to include the second value of the second attribute as the first value of the first attribute; and outputting the generated response.

Some embodiments provide for a data processing system configured to store a plurality of data entity instances, the plurality of data entity instances including a first data entity instance having a first plurality of attributes including a first attribute and a second data entity instance having a second plurality of attributes including a second attribute. The data processing system comprises: at least one processor; and at least one non-transitive computer-readable storage medium storing instructions that, when executed by the at least one processor, cause the at least one processor to perform: obtaining a request for a first value of the first attribute of the first data entity instance, the first attribute of the first data entity being configured to inherit its value from the second attribute of the second data entity instance; generating a response to the request, the response including the first value of the first attribute, the generating comprising: accessing a second value of the second attribute; and generating the response to include the second value of the second attribute as the first value of the first attribute; and outputting the generated response.

Some embodiments provide for a non-transitory computer-readable storage medium storing instructions. When executed by at least one processor of a data processing system configured to store a plurality of data entity instances, the plurality of data entity instances including a first data entity instance having a first plurality of attributes including a first attribute and a second data entity instance having a second plurality of attributes including a second attribute, cause the at least one processor to perform: obtaining a request to obtain information about the first data entity instance, the information including a first value of the first attribute of the first data entity instance, the first attribute of the first data entity instance being configured to inherit its value from the second attribute of the second data entity instance; generating a response to the request, the response including the first value of the first attribute, the generating comprising: determining whether the first attribute of the first data entity instance is configured to override a second value of the second attribute of the second data entity instance; when it is determined that the first attribute is configured to override the second value of the second attribute, accessing an overriding value, and generating the response to include the overriding value as the first value of the first attribute, and when it is determined that the first attribute is not configured to override the second value of the second attribute, accessing the second value of the second attribute, and generating the response to include the second value as the first value of the first attribute; and outputting the generated response.

Some embodiments provide for a method for obtaining information about data entity instances from a data processing system. The data processing system is configured to store a plurality of data entity instances, the plurality of data entity instances including a first data entity instance having a first plurality of attributes including a first attribute and a second data entity instance having a second plurality of attributes including a second attribute. The method comprises: using at least one hardware processor to perform: generating a graphical user interface (GUI) containing information about the first data entity instance, the generating comprising: generating a first GUI portion indicating a first value of the first attribute of the first data entity instance, the first attribute of the first data entity instance being configured to inherit its value from the second value of the second data entity instance, the generating comprising: accessing a second value of the second attribute, and setting the first value of the first attribute to the second value; generating a second GUI portion to indicate whether the first attribute is configurable to override its inherited value; and displaying the GUI.

Some embodiments provide for a data processing system. The data processing system is configured to store a plurality of data entity instances, the plurality of data entity instances including a first data entity instance having a first plurality of attributes including a first attribute and a second data entity instance having a second plurality of attributes including a second attribute. The data processing system comprises: at least one processor; and at least one non-transitory computer-readable storage medium storing instructions that, when executed by the at least one processor, cause the at least one processor to perform: generating a graphical user interface (GUI) containing information about the first data entity instance, the generating comprising: generating a first GUI portion indicating a first value of the first attribute of the first data entity instance, the first attribute of the first data entity instance being configured to inherit its value from the second value of the second data entity instance, the generating comprising: accessing a second value of the second attribute, and setting the first value of the first attribute to the second value; generating a second GUI portion to indicate whether the first attribute is configurable to override its inherited value; and displaying the GUI.

Some embodiments provide for a non-transitory computer-readable storage medium storing instructions. When the instructions are executed by at least one processor of a data processing system configured to store a plurality of data entity instances, the plurality of data entity instances including a first data entity instance having a first plurality of attributes including a first attribute and a second data entity instance having a second plurality of attributes including a second attribute, cause the at least one processor to perform: generating a graphical user interface (GUI) containing information about the first data entity instance, the generating comprising: generating a first GUI portion indicating a first value of the first attribute of the first data entity instance, the first attribute of the first data entity instance being configured to inherit its value from the second value of the second data entity instance, the generating comprising: accessing a second value of the second attribute, and setting the first value of the first attribute to the second value; generating a second GUI portion to indicate whether the first attribute is configurable to override its inherited value; and displaying the GUI.

The foregoing is a non-limiting summary of the invention, which is defined by the attached claims.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A is a diagram illustrating an example enterprise system environment in which a data processing system 105 may be used, in accordance with some embodiments of the technology described herein.

FIG. 1B is a diagram illustrating an example implementation of the data processing system 105, in accordance with some embodiments of the technology described herein.

FIG. 1C is a graphical user interface (GUI) illustrating an example instance “Credit Score” 158, in accordance with some embodiments of the technology described herein.

FIG. 1D is a diagram illustrating a data entity 170 that may be used by data processing system 105, in accordance with some embodiments of the technology described herein.

FIG. 1E is a diagram illustrating example data stored in the data persistence layer 150 of the data processing system 105, in accordance with some embodiments of the technology described herein.

FIG. 1F is a diagram illustrating inheritance of an attribute value from data entity instance 159A by data entity instances 158 and 161A, in accordance with some embodiments of the technology described herein.

FIG. 1G is a diagram illustrating an override of an attribute value inherited by a data entity instance 161B from data entity instance 159A, in accordance with some embodiments of the technology described herein.

FIG. 1H is a block diagram illustrating aspects of the data processing system 105, in accordance with some embodiments of the technology described herein.

FIG. 2A is a diagram illustrating a data entity 210 with attributes configured to inherit values from data entity 220, in accordance with some embodiments of the technology described herein.

FIG. 2B is a diagram illustrating an override of a value inherited by an attribute of data entity 210 of FIG. 2A, in accordance with some embodiments of the technology described herein.

FIG. 2C is a diagram illustrating an example of the data entity instance “Credit Score” 158 with attributes configured to inherit values from another data entity instance “Credit Risk” 270, in accordance with some embodiments of the technology described herein.

FIG. 2D is a diagram illustrating overriding of values inherited by attributes of the data entity instance “Credit Score” 158, in accordance with some embodiments of the technology described herein.

FIG. 3A is a flowchart of an illustrative process 300 for generating a response to a request to obtain information about a data entity instance, in accordance with some embodiments of the technology described herein.

FIG. 3B is a flowchart of an illustrative process 350 for generating a graphical user interface (GUI) displaying information about a data entity instance, in accordance with some embodiments of the technology described herein.

FIG. 3C is a flowchart of an illustrative process 370 for generating a response to a request for an attribute value of a data entity instance inherited from another data entity instance, in according with some embodiments of the technology described herein.

FIG. 4A is an illustration of a GUI displaying information about the instance “Credit Score” 402 of the data entity “Business Term” 404, in accordance with some embodiments of the technology described herein.

FIG. 4B is an illustration of a GUI displaying information about a data entity instance “Credit Risk” 412 from which attributes of the data entity instance “Credit Score” 402 of FIG. 4A inherits values, in accordance with some embodiments of the technology described herein.

FIG. 4C is an illustration of a GUI for configuring attributes of the data entity “BizTerm” 404 of which “Credit Score” 402 is an instance, in accordance with some embodiments of the technology described herein.

FIG. 4D is an illustration of the GUI 400 of FIG. 4A with a portion 422 indicating information about an attribute of the data entity instance “Credit Score” 402 that inherits its value, in accordance with some embodiments of the technology described herein.

FIG. 4E is an illustration of a GUI portion 430 indicating whether attributes of the data entity instance “Credit Score” 402 of FIG. 4A are configurable to override their inherited values, in accordance with some embodiments of the technology described herein.

FIG. 4F is another illustration of a GUI portion 440 indicating whether attributes of the data entity instance “Credit Score” 402 of FIG. 4A are configurable to override their inherited values, in accordance with some embodiments of the technology described herein.

FIG. 4G is an illustration of a GUI portion 450 indicating information about the source from which an attribute of the data entity instance “Credit Score” 402 of FIG. 4A is configured to inherit its value, in accordance with some embodiments of the technology described herein.

FIG. 5A is a diagram illustrating attribute value inheritance paths among a set of three data entity instances 500, 158, 520, in accordance with some embodiments of the technology described herein.

FIG. 5B is a diagram illustrating an override of a value inherited by an attribute of a data entity instance 500 of FIG. 5A, in accordance with some embodiments of the technology described herein.

FIG. 5C is a diagram illustrating an override of a value inherited by an attribute of a data entity instance 158 of FIG. 5A, in accordance with some embodiments of the technology described herein.

FIG. 6A is an illustration of a GUI 600 displaying information about an instance “Customer Credit Score” 602 of the “Business Data Element” data entity, in accordance with some embodiments of the technology described herein.

FIG. 6B is an illustration of a GUI 620 displaying information about a configuration of attributes of the “Business Data Element” data entity of FIG. 6A, in accordance with some embodiments of the technology described herein.

FIG. 6C is an illustration of a GUI 630 displaying information about a first attribute of the data entity instance “Customer Credit Score” 602 of FIG. 6A that inherits its value from the data entity instance “Credit Score”, in accordance with some embodiments of the technology described herein.

FIG. 6D is an illustration of a GUI 640 displaying information about a second attribute of the data entity instance “Customer Credit Score” 602 of FIG. 6A that inherits its value from the data entity instance “Credit Risk”, in accordance with some embodiments of the technology described herein.

FIG. 7A is a diagram illustrating that different attributes of a data entity may inherit their values from respective attributes of different data entities, in accordance with some embodiments of the technology described herein.

FIG. 7B is a diagram illustrating example queries for accessing values of inherited attributes sharing a common inheritance path, in accordance with some embodiments of the technology described herein.

FIG. 8 is a block diagram of an illustrative computing system environment that may be used in implementing some embodiments of the technology described herein.

### DETAILED DESCRIPTION

The inventors have developed new techniques that allow for efficiently storing and accessing (e.g., querying, creating, updating, and deleting) data that is managed by a data processing system using data entities and instances thereof. As described herein, in some embodiments, a data processing system may manage data using data entities, which may be used to organize the data using an object-oriented paradigm. A data entity may specify attributes, which may take on different values such as numbers, strings, or references to other data entities when instantiated. One or more data entity instances may be instantiated from a data entity, and used to store data. For example, a data processing system for a bank may include a credit score data entity for storing information about customer credit scores. In this example, the credit score data entity may specify attributes such as a credit score value, a credit score agency, a credit score definition, and/or other attributes. The data processing system may instantiate multiple (e.g., hundreds, thousands, or millions) of instances of the credit score data entity to store credit score information for their customers as values of the attributes specified by the credit score data entity. Accordingly, similar to how object-oriented programming involves classes and instances thereof, a data processing system may be configured with definitions of data entities and manage data using instances of the data entities. Some of the techniques developed by the inventors allow for efficient storage of attribute values in data entity instances and efficient retrieval of attribute values (e.g., to provide information requested about data entity instances).

A data entity instance may not be required to store all its attribute values together. In some embodiments, attribute values of a data entity instance may be stored using one or multiple data structures. For example, attribute values may be stored using one or more tables, records, lists, or any other suitable data structures, as aspects of the technology described herein do not require values of a particular data entity instance to be stored using the same underlying data structure in memory.

As described herein, a data processing system may be used for managing many different types of data. For example, in some applications, a data processing system may be used for metadata management. In such applications, data entity instances instantiated from respective data entities may store information (“metadata”) about other data. For example, the data entity instances may store metadata about data of an enterprise system (e.g., for a large multi-national corporation such as a credit card company, a phone company, a bank, etc.). In such applications, the data of the enterprise system may include millions or billions of datasets (e.g., tables, documents, records, etc.) deployed across multiple databases, data warehouses, data lakes, etc. Thus, the data processing system may manage a large amount (e.g., millions or billions) of data entity instances that contain metadata about the datasets. Although examples described herein may refer to metadata management, it should be appreciated that techniques developed by the inventors and described herein are not limited to being applied to any particular type of data and may be used within any data processing system using data entities and data entity instances instantiated from the data entities to manage data irrespective of whether the managed data is metadata or any other type of data (e.g., transactions, files, data records, tables, etc.).

The inventors have recognized that given the large numbers (e.g., millions) of data entity instances that are to be managed (e.g., created, stored, updated, etc.) by a data processing system in some applications it is important to store and access data efficiently. Writing data to each and every data entity instance, whether done manually or programmatically, is inefficient. Conventional data processing systems may populate each of the data entity instances by requiring repeated writing of the same information into each of the data entity instances. Moreover, to retrieve the same shared information from the data entity instances, conventional data processing systems may need to separately access each of the data entity instances. Thus, conventional data processing systems may store data in data entity instances inefficiently, and retrieve information about data entity instances inefficiently. For example, conventional data processing systems may execute queries for storing data in data entity instances and/or for reading data from data entity instances inefficiently.

The inventors have further recognized that many of the data entity instances managed by the data processing system may store similar information. For example, where a data processing system manages instances of a credit score data entity storing metadata about credit scores from different respective credit agencies, the data entity instances may each store an identity of a user who manages a dataset that the credit scores are stored in. The dataset may include other information in addition to the credit score information that is stored in instances of another data entity. Thus, the credit score data entity instances and the instances of the other data entity may all store the same value of a user identity attribute. In another example, where a data processing system manages data entity instances storing metadata about customer information from a particular geographic region, the data entity instances may each store a string identifying the geographic region (e.g., “USA” or “Europe”). Instances of another data entity storing information associated with the same geographic region may also store the same string for a geographic region attribute.

To address the above-described challenges of efficiently storing and retrieving information about data entity instances instantiated from one or more data entities, the inventors have developed techniques for allowing attributes of data entity instances to take on or inherit values of attributes of other data entity instances. To this end, the data processing system may configure one or more attributes of a data entity to inherit values in an instance of the data entity from an instance of another data entity. Thus, the data processing system may: (1) use a value stored in a first data entity instance to set values of attributes of one or more other data entity instances managed by the data processing system; and (2) retrieve the value from the first data entity instance for requests for information about the other data entity instance(s). In this way, inheritance allows the data processing system to efficiently store and retrieve attribute values for large numbers (e.g., thousands, millions, or billions) of data entity instances. For example, inheritance allows the data processing system to more efficiently execute queries for storing and/or retrieving attribute values. Furthermore, inheritance allows the data processing system to use memory more efficiently by storing information shared by multiple data entity instances in a single data entity instance and referencing that information in other data entity instances. In this manner, techniques described herein improve conventional data processing systems by both: (1) reducing computing resources (e.g., processor resources, network bandwidth, etc.) needed to write information into data entity instances and retrieve information about data entity instances; and (2) reducing the amount of memory used to store information in the data entity instances.

The inheritance techniques developed by the inventors for use in a data processing system allow the data processing system to quickly access information about data entity instances managed by the data processing system. Accordingly, some embodiments provide a technique for obtaining information about data entity instances of a data processing system. The data entity instances may include a first data entity instance (e.g., “Credit Score”) having a first plurality of attributes including a first attribute (e.g., an accountable party for credit score data) and a second data entity instance (e.g., “Customer Information”) having a second plurality of attributes including a second attribute (e.g., an accountable party for the data stored in customer data). The data processing system may be configured to access data according to inheritance relationships among attributes of data entities. The data processing system may be configured to receive a request to access a first attribute value in a particular instance of a first data entity, wherein: the first data entity comprises a plurality of attributes including the first attribute; and the particular instance comprises a value for zero, one, or more of the plurality of attributes of the first data entity. The data processing system may be configured to: (1) determine that the first attribute of the particular instance is configured to inherit its value from a second attribute of another instance of a second data entity different from the first data entity; (2) access the value inherited from the second attribute; (3) generate a response to the request that includes information indicating the value inherited from the second attribute as the first attribute value; and (4) output the generated response.

In some embodiments, the data processing system may be configured to: (1) receive a request to access a third attribute value in the particular instance; (2) determine that the third attribute of the particular instance is configured to inherit its value from a fourth attribute of an instance of a third data entity different from the first data entity and the second data entity; (3) access the value inherited from the fourth attribute; (4) generate a response to the request that includes information indicating the value inherited from the fourth attribute as the third attribute value; and (5) output the generated response. In some embodiments, accessing the value inherited from the second attribute comprises: (1) determining that the second attribute of the second data entity instance is configured to inherit its value from a third attribute of an instance of a third data entity different from the first data entity and the second data entity; and (2) accessing the value inherited by the second attribute from the third attribute.

In some embodiments, determining that the first attribute of the particular instance is configured to inherit from the second attribute comprises using the first data entity to determine that the first attribute is configured to inherit its value from the second attribute.

In some embodiments, the data processing system may be configured to: (1) obtain a request for a first value of the first attribute of the first data entity instance, the first attribute configured to inherit its value from the second attribute of the second data entity; (2) generate a response to the request that includes the first value of the first attribute; and (3) output the response. The data processing system may be configured to generate the response to the request by: (1) accessing a second value of the second attribute; and (2) generating the response to include the second value of the second attributes as the first value of the first attribute. For example, the data processing system may access the name of the accountable party stored in a “Customer Information” data entity instance and generate the response to include the name as the value of the accountable party of a “Credit Score” data entity instance.

In some embodiments, the data processing system may be configured to instantiate the first data entity instance (e.g., “Credit Score”) from a first data entity and the second data entity instance (e.g., “Customer Information”) from a second data entity. The first data entity may specify the first attribute which takes on values in instances of the first data entity, and the second data entity may specify the second attribute which takes on values in instances of the second data entity. The data processing system may be configured to configure the first data entity to specify inheritance of the first attribute of the first data entity from the second attribute of the second data entity (e.g., by storing configuration information in the first data entity that references the second attribute of the second data entity). Based on the configuration information in the first data entity, the data processing system may configure the first data entity instance (e.g., “Credit Score”) to inherit a value of the first attribute from the second attribute of the second data entity instance (e.g., “Customer Information”). In some embodiments, the data processing system may be configured to store, in the first data entity instance, a reference to the second attribute of the second data entity instance. The first data entity instance may thus not store a value of the first attribute in the first data entity instance, and instead store the reference to the second attribute of the second data entity instance.

In some embodiments, the data processing system may comprise at least one data store configured to store the plurality of data entity instances and associated values (e.g., attribute values). The request may be an executable query that, when executed by the data processing system, causes the data processing system to generate the response to the request. In some embodiments, the executable query may be a structured query language (SQL) query or any other type of executable query. In some embodiments, the request may be a programmatic request, made by a computer program being executed by the data processing system, to access the first value of the first attribute.

In some embodiments, the plurality of data entity instances may include a third data entity instance that has a third plurality of attributes including a third attribute. The second attribute of the second data entity instance may be configured to inherit its value from the third attribute of the third data entity instance. Thus, the first data entity instance may be configured to inherit the first value of the first attribute from the third attribute of the third data entity instance through the second attribute of the second data entity instance.

In some embodiments, the data processing system may be configured to generate a graphical user interface (GUI) display that displays the first value of the first attribute of the first data entity instance, and information indicating whether the first value is inherited. For example, the information may include an indication of the second data entity instance from which the first value of the first attribute is inherited. The information indicating whether the first value is inherited may inform the user of the source of the first value of the first attribute. The information may allow the user to determine a relationship between the first data entity instance and the second data entity instance.

The inventors have further recognized that, although inheritance in a data processing system provides more efficient storage of data and access to information about data entity instances, there may be times when an attribute of data entity instance needs to take on a value different from one it is configured to inherit from another data entity instance. For example, a data entity instance storing validation rules for credit scores in the United States may need to store a different rule than one inherited from a data entity instance storing validation rules for credit scores in Europe. Accordingly, the inheritance architecture may restrict flexibility in setting attribute values in data entity instances.

To address the above-described challenge with attribute inheritance of attribute values, the inventors have developed techniques that allow attributes of data entity instances to be configured to override its inherited value. The data processing system may thus provide the efficiency improvements of inheritance together with the flexibility to override the inherited values when needed. Continuing with the example above, a data entity instance in which an attribute is configured to inherit a credit score validation rule from an attribute of another data entity instance may be configurable to override the inherited validation rule (e.g., for a different geographic region).

Accordingly, some embodiments provide techniques for accessing data according to inheritance relationships among attributes of data entities, where such inheritances can be overridden. The data processing system may be configured to receive a request to access a first attribute value of a particular instance of a first data entity. The first data entity comprises a plurality of attributes including the first attribute. The particular instance comprises a value for zero, one, or more of the plurality of attributes of the first data entity. The first attribute of the particular instance may be configured to inherit its value from a second attribute of another instance of a second data entity different from the first data entity. The data processing system may be configured to determine whether the first attribute of the particular instance is configured to override the value inherited from the second attribute. When it is determined that the first attribute is configured to override the value inherited from the second attribute, the data processing system may: (1) access an overriding value for overriding the value inherited from the second attribute; (2) generate a first response to the request that includes information indicating the overriding value as the first attribute value; and (3) output the first response. When it is determined that the first attribute is not configured to override the value inherited from the second attribute, the data processing system may: (1) access the value inherited from the second attribute; (2) generate a second response to the request that includes information indicating the value inherited from the second attribute as the first attribute value; and (3) output the second response.

In some embodiments, the first data entity includes information indicating: (i) that the first attribute inherits its value from the second attribute; and (ii) whether the first attribute is configurable to override its inherited value. In some embodiments, the data processing system comprises at least one data store configured to store instances of the data entities, the instances of the data entities including the particular instance and the other instance. In some embodiments, the request comprises an executable query (e.g., a structured query language (SQL) query). In some embodiments, the particular instance may comprise multiple attribute values, wherein each of at least some of the multiple attribute values is inherited from a respective instance of a different data entity.

In some embodiments, the second attribute of the other instance may be configured to inherit its value from a third attribute of an instance of a third data entity different from the second data entity and the first data entity. In some embodiments, accessing the value inherited from the second attribute comprises: determining whether the second attribute of the other instance is configured to override the value inherited from the third attribute. When it is determined that the second attribute of the other instance is configured to override the value inherited from the third attribute, the data processing system may access another overriding value for overriding the value inherited from the third attribute as the value inherited from the second attribute. When it is determined that the second attribute of the other instance is not configured to override the value inherited from the third attribute, the data processing system may access the value inherited by the second attribute from the third attribute.

In some embodiments, the outputting comprises: generating a graphical user interface (GUI) that displays: (1) the first attribute value; and (2) information indicating whether the first attribute value is inherited.

In some embodiments, the particular instance includes respective values for a first plurality of attributes including the first attribute, the first plurality of attributes being configured to inherit their values from a respective second plurality of attributes of the other instance, wherein the request comprises a request to access the values of the first plurality of attributes. The data processing system may be configured to: (1) group the first plurality of attributes into a single group; and (2) generate a single executable query for the single group in accordance with the request, wherein the single executable query, when executed by the data processing system, causes the data processing system to generate a response to the request. In some embodiments, grouping the first plurality of attributes into the single group comprises grouping the first plurality of attributes into the single group using a grouping criterion. In some embodiments, the grouping criterion is to group attributes that inherit values from a common instance into the single group.

In some embodiments, the data processing system comprises at least one data store configured to store information defining relationships among multiple data entity instances. In some embodiments, the data managed by the data processing system comprises information describing data stored in distributed databases of a distributed network of computing systems. In some embodiments, the data processing system may be configured to store an instance for each of multiple datasets stored by the distributed databases of the distributed computing system and/or for each of multiple software applications configured to be executed by the distributed computing systems.

In some embodiments, the data processing system may be configured to: (1) generate a first portion of a graphical user interface (GUI) indicating the first attribute value; (2) set the first attribute value indicated by the GUI to the second attribute value; and (3) display the GUI. In some embodiments, the data processing system may be configured to: (1) determine whether the first attribute is configurable to override its inherited value; and (2) generate a second portion of the GUI indicating that the first attribute is configurable to override its inherited value when it is determined that the first attribute is configurable to override its inherited value. In some embodiments, generating the second portion of the GUI comprises: enabling a user to specify, through the second portion of the GUI, the overriding value for overriding the value inherited from the second attribute. In some embodiments, the data processing system may be configured to generate a second portion of the GUI indicating that the first attribute is not configurable to override its inherited value when it is determined that the first attribute is not configurable to override its inherited value.

In some embodiments, the data processing system may be configured to prevent overriding of the value inherited from the second attribute of the other instance. In some embodiments, the data processing system may be configured to generate a GUI allowing a user to configure the first data entity such that the first attribute inherits its value from the second attribute. In some embodiments, the data processing system may be configured to generate a GUI displaying information indicating a source of the first attribute value. In some embodiments, the GUI may be configured to display the information indicating the source of the first attribute value in response to a mouse-over event. In some embodiments, the information indicating the source of the first attribute value indicates that the source is the second attribute of the other instance or that the source is an overriding value.

Some embodiments provide techniques for obtaining information about data entity instances from a data processing system is provided. The data processing system may be configured to store a plurality of data entity instances including: (1) a first data entity instance having a first plurality of attributes including a first attribute; and (2) a second data entity instance having a second plurality of attributes including a second attribute. The data processing system may be configured to obtain a request to obtain information about the first data entity instance, the information including a first value of the first attribute of the first data entity instance, the first attribute of the first data entity instance being configured to inherit its value from the second attribute of the second data entity instance. The first attribute may be configurable to override its inherited value (such an attribute may be termed as being “overridable”). Of course, even if the value of a data entity instance attribute is overridable, it is not necessary the case that it will be overridden.

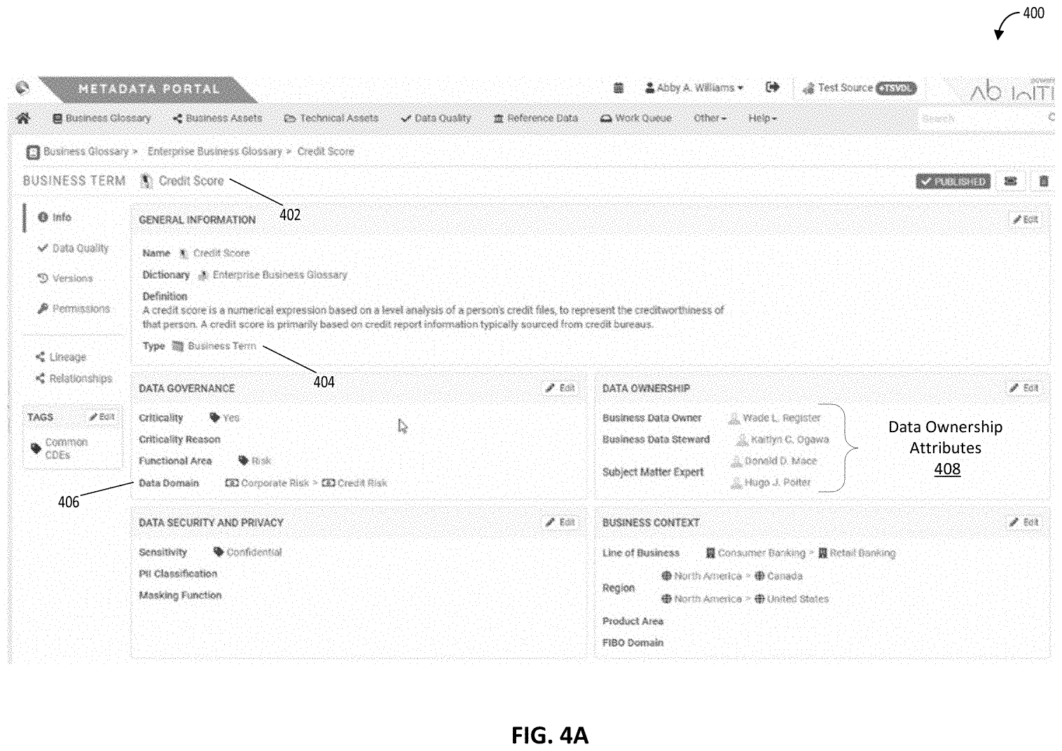

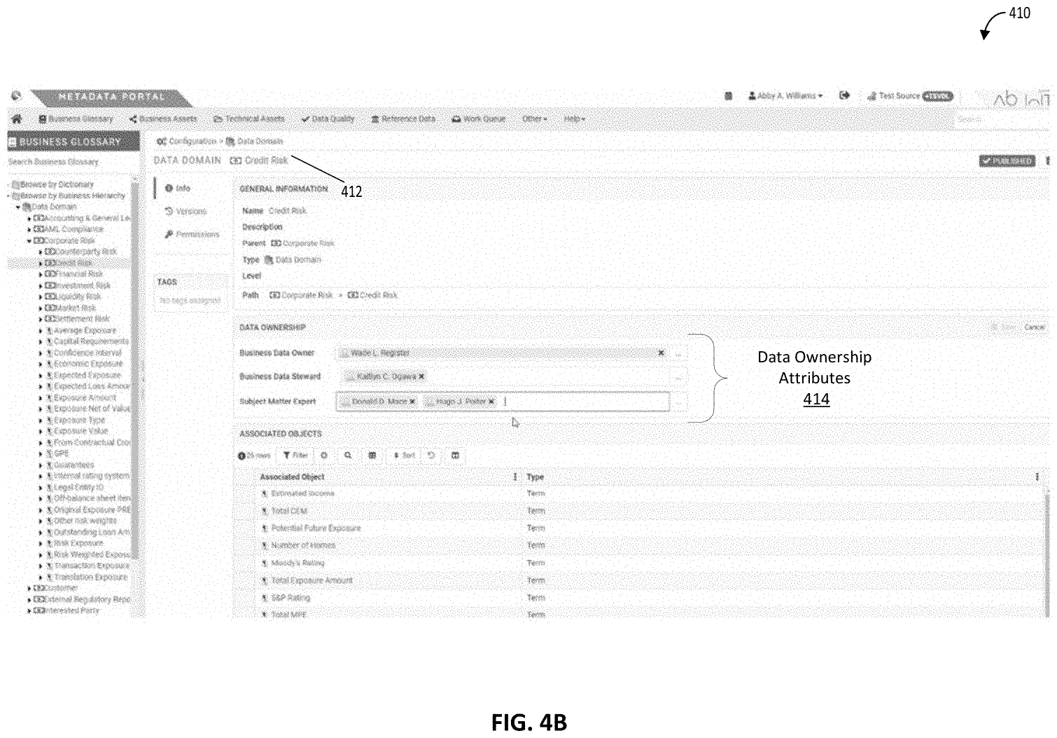

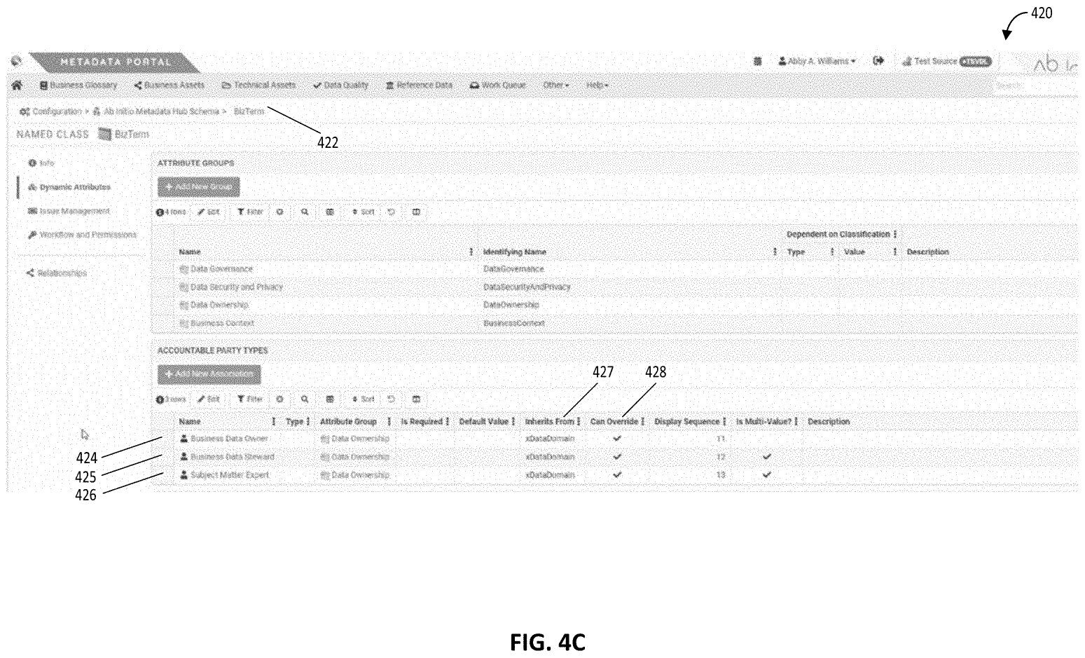

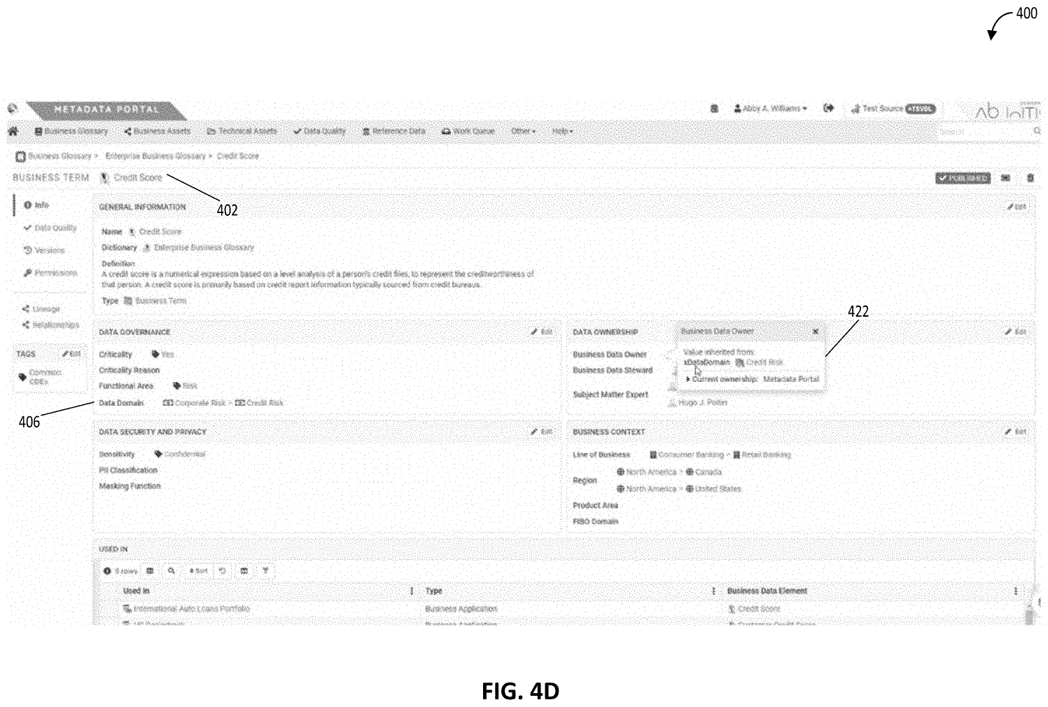

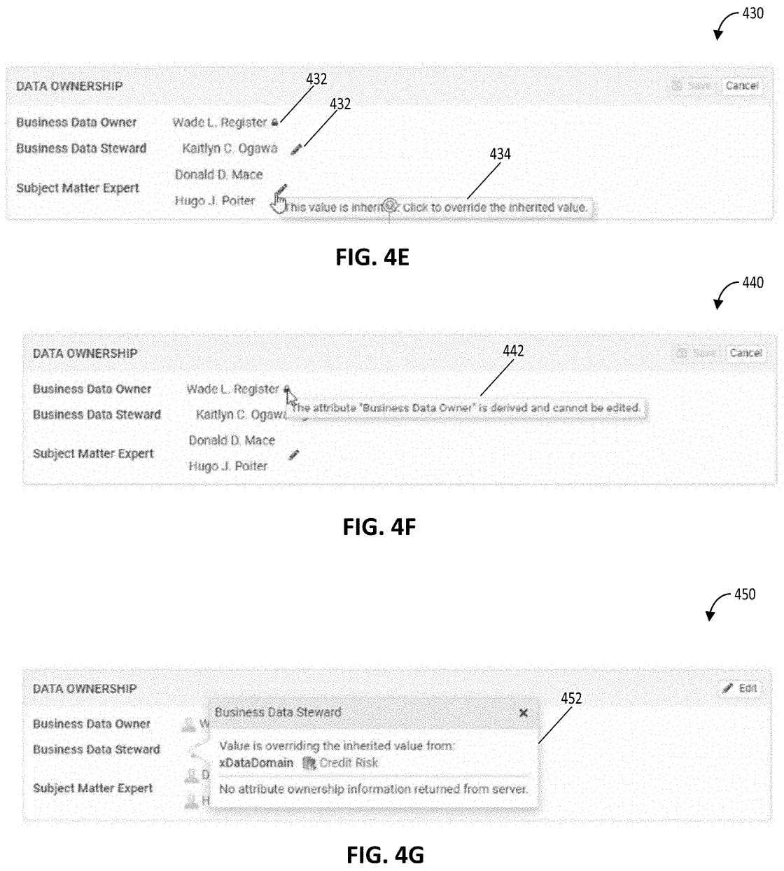

In some embodiments, there are multiple different ways in which a value inherited by an attribute of a data entity instance may be overridden. For example, the value may be overridden through a GUI as described herein with reference to FIGS. 4E-G. In another example, the value inherited by an attribute may be overridden through an application program interface (API). In another example, the value inherited by an attribute may be overridden by a configuration file. Regardless of how the request is made, the data processing may be configured to respond to a request for information about the attribute (e.g., included in a request for information about the data entity instance) by accessing the override value.

In some embodiments, the data processing system may be configured to generate a response to the request that includes the first value of the first attribute by determining whether the first attribute of the first data entity instance is configured to override a second value of the second attribute of the second data entity instance. When it is determined that the first attribute is configured to override the second value of the second attribute, the data processing system may access the overriding value and generate the response to including the overriding value as the first value of the first attribute. When it is determined that the first attribute is not configured to override the second value of the second attribute, the data processing system may access the second value of the second attribute and generate the response to include the second value as the first value of the first attribute.

In some embodiments, the data processing system comprises at least one data store configured to store the plurality of data entity instances and associated values, and the request comprises an executable query (e.g., an executable SQL query) that, when executed by the data processing system, causes the data processing system to generate the response to the request. In some embodiments, the request is generated in response to a programmatic request, made by a computer program being executed by the data processing system, to access the first value of the first attribute. In some embodiments, the request is generated in response to a programmatic request, made by a computer program executing external to the data processing system, to access the first value of the first attribute.

In some embodiments, the plurality of data entity instances includes a third data entity instance having a third plurality of attributes including a third attribute, and the second attribute of the second data entity instance is configured to inherit its value from the third attribute of the third data entity instance. In some embodiments, accessing the second value of the second attribute comprises: (1) determining whether the second attribute of the second data entity instance is configured to override a third value of the third attribute of the third data entity instance; (2) when it is determined that the second attribute of the second data entity instance is configured to override the third value of the third attribute, accessing a second overriding value for the second attribute; and (3) when it is determined that the second attribute of the second data entity instance is not configured to override the third value of the third attribute, accessing the third value of the third attribute. In some embodiments, accessing the second value of the second attribute comprises accessing the third value of the third attribute.

In some embodiments, the first data entity instance is associated with a first data entity and the second data entity instance is associated with a second data entity, wherein the first data entity includes information indicating: (i) that the first attribute inherits its value from the second attribute; and (ii) whether the first attribute is configured to override its inherited value, and determining whether the first attribute of the first data entity instance is configured to override the second value of the second attribute of the second data entity instance is performed using the first data entity. In some embodiments, determining that the first attribute of the first data entity instance is configured to inherit its value from that of the second attribute of the second data entity instance using the first data entity.

In some embodiments, the outputting comprises: generating a graphical user interface (GUI) that displays: (1) the first value of the first attribute of the first data entity instance, and (2) information indicating whether the first value is inherited. In some embodiments, accessing the second value of the second attribute comprises recursively accessing values of one or more attributes of one or more data entity instances to determine the second value of the second attribute. In some embodiments, each attribute of multiple attributes, including the first attribute of the first plurality of attributes of the first data entity instance is configured to inherit its value from one or more attributes of another data entity instance, and wherein the information includes respective values of the multiple attributes, the method comprising: (1) grouping, by the data processing system, the multiple attributes of the first plurality of attributes into a single group; and (2) generating a single executable query for the single group in accordance with the request, wherein the single executable query, when executed by the data processing system, causes the data processing system to generate the response to the request.

In some embodiments, the data processing system may be configured to: (1) group multiple attributes of the first plurality of attributes into one or more groups using a grouping criterion, wherein the information includes respective values of the multiple attributes; and (2) generate an executable query for each of the groups to obtain a plurality of executable queries that, when executed by the data processing system, cause the data processing system to generate the response to the request. In some embodiments, the grouping criterion is to group attributes of the multiple attributes that share a common inheritance path into a single group such that a one of the plurality of executable queries is used to access inherited values of the grouped attributes.

In some embodiments, the data processing system comprises at least one data store configured to store the plurality of data entity instances and information defining relationships among different data entity instances, wherein the at least one data store is configured to store, using the plurality of data entity instances, information describing data stored in distributed databases of a distributed network of computing systems. In some embodiments, the at least one data store is configured to store a data entity instance of the plurality of data entity instances for each of multiple datasets stored by the distributed databases of the distributed computing systems, for each of multiple software applications configured to be executed by the distributed computing systems, or for each or multiple system parts of the distributed computing systems.

Some embodiments provide techniques for obtaining information about data entity instances from a data processing system. The data processing system may be configured to store a plurality of data entity instances, the plurality of data entity instances including a first data entity instance having a first plurality of attributes including a first attribute and a second data entity instance having a second plurality of attributes including a second attribute. The data processing system may be configured to generate a graphical user interface (GUI) containing information about the first data entity instance. The data processing system may be configured to generate the GUI by generating a first GUI portion indicating a first value of the first attribute of the first data entity instance, the first attribute of the first data entity instance being configured to inherit its value from the second value of the second data entity instance. The data processing system may be configured to generate the first GUI portion by: (1) accessing a second value of the second attribute, and (2) setting the first value of the first attribute to the second value. The data processing system may be configured to generate a second GUI portion to indicate whether the first attribute is configurable to override its inherited value. The data processing system may be configured to display the GUI.

In some embodiments, generating the second GUI portion comprises: determining whether the first attribute is configurable to override its inherited value. In some embodiments, generating the second GUI portion comprises determining whether the first attribute is configurable to override its inherited value. In some embodiments, the second GUI portion is configured to display information indicating a source of the first value of the first attribute. In some embodiments, the second GUI portion is configured to display the information indicating the source of the first value of the first attribute in response to a mouse-over event. In some embodiments, the information indicating the source of the first value of the first attribute indicates that the source is the second attribute or that the source is an overriding value.

It should be appreciated that the concept of inheritance as described herein is different from the inheritance as that term is used in the context of object-oriented programming. In object-oriented programming, inheritance refers to a child class inheriting properties (e.g., variables, definitions of functions, implementations of functions) from a base class. This allows for code reuse and extension of software via public classes and interfaces.

By contrast, inheritance as described herein refers to the situation where an attribute of a data entity can be configured to take on or “inherit” its value from an attribute of another data entity. The configuration would indicate the data entity from which the attribute would inherit the data—it would not be fixed like a base class in an object-oriented setting. For example, a data entity “D1” may have two attributes “A1” and “A2”, and the value of attribute “A2” may identify another data entity “D2” from which the value of attribute “A1” is to be inherited. Changing the value of attribute “A2” to a different data entity “D3” would change the data entity from which the attribute “A1” inherits its value.

Since the configuration is at the level of attributes, different attributes of the same underlying data entity can be configured to take on or “inherit” their values from different attributes of multiple other data entities. This provides great flexibility for how attribute values can be set, and provides a level of indirection not available in object oriented programming. Indeed, a single data entity may be configured to not only inherit attribute values from multiple other data entities, but that configuration can be changed at the level of instances of the single data entity, as described above.

As can be appreciated from the following description, inheritance for data entities can be configured at an attribute level. To this end, in some embodiments, a data processing system may store an “inheritance configuration” for each of at least some (e.g., all) attributes of a data entity. The “inheritance configuration” may indicate whether the attribute inherits its value from another data entity attribute and, if so, which one. Additionally, the inheritance configuration may indicate whether or not the attribute is overridable. Where an attribute is overridable, the inheritance configuration may further include permissions information indicating the user(s) permitted to override the value.

In contrast, conventional object oriented systems do not have attribute-level inheritance configuration described herein. As described above, conventional object oriented systems do not support inheritance of values at the attribute level of a data entity instance. Rather, object-oriented inheritance is at the class level such that all object instances inherit all their values from a single parent object.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

As described above, the inventors have recognized that a data processing system may be configured to manage millions or billions of data entity instances. For example, the techniques described herein may be used, in some embodiments, for metadata management in an enterprise setting, whereby data entity instances store information about individual data sets (e.g., tables, transactions, documents, data records, etc.) stored across a globally distributed enterprise system comprising many databases, data warehouses, data lakes, etc. As described above, in this context, a data entity instance may store information about a corresponding dataset such as, for example, when the dataset was created, where it is stored, its size, the identity of the user(s) that are allowed to edit the dataset, information identifying which application programs use the dataset, information identifying the sensitivity level of the data, etc. Since a large organization (e.g., a financial institution such as a bank or credit card company, a utility such as a phone or electric company, etc.) will typically manage millions or billions of such datasets, there may be millions or billions of data entity instances storing information about such datasets that would be managed by the data processing system.

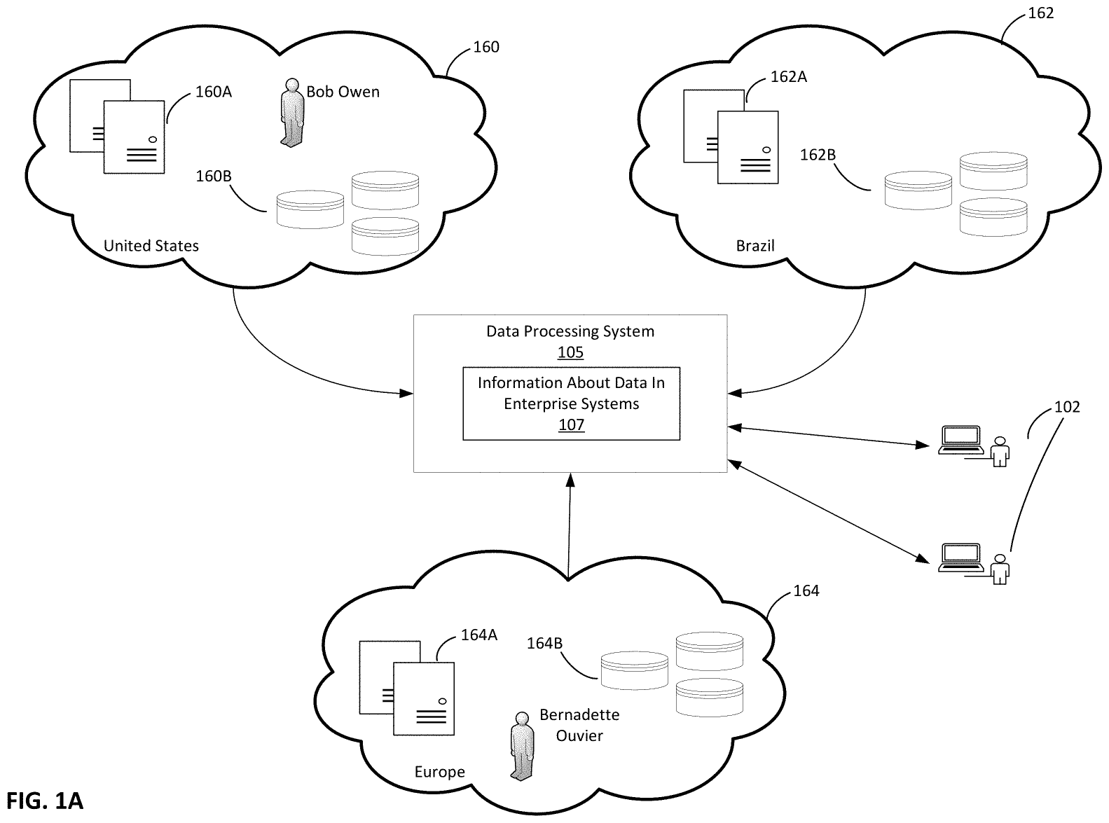

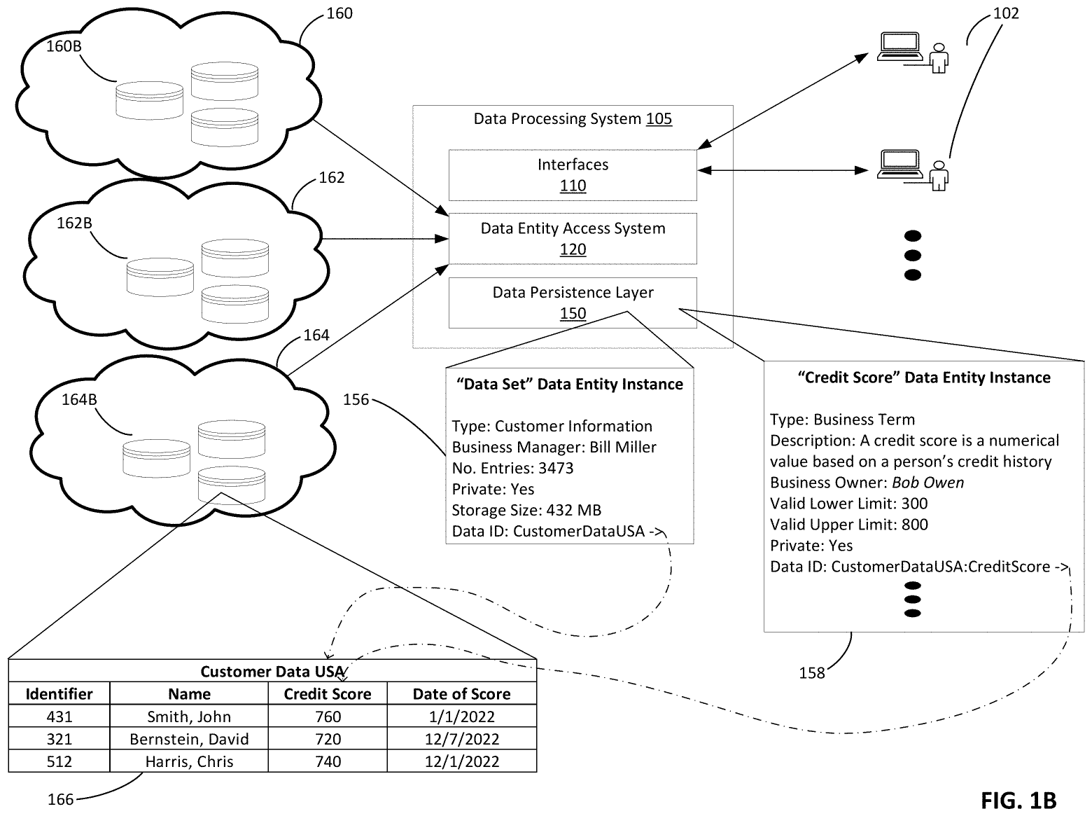

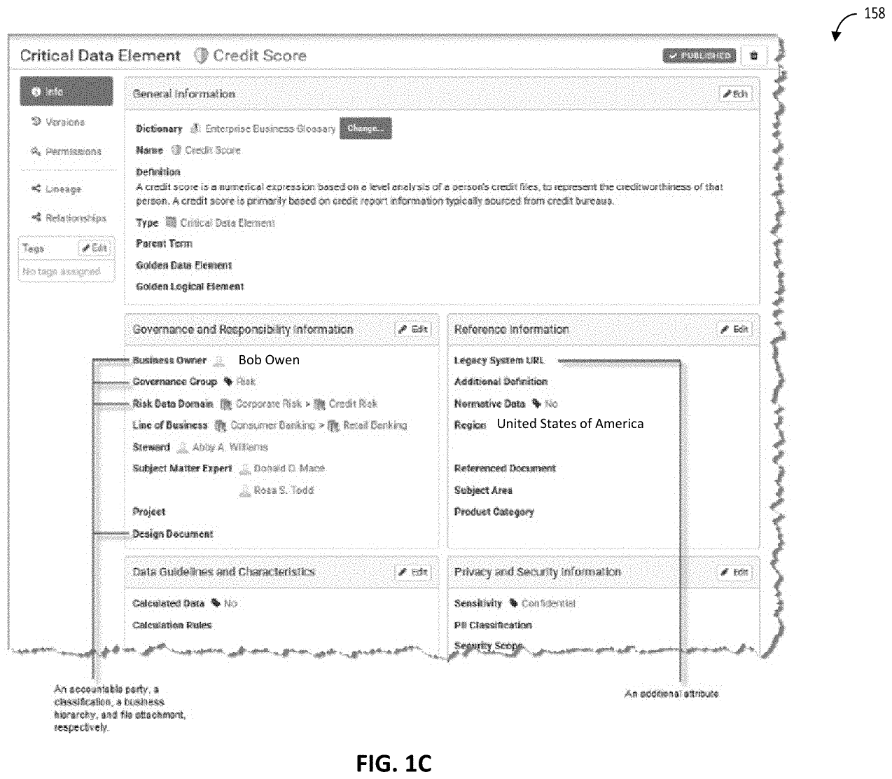

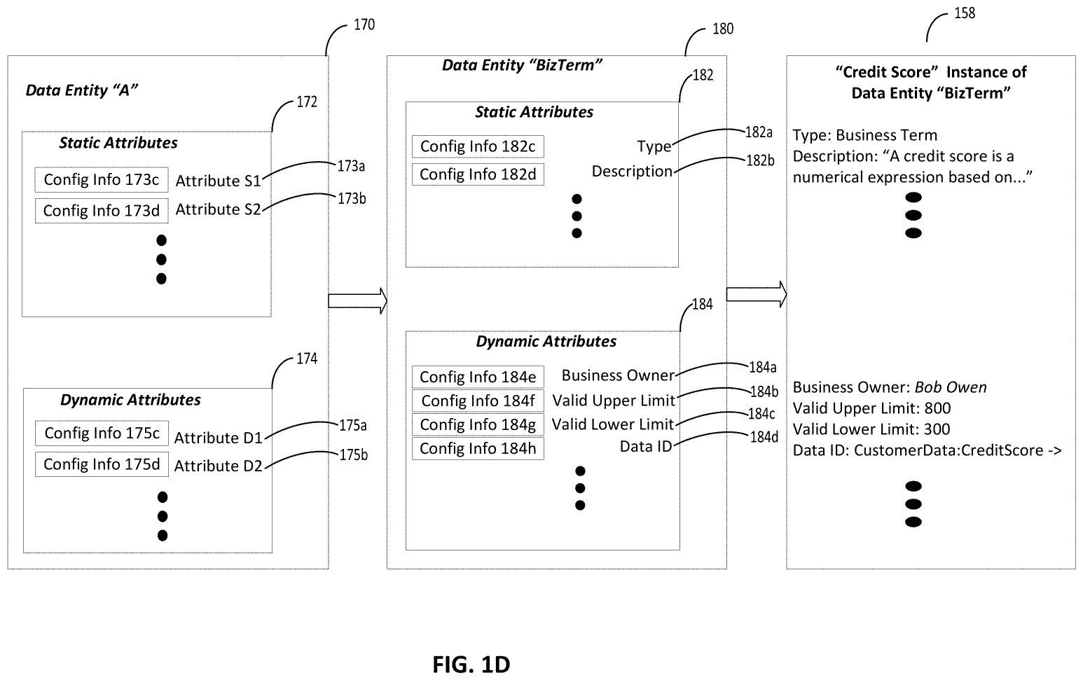

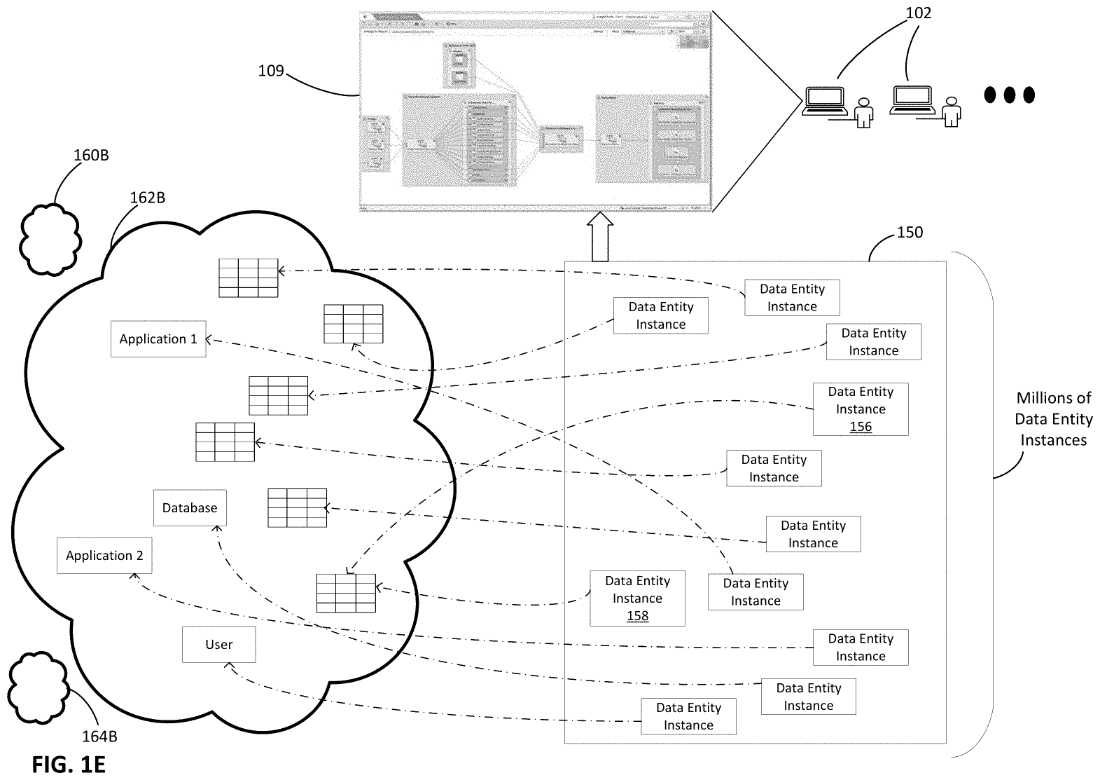

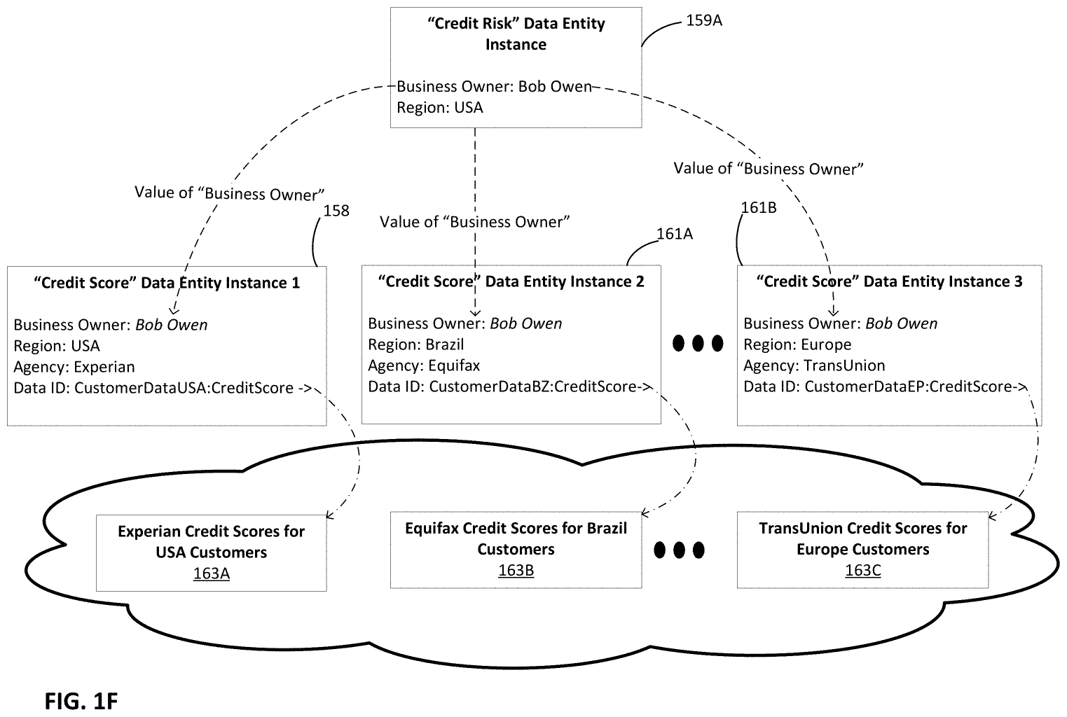

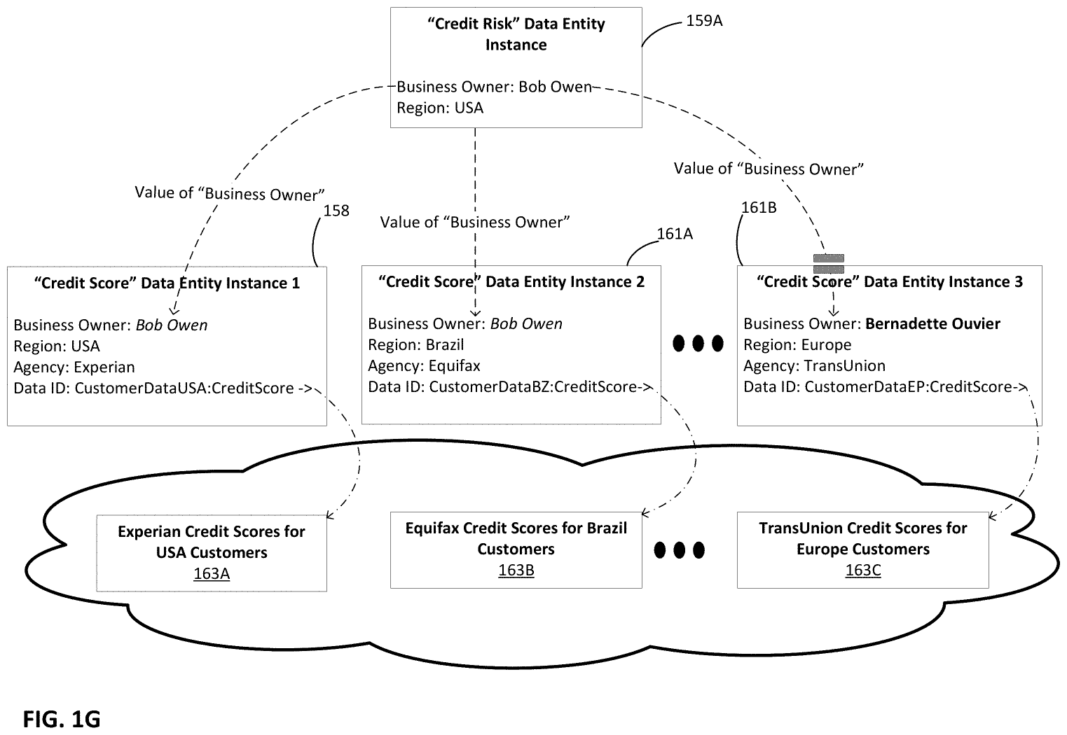

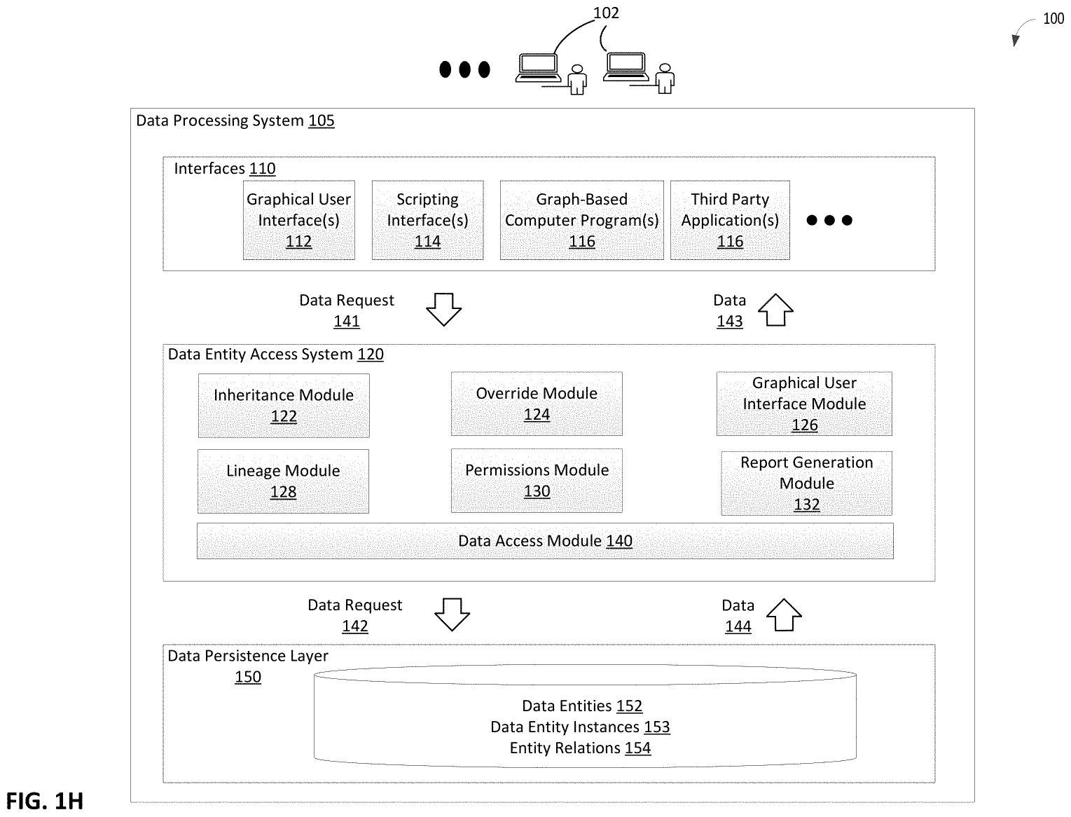

FIG. 1A is a diagram illustrating an example environment in which a data processing system 105 may be used, in accordance with some embodiments of the technology described herein. The example of FIG. 1A is an implementation in which the data processing system 105 is used for metadata management. It should be appreciated that techniques described herein are not limited to being applied to any particular type of data and may be used within any data processing system using data entities and data entity instances to manage data irrespective of whether the managed data is metadata or any other type of data (e.g., transactions, files, data records, tables, etc.).

FIG. 1A illustrates an enterprise system comprising systems 160, 162, 164 distributed across multiple geographic locations (e.g., different cites, countries, continents, etc.). Each of the systems 160, 162, 164 may store vast amounts of data (e.g., in one or more database systems, data warehouses, data lakes, etc.). For example, the systems 160, 162, 164 may be components of an enterprise system of a global bank, with the system 160 being located in the United States, system 162 being located in Brazil, and system 164 being located in Europe.

As shown in the example embodiment of FIG. 1A, each of the systems 160, 162, 164 includes a respective set of computing devices. System 160 includes servers 160A, and databases 160B. System 162 includes servers 162A and databases 162B. System 164 includes servers 164A and databases 164B. During operation of the enterprise system, each of the systems 160, 162, 164 may generate and/or store large amounts of data (e.g., terabytes of data). For example, the enterprise system may be for a credit card company, where each of the systems 160, 162, 164 generates and/or stores transaction data, credit scores, and/or any other suitable data. In another example, the enterprise system may be for a bank, where each of the systems 160, 162, 164 generates and/or stores data about bank records, loans, account holders, and/or any other suitable data. In another example, the enterprise system may be for a phone company, where each of the systems 160, 162, 164 generates and/or stores data about phone calls, text messages, data usage, and/or any other suitable data.

In some embodiments, the database systems 160B, 162B, 164B may be configured to store data (e.g., of an enterprise system). Each of the database systems 160B, 162B, 164B may comprise a database, data warehouse, data lake, and/or any other database system. The database systems 160B, 162B, 164B may be of any suitable type(s), either the same type or different types. For example, each of these systems may include one or more relational database systems (e.g., ORACLE, SQL SERVER, etc.) As another example, in some embodiments, each of these systems may include one or more other types of database systems (e.g., non-relational (e.g., NoSQL) database system, a multi-file system, or any other suitable type of database system).

In the example embodiment of FIG. 1A, the data processing system 105 stores information 107 describing data stored in the systems 160, 162, 164. In this sense, the information 107 may be considered to be metadata. The metadata may include any of numerous types of information about the data stored in the enterprise systems 160, 162, 164. For example, the metadata may include information about systems that process data (e.g., servers 160A, 162A, 164A), software applications executing on the enterprise system that are used to process data, and/or rules for the applications in storing the data. In another example, the metadata may include information about data throughout the enterprise software system such as how the data were generated, the size of data, description of the data, which user(s) are permitted to read, update, create, delete or perform any other action with respect to the data, and/or any other suitable information about the data.

In some embodiments, the data processing system may be configured to manage the metadata using data entity instances and data entity definitions. For example, the data processing system 105 may store a data entity instance for each of multiple datasets (e.g., tables) stored by the enterprise system. Each such data entity instance may store information about the dataset (e.g., when the dataset was created or updated, where the dataset is stored, size of the dataset, the identity of the user(s) that are allowed to read, edit, delete, or perform any other suitable action with respect to the dataset, information identifying which software applications use the dataset, information identifying the sensitivity level of the data in the dataset, and/or any other suitable metadata). As another example, the data processing system 105 may store data entity instances for respective columns of tables in the enterprise system. Each such a data entity instance may store information about the column (e.g., the meaning of the values in the column, who is authorized to read, write, update, and/or delete values in the column, the range of permitted values of entries in the column, and/or any other suitable metadata). As yet another example, the data processing system 105 may store a data entity instance for each of multiple software applications configured to be executed by some system or device part of the enterprise system. Such a data entity instance may store information about the software application (e.g., which datasets the software application processes, where the application puts its output, a description of the application's functionality, the application's version, the application's dependency on data and/or other applications, where the executables of the application may be found, and/or any other suitable metadata). As yet another example, the data processing system 105 may store a data entity instance for each of multiple systems part of the enterprise system.

As can be readily appreciated from the foregoing, in such a metadata management scenario, the data processing system 105 may manage millions or billions of such data entity instances, which is why it is important that querying, creating, updating, deleting, or performing any other suitable actions with respect to the data entity instances be performed efficiently as possible.

In some embodiments, the data processing system 105 may be configured to obtain the information 107 about data from the various systems 160, 162, 164. For example, the data processing system 105 may query database 160B, 162B, 164B for metadata of the various systems 160, 162, 164. In some embodiments, the data processing system 105 may be configured to generate metadata using information obtained from the systems 160, 162, 164 (e.g., by querying database systems 160B, 162B, 164B for metadata). In some embodiments, the data processing system 105 may be configured to store metadata about data stored in the systems 160, 162, 164. For example, the systems 160, 162, 164 may each be a data lake, data warehouse, database system, or other type of system. The metadata may be stored in instances of data entities, as described herein. In some embodiments, one or more attributes of data entity instances may be configured to inherit values from attributes of other data entity instances. In some embodiments, the data processing system 105 may be configured to allow users of the data processing system 105 to override value(s) inherited by attribute(s).

As shown in FIG. 1A, one or more users 102 may access the information 107 about the data in the enterprise systems by interacting with the data processing system 105. For example, the user(s) 105 may interact with the data processing system 105 using one or more computing devices through one or more interfaces (e.g., user interface(s)) provided by the data processing system 105. Example interfaces through which the user(s) 102 may interact with the data processing system 105 are described herein with reference to FIG. 1H.

FIG. 1B is a diagram illustrating an example implementation of the data processing system 105 of FIG. 1A, in accordance with some embodiments of the technology described herein. As shown in the example embodiment of FIG. 1B, the data processing system 105 communicatively coupled to: (1) databases 160B, 162B, 164B of respective systems 160, 162, 164 of FIG. 1A; and (2) devices (e.g., used by user(s) 102). The data processing system 105 includes interfaces 110, a data entity access system 120, and a data persistence layer 150.

In some embodiments, the interfaces 110 may be configured to include user interfaces through which user(s) 102 may access information from the data processing system 105 (e.g., using computing device(s)). The interfaces 110 may be configured to generate graphical user interfaces (GUIs) through which users may access data from the information 107 about data stored in systems 160, 162, 164. The GUIs may allow the users to: (1) request information about data entity instances stored by the data processing system; and (2) view information about data entity instances stored by the data processing system. In some embodiments, the GUIs may allow users to access information 107 (e.g., metadata) stored about data stored by systems 160, 162, 164. For example, the GUIs may allow user(s) 102 to track data being generated in an enterprise system (e.g., quality metrics, and other characteristics of the data). In another example, the GUIs may allow the user(s) 102 to visualize information describing components of a process flow including: input data, a description of a process performed on the input data, and output data. In another example, the interfaces 110 may include scripting interfaces through which scripts may be received for execution by the data processing system 105. In another example, the interfaces 110 may include graph-based computer programs(s) 116, third party application(s), and/or other interfaces. Various examples of interfaces 110 are described herein with reference to FIG. 1H.

In the context of metadata management, in some embodiments, the interfaces 110 may be configured to generate graphical user interfaces (GUIs) through which users may access data from the information 107 about data stored in systems 160, 162, 164. The GUIs may allow the users to: (1) request information about data entity instances stored by the data processing system; and (2) view information about data entity instances stored by the data processing system. In some embodiments, the GUIs may allow users to access information 107 (e.g., metadata) stored about data stored by systems 160, 162, 164. For example, the GUIs may allow user(s) 102 to track data being generated in an enterprise software system (e.g., quality metrics, and other characteristics of the data). In another example, the GUIs may allow user(s) 102 to visualize lineage information. Lineage information may include information about relationships between different data entity instances. Aspects of lineage information are described in U.S. Pat. No. 10,489,384, entitled “SYSTEMS AND METHODS FOR DETERMINING RELATIONSHIPS AMONG DATA ELEMENTS”, which is herein incorporated by reference in its entirety.

In some embodiments, the data entity access system 120 may be configured to manage access to data entities. The data entity access system 120 may be configured to allow data entities to be configured. The data entity access system 120 may be configured to allow defining of new data entities, and configure properties of attributes of the data entities. For example, the data entity access system 120 may allow for configuring attribute(s) of a data entity to inherit its value from an attribute of another data entity. As another example, the data entity access system 120 may allow for configuring multiple attributes of a data entity to inherit from multiple attributes of multiple other data entities. As another example, the data entity access system 120 may allow for configuring attribute(s) of a data entity to be overridable.

In some embodiments, the data entity access system 120 may be configured to manage organization, storage, and access of information from data entity instances stored by the data processing system 105. For example, the data processing system 105 may execute queries to obtain information about data entity instances stored by the data processing system 105. In some embodiments, the data entity access system 120 may be configured to generate responses to requests for information about data entity instances stored by the data processing system 105. For example, the data processing system 105 may generate responses for information about metadata stored by the data processing system 105.

In some embodiments, the data persistence layer 150 may be configured to store information about data entities and instances thereof. The information may include information defining data entities, instances of the data entities, and relations among the data entities and instances thereof. In some embodiments, the data persistence layer 150 may provide a central repository for all metadata of a system (e.g., an enterprise system). For example, the data persistence layer 150 may store the information 107 about data stored in databases 160B, 162B, and 164B. For example, each of the databases 160B, 162B, 164B may be a data lake, data warehouse, database system, or other type of datastore.

Table 166 shown in FIG. 1B illustrates example data stored in the database 164C. Table 166 stores a set of information about customers (e.g., of a bank). The columns of the table 166 include “Identifier”, “Name”, “Credit Score”, and “Date of Score”. The data persistence layer 150 stores a “Data Set” data entity instance 156 that stores metadata about the data of table 166. The data entity instance 156 stores values of attributes including a “Type” of the data entity instance 156, a “Business Manager”, “No. Entries”, “Private”, “Storage Size”, and “Data ID”. In some embodiments, the “Data Set” data entity instance 156 may store values of other attributes in addition to or instead of those shown in FIG. 1B.

In applications where a data entity instance contains metadata about data (e.g., information about a table), in some embodiments, the data entity instance may include information that can be used to identify and/or access the data. As shown in the example of FIG. 1B, the “Data ID” attribute identifies data (e.g., a table) that the information in the “Data Set” data entity instance 156 describes. For example, the value of “Data ID” may be an identifier of the table 166. In some embodiments, the value of “Data ID” may allow a user to navigate to the table 166. For example, the value of “Data ID” may be a hyperlink that navigates to the table 166 in database 164B. In some embodiments, the data entity instance may not itself store information about the data, though the data processing system may store information associating a data entity instance with information that can be used to identify and/or access the data itself. For example, the data processing system may store such information in one or more tables (e.g., within data persistence layer 150) or in any other suitable way.

As shown in the example embodiment of FIG. 1B, the data persistence layer 150 further stores a “Credit Score” data entity instance 158. The “Credit Score” data entity instance 158 may be an instance of “BizTerm” data entity 180 of FIG. 1D. The “Credit Score” data entity instance 158 includes values for the attributes “Type”, “Description”, “Business Owner”, “Valid Lower Limit”, “Valid Upper Limit”, “Private”, and “Data ID”. As indicated by the arrow between the “Data ID” attribute and the “Credit Score” column of table 166, the “Credit Score” data entity instance 158 describes data in the “Credit Score” column of table 166. As shown in the example of FIG. 1B, the “Data ID” attribute indicates data that the information in the “Data Set” data entity instance 158 describes. For example, the value of “Data ID” may be an identifier of the “Credit Score” column in table 166. In some embodiments, the value of “Data ID” may allow a user to navigate to the “Credit Score” column of table 166. For example, the value of “Data ID” may be a hyperlink that provides information from the “Credit Score” column to a user.

FIG. 1C is a graphical user interface (GUI) illustrating the data entity instance 158 of FIG. 1B, in accordance with some embodiments of the technology described herein. In this example, the data entity instance is named “Credit Score.” The data entity instance 158 has many static attributes (e.g., “Name”, “Definition”, and “Type”) and dynamic attributes. In this example, the dynamic attributes are divided into groups of attributes for storing various types of information related to data governance in a banking application. For example, the data entity instance 158 has dynamic attributes relating to governance including: “Business Owner”, “Governance Group”, “Risk Data Domain”, “Line of Business”, “Steward,” “Subject Matter Expert”, etc. As another example, the data entity instance 158 has attributes relating to privacy and security including: “Sensitivity”, “PII Classification” and “Security Scope”. The screenshot of FIG. 1C illustrates example values of some of these attributes for the data entity instance 158 displayed in a GUI.

As may be appreciated from the foregoing examples, attributes may be considered as being of different types depending on the types of values that they take on. Examples of different types of attributes are described below by way of example and not limitation. For example, an attribute may take on a scalar value such as a number, a string, a date, a time, or a date-time. This type of attribute may be referred to as an “Extended Attribute” in some of the examples described herein. In some embodiments, an attribute may be multi-valued and take on a set of values, each of which may be a number, a string, a date, a time, or a date-time.

As another example, an attribute may be discrete whereby it takes on values selected from a discrete set of values. Such a set may be referred to as an “enumeration”. For example, an attribute may be of type “Classification,” whereby its value is a label from selected from a set of labels. This allows for tagging of data with desired labels. As one specific example, certain data may be classified as being or containing personally identifiable information (PII), for example, with values such as “Yes” or “No”. In the example of FIG. 1C, the PII Classification dynamic attribute may be of the type “Classification,” as is the attribute “Governance Group”. As another example, an attribute may take on values representing respective users or groups of users. In the example of FIG. 1C, the “Business Owner” attribute may be of type “Accountable Parties” and its values may represent users or groups of users. In the example of FIG. 1C, the “Business Owner” takes on the value “Bob Owen”. In some embodiments, one or more (e.g., all) of the values in the discrete set of values may be a reference to another data entity instance. All these example attributes are discrete.

As another example of a discrete attribute, an attribute may take on values in an ordered set of values. For example, values in the ordered set may be ordered according to a hierarchy. As one specific example, an attribute may store a value related to a geographic region, which may be selected from a hierarchical list of values (e.g., “United States”, “Delaware”, or “Wilmington”). Attributes taking on values in an ordered set of values may be of type “Hierarchy”. In the example of FIG. 1C, the “Risk Data Domain”, “Line of Business”, and “Region” attributes are dynamic attributes of type “Hierarchy”. When accessing the value of an attribute of type “Hierarchy”, in some embodiments, the particular value taken on by the variable may be returned together with other related values. For example, as shown in FIG. 1C, the value of the “Risk Data Domain” is “Credit Risk” and it is displayed in FIG. 1C together with the related value “Corporate Risk”, which is a value related to “Credit Risk” in the hierarchy of values of “Risk Data Domain” since “Credit Risk” is a type of “Corporate Risk”. In some embodiments, one or more (e.g., all) of the values in the ordered set of values may be a reference to another data entity instance.

As another example, an attribute may be a reference attribute and its value may be a reference to another data entity (e.g., a reference to an instance of another data entity). In some embodiments, an attribute may be multi-valued and take on a set of values, each of which may be reference to a data entity.

As another example, in some embodiments, an attribute may be of type “file attachment” and its value may identify a file (e.g., a document, a report, a configuration file, a spreadsheet, etc.) of interest. In the example of FIG. 1C, the “Design Document” attribute is of the “Attachment” type.

In some embodiments, the data processing system 105 may be configured to store the information 107 in instances of data entities. As described herein, in some embodiments, data entity attributes may be static or dynamic, which means that their values are stored using different mechanisms as described below. For example, FIG. 1D shows an illustrative diagram of a data entity 170 having multiple static attributes 172, including static attributes 173a and 173b, and multiple dynamic attributes 174, including dynamic attributes 175a and 175b. As shown in FIG. 1D, the data entity 170 includes configuration information 173c for attribute S1 173a, configuration information 173d for attribute S2 173b, configuration information 175c for attribute D1 175a, and configuration information 175d for attribute D2 175b. Configuration information for a respective attribute may indicate whether the attribute is configured to inherit its value, a data entity from which the attribute inherits its value (if the attribute is configured to inherit its value), whether a value that the attribute inherits is overridable, whether the attribute is required in instances of the data entity 170, a sequence in which the attribute is displayed in GUI, whether the attribute can have multiple values, a description of the attribute, and other information. Attributes of instances of the data entity 170 may be configured according to the configuration information for the attribute in the data entity 170.

In some embodiments, a data entity may specify additional information for one or more of the attributes of the data entity. For example, a data entity may specify the attribute type. As another example, a data entity may specify the manner in which values for an attribute are stored by the data processing system (e.g., whether the attribute values are stored in rows or columns). As yet another example, a data entity may specify whether an attribute of a data entity inherits its value (e.g., from an attribute of another data entity). In some implementations, a data entity may specify a particular value for a particular attribute, in which case all instances of the data entity would have the particular attribute set to the particular value. Otherwise, the values of data entity instance attributes may vary from instance to instance of the data entity.

As another example, FIG. 1D shows an illustrative diagram of a data entity 180, named “BizTerm”, having multiple static attributes 182, including static attributes “Type” 182a and “Description” 182b, and dynamic attributes 184, including dynamic attributes “Business Owner” 184a, “Valid Upper Limit” 184b, “Valid Lower Limit” 184c, and “Data ID” 184d. A data entity may have any suitable number of static attributes (including 0) and any suitable number of dynamic attributes (including 0), as aspects of the technology described herein are not limited in this respect. In some embodiments, the data processing system 105 may be configured to store static and dynamic attributes in different ways. Accordingly, a single data entity instance may be stored using rows and/or columns of one or multiple tables in a database system (e.g., a relational database system). The table(s) may be stored on one or multiple computer-readable storage mediums. On the other hand, in some embodiments, dynamic attribute values may be stored using name-value pairs. In particular, each database record may store an attribute value for a particular entity instance.

As shown in FIG. 1D, the “Credit Score” data entity instance 158 is an instance of the data entity “BizTerm” 180. The data entity instance 158 has values for the respective attributes of the data entity “BizTerm” 180. For example, the data entity instance 158 has a value of “Business Term” for the “Type” attribute 182a, a value of “Bob Owen” for the “Business Owner” attribute 184a, a value of “800” for the “Valid Upper Limit” attribute 184b, and a value of “300” for the “Valid Lower Limit” attribute 184c. As indicated by the dotted lines, the data entity instance 158 may have values for other attributes not shown in FIG. 1D.

FIG. 1E is a diagram illustrating example data 107 stored in the data persistence layer 150 of the data processing system 105, in accordance with some embodiments of the technology described herein. As shown in the example embodiment of FIG. 1E, in some embodiments, the data persistence layer 150 stores large numbers (e.g., thousands, millions, billions) of data entity instances storing information about respective components of the enterprise system of FIG. 1A (e.g., datasets, software application, systems or any other component of the enterprise system). The arrow from each data entity instance of FIG. 1E indicates a component that the information in the data entity instance describes. A component may be a dataset, an application (e.g., one or more computer programs), a system (e.g., a database system), and/or other component of the enterprise system. For example, a data entity instance may store information about data (e.g., a table) in the enterprise system. In another example, a data entity instance may store information about an application of the enterprise system. In yet another example, a data entity instance may store information about users of the enterprise system. As shown in FIG. 1E, the data persistence layer 150 stores the data entity instances 156, 158 described herein with reference to FIG. 1B.

In some embodiments, the data persistence layer 150 may be configured to support tens, hundreds, thousands or tens of thousands of data entities. And in an enterprise system environment, the data persistence layer 150 may be configured to store thousands, millions or billions of data entity instances. For example, the data persistence layer 150 may store at least 10,000 data entity instances, at least 50,000 data entity instances, at least 100,000 data entity instances, at least 500,000 data entity instances, at least 1,000,000 data entity instances, at least 5 million data entity instances, at least ten million data entity instances, at least 50 million data entity instances, at least 100 million data entity instances, at least 500 million data entity instances, at least one billion data entity instances, at least 5 billion data entity instances, between 100,000 and 5 million data entity instances, between 1 and 500 million data, between one million and 5 billion data entity instances, or any other range within these ranges.

As shown in the example embodiment of FIG. 1E, the data stored by the data persistence layer 150 may be used to provide a visualization 109 in a graphical user interface (GUI) provided on device(s) to user(s) 102. In some embodiments, the interfaces 110 of the data processing system 105 may be configured to provide information about data entity instances stored by the data processing system 105. For example, the user may wish to access the value(s) of one or more attributes of a data entity instance. In another example, the user may wish to access values of multiple attributes of multiple data entity instances. In another example, the user may wish to view lineage information such as lineage information 109 shown in FIG. 1E. Lineage information may include information about relationships between different data entity instances. Aspects of lineage information are described in U.S. Pat. No. 10,489,384, entitled “SYSTEMS AND METHODS FOR DETERMINING RELATIONSHIPS AMONG DATA ELEMENTS”, which is incorporated herein by reference in its entirety.

FIG. 1F is a diagram illustrating inheritance of an attribute value from data entity instance 159A by data entity instance 158, data entity instance 161A, and data entity instance 161B, in accordance with some embodiments of the technology described herein. FIG. 1F shows a “Credit Risk” data entity instance 159A, “Credit Score” data entity instance 158 storing information about EXPERIAN credit scores for customers in the United States of America (USA) (the credit scores themselves are stored in table 163A), “Credit Score” data entity instance 161A storing information about EQUIFAX credit scores for customers in Brazil (the credit scores themselves are stored in table 163B), and “Credit Score” data entity instance 161B storing information about TransUnion credit scores for customers in Europe (the credit scores themselves are stored in table 163C). Each of the “Credit Score” data entity instances 158, 161A, and 161B, include attributes “Business Owner”, “Region”, and “Agency”. In the example of FIG. 1F, in each of the “Credit Score” data entity instances 158, 161A, and 161B, the “Business Owner” attribute is configured to inherit its value from the accountable party attribute of the “Business Owner” data entity instance 159A. Each of data entity instances 158, 161A, 161B inherits “Bob Owen” as a value of its respective “Accountable Party” attribute. As indicated by the dots, there may be more “Credit Score” data entity instances storing information about respective credit scores (e.g., stored in an enterprise system).

FIG. 1G is a diagram illustrating an override of an attribute value inherited by “Credit Score” data entity instance 161B from the “Credit Risk” data entity instance 159A, in accordance with some embodiments of the technology described herein. The “Credit Score” data entity instance 161B includes attributes “Business Owner”, “Region”, and “Agency”. Although the “Business Owner” attribute of the “Credit Score” data entity instance 161B may have been originally configured to inherit its value from the “Credit Risk” data entity instance 159A, it has been overridden in the example of FIG. 1G. As shown in FIG. 1G. Instead of inheriting the value “Bob Owen” from the “Credit Risk” data entity instance 159A, the “Business Owner” attribute has an override value of “Bernadette Ouvier”.

FIG. 1H is a block diagram 100 illustrating aspects of an example data processing system 105, in accordance with some embodiments of the technology described herein. Data processing system 105 includes interfaces 110, data entity access system 120, and a data persistence layer 150.

In some embodiments, the interfaces 110 may allow user(s) 102 to interact with the data processing system 105. The interfaces 110 include one or more graphical user interfaces (GUI(s)) 112, scripting interfaces 114, graph-based computer programs 116, and third party applications 116. As indicated by the dots, the interfaces 110 may include one or more other types of interfaces instead of or in addition to the interfaces shown in FIG. 1H.

In some embodiments, the GUI(s) 112 may include a graphical user interface (GUI) that allows configuring a data entity. The GUI may be configured to allow defining of the data entity. The GUI may be configured to allow user(s) 102 to configure attributes of the data entity. In some embodiments, the GUI may be configured to allow user(s) 102 to configure an attribute of the data entity to inherit its value from an attribute of another data entity. For example, the GUI may allow a user to indicate the other data entity from which the attribute is to inherit its value (e.g., by specifying an identifier of the other data entity). In some embodiments, the GUI may be configured to allow user(s) 102 to make an attribute configurable to override a value that the attribute inherits. For example, the GUI may allow the user to enable or disable override for the attribute. By enabling override for an attribute, for an instance of the data entity, a user may: (1) command an override of an inherited value; and (2) input an override value as the value of the attribute.

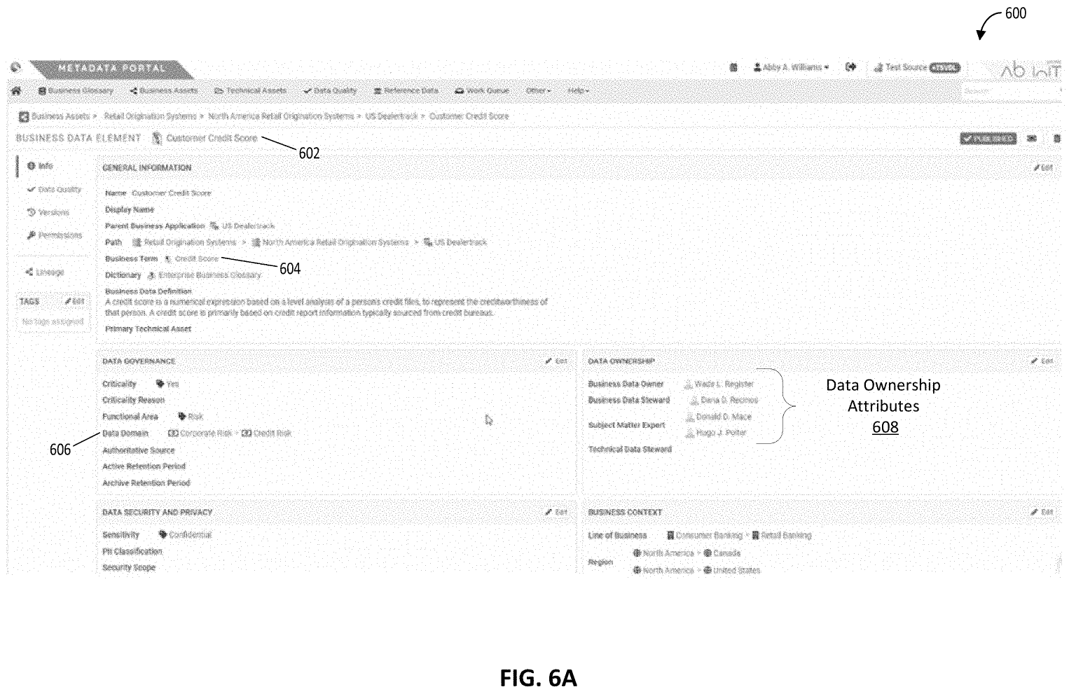

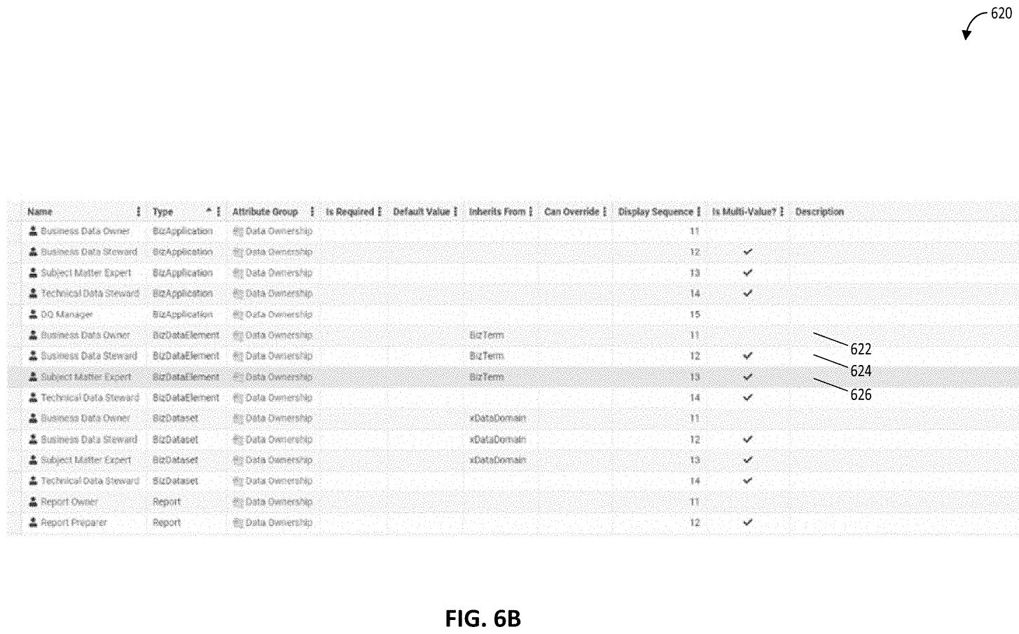

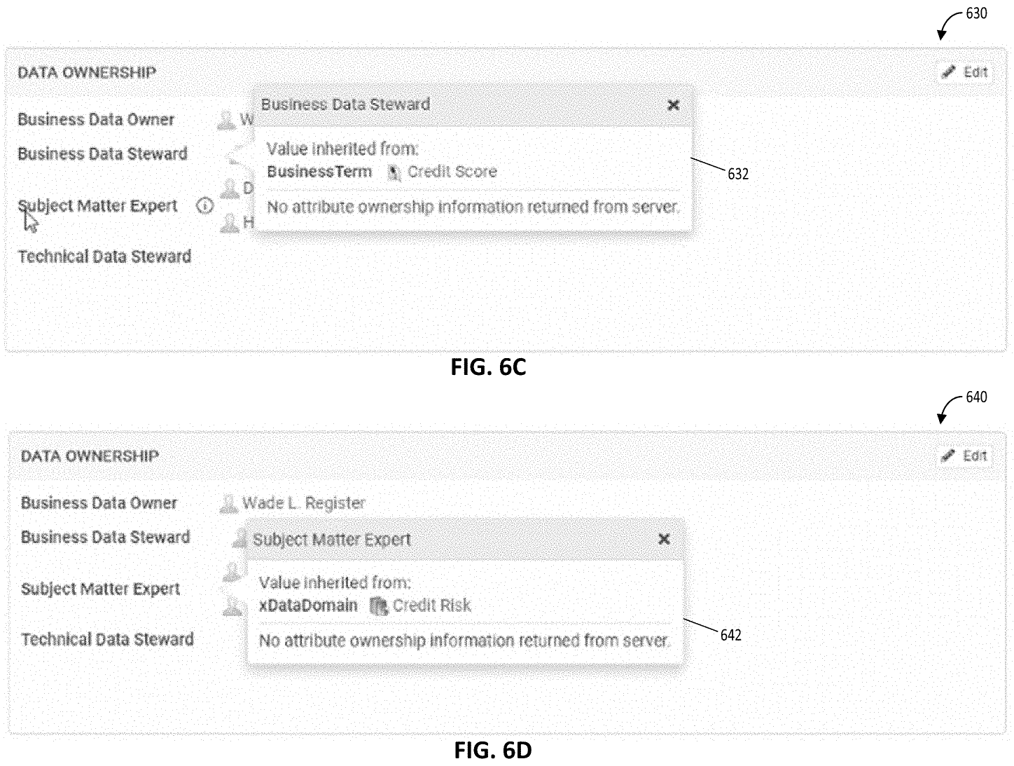

In some embodiments, the GUI(s) 112 may include a GUI that displays information about a data entity instance. The GUI may be configured to display attribute values of the data entity instance. An example GUI that displays information about a data entity instance is described herein with reference to FIG. 1H. In some embodiments, the GUI may be configured to indicate a source of from which an attribute value is inherited. The GUI may be configured to indicate a data entity and/or data entity instance from which the attribute of the data entity instance inherits its value. For example, the GUI may generate a portion of the GUI (e.g., when a user hovers a cursor over an attribute name) that displays a name of a data entity and/or data entity instance from which the attribute value is inherited. Example GUI portions are described herein with reference to FIGS. 4D-G and FIGS. 6C-D.

In some embodiments, the GUI(s) 112 may include a GUI configured to indicate whether an attribute of a data entity instance is configurable to override its inherited value. The GUI may include a portion indicating whether the attribute is configurable to override its inherited value. For example, the GUI may be configured to display a graphical element (e.g., an icon) indicating whether an attribute is configurable to override its inherited value. In some embodiments, a first graphical element (e.g., a pencil icon) may indicate that an attribute is configurable to override its inherited value and a second graphical element (e.g., a lock icon) may indicate that the attribute is not configurable to override its inherited value. Example GUI portions are described herein with reference to FIGS. 4D-G and FIGS. 6C-D.

In some embodiments, the GUI(s) 112 may include a GUI configured to allow user(s) 102 to set attribute values of a data entity instance. The GUI may be configured to allow a user to input attribute values. For example, the GUI may include one or more text input fields that allow a user to enter a string as an attribute value. In another example, the GUI may provide a list of options from which a user may select one or more attribute values.

In some embodiments, the GUI(s) 112 may include a GUI that allows a user to submit a request for information about one or more data entity instances. In some embodiments, the GUI may be configured to include a query generator that allows a user to generate and submit a query for information about the data entity instance(s). In some embodiments, the GUI may be configured to provide a search field in which a user may enter search terms to retrieve information about one or more data entity instances stored by the data processing system 105. In some embodiments, the GUI may provide a filter interface in which a user may provide input specifying criteria based on which data entity instances may be filtered by the data processing system 105.

In some embodiments, the script interfaces 114 may allow the user(s) 102 to access information about data entity instances using scripts. In some embodiments, a scripting interface may be a program written using a scripting language. For example, the scripting interface may be a JAVASCRIPT program of a website written using JAVASCRIPT. The scripting interface may allow a user to request information about data entity instances. For example, the scripting interface may allow a user to submit a query for information about one or more data entity instances.

In some embodiments, the graph-based computer programs 116 may be used by one or more users 102 to perform data processing using the data processing system 105. In some embodiments, a graph-based computer program may be a dataflow graph. The dataflow graph may include components called “nodes” or “vertices,” representing data processing operations to be performed on data and links between components representing flows of data. Techniques for executing computations encoded by dataflow graphs are described in U.S. Pat. No. 5,966,072, titled “EXECUTING COMPUTATIONS EXPRESSED AS GRAPHS,” which is incorporated by reference herein in its entirety. An environment for developing computer programs as data flow graphs is described in U.S. Pat. Pub. No.: 2007/0011668, titled “Managing Parameters for Graph-Based Applications,” which is incorporated by reference herein in its entirety.

In some embodiments, one or more third party applications 116 may provide an interface through which user(s) 102 may interact with the data processing system 105. In some embodiments, the third party application may be a web application through which the user(s) 102 may interact with the data processing system 105. For example, the third party application may be a website through which user(s) 102 can request information about data entities and/or instances thereof. In another example, the third party application may be a mobile application through which user(s) 102 can request and view information about data entities.

In some embodiments, the data entity access system 120 may be configured to manage data entities and data entity instances stored by the system 105. The data entity access system 120 includes an inheritance module 122, an override module 124, a graphical user interface module 126, a lineage module 128, a permissions module 130, a report generation module 132, and a data access module 140. In some embodiments, each of the modules 122, 124, 126, 128, 130, 132 may include a set of processor-executable instructions that, when executed, by a data processing system, cause the data processing system to perform the described functions of the module. In some embodiments, the data entity access system 120 may include one or more modules instead of or in addition to the modules shown in FIG. 1H.

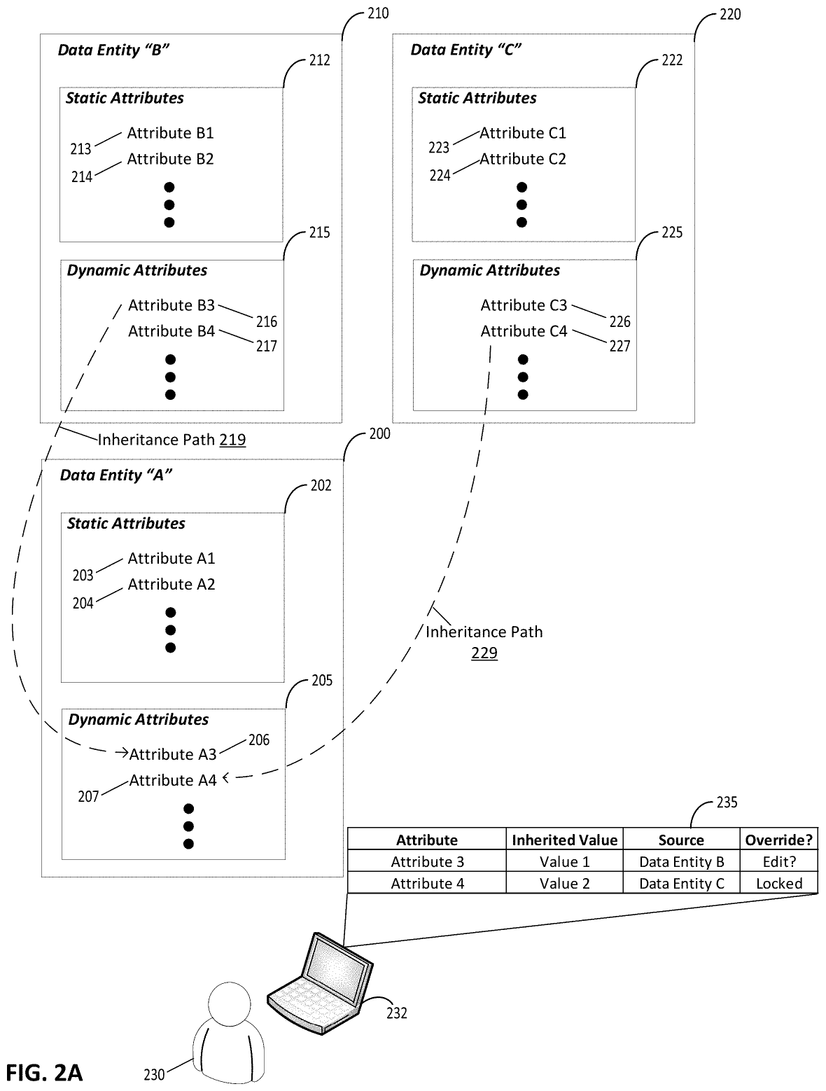

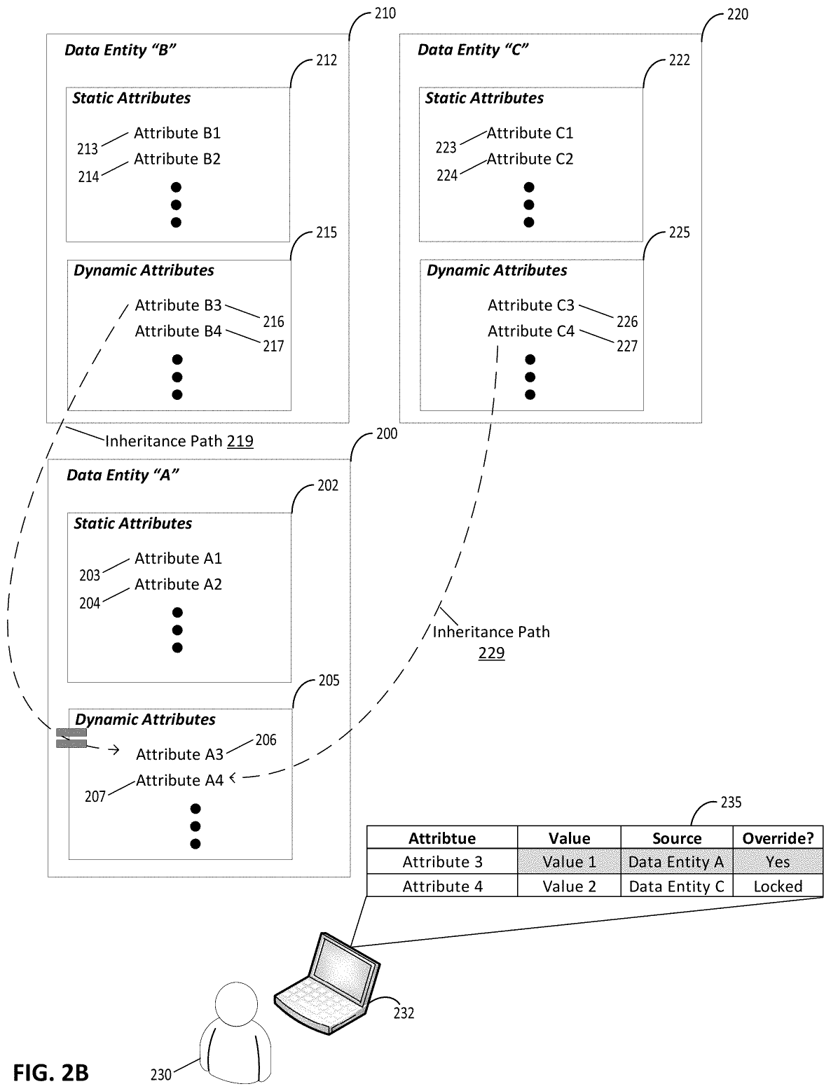

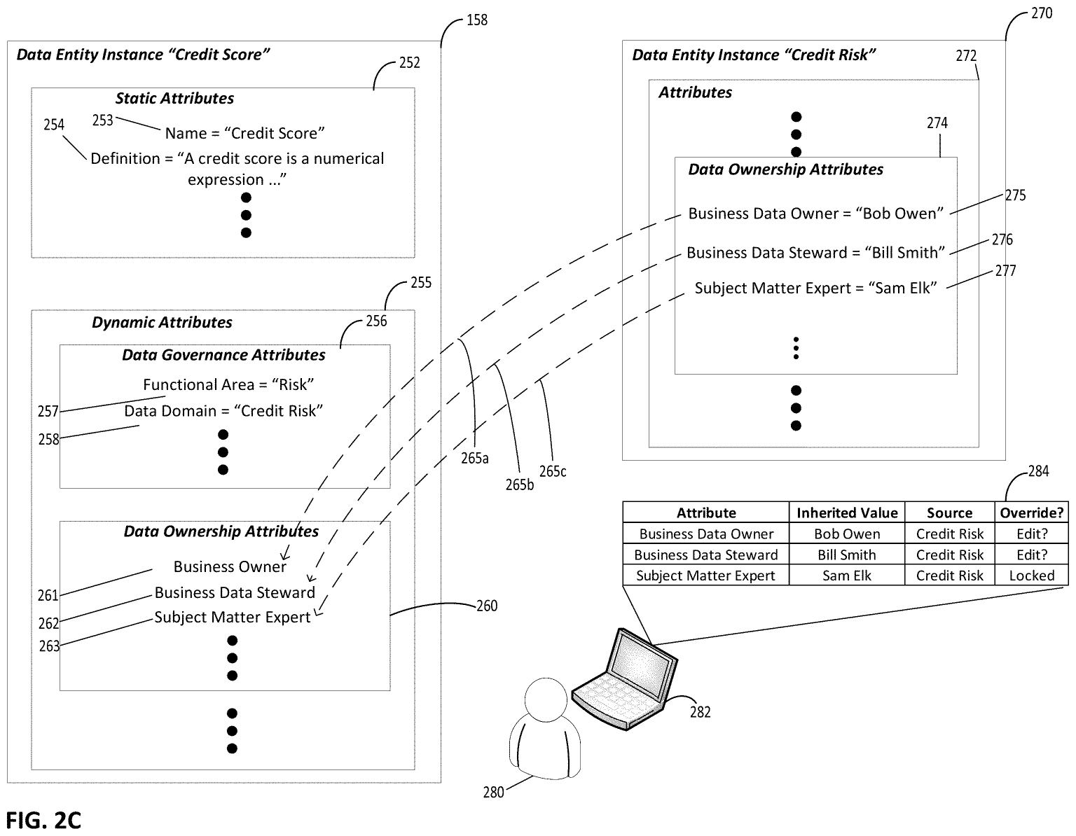

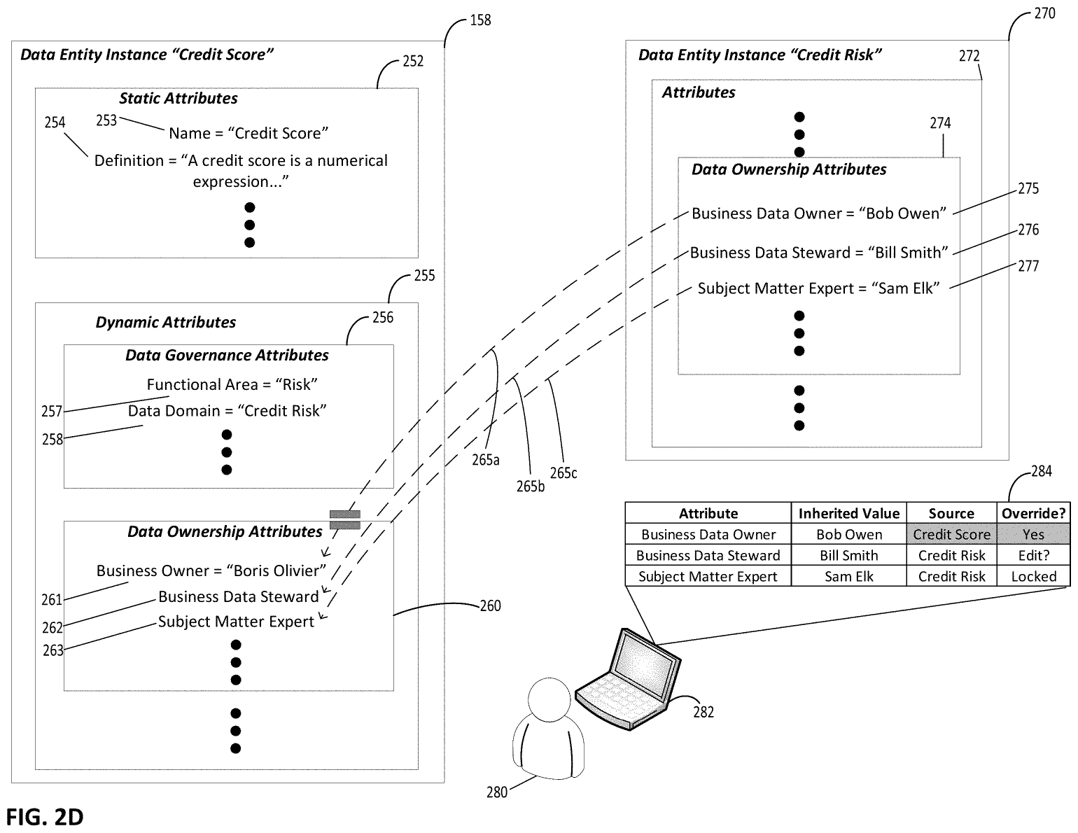

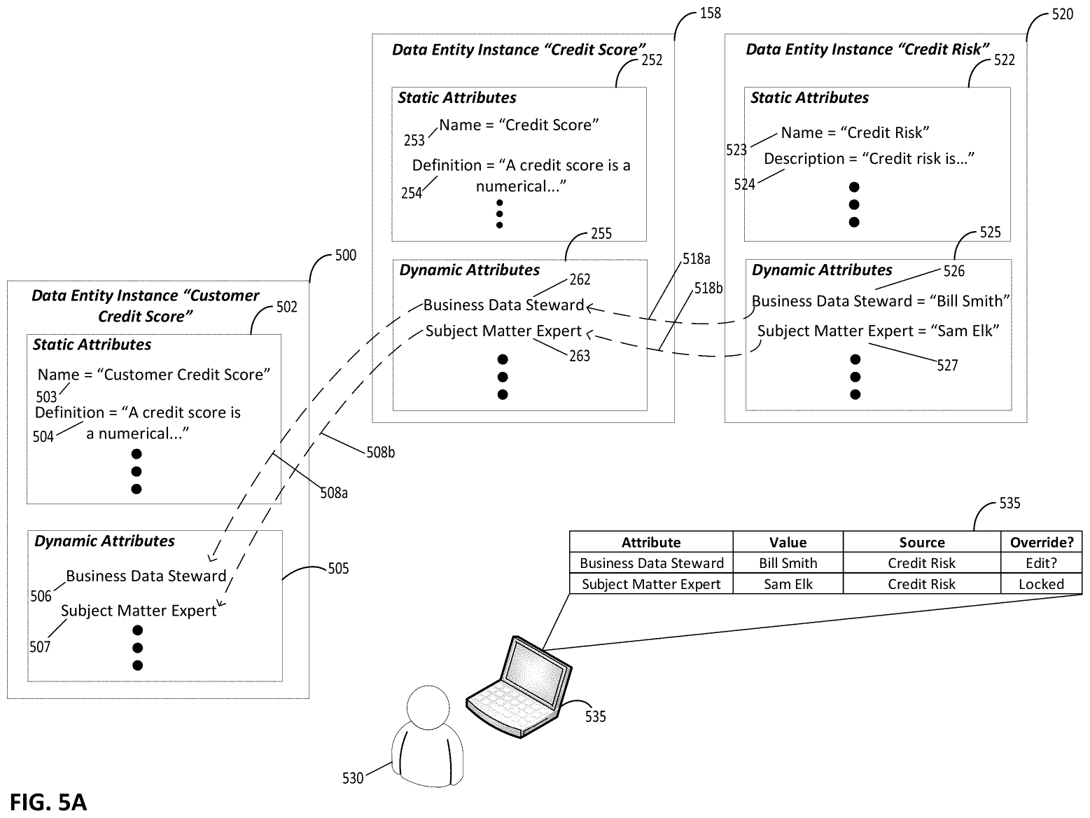

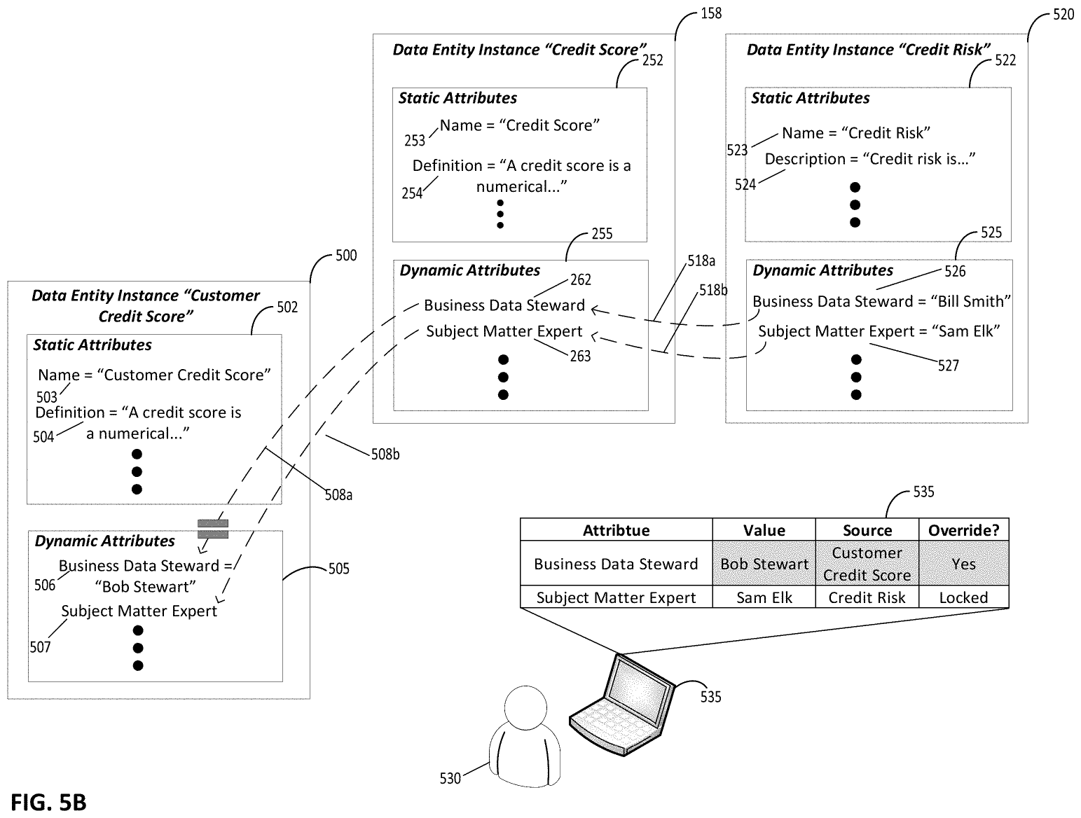

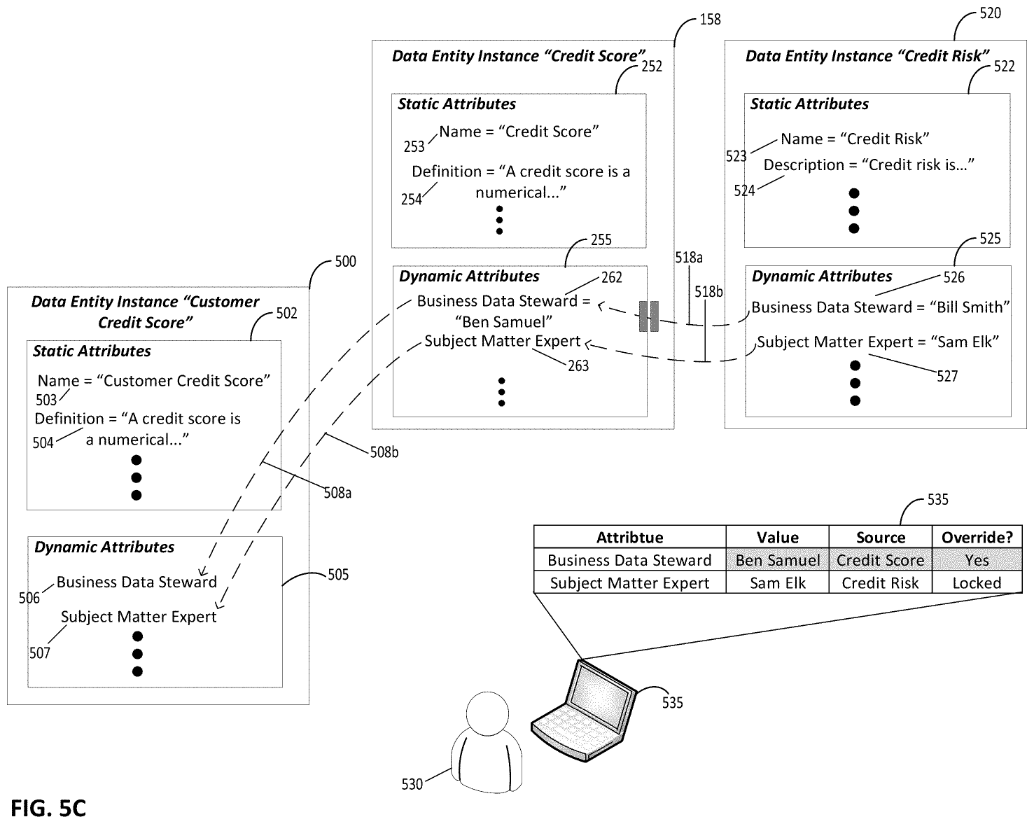

In some embodiments, the inheritance module 122 may be configured to manage inheritance of attributes among data entities and instances thereof. The inheritance module 122 may be configured to configure one or more attributes of a data entity to inherit values from another data entity. For example, the inheritance module 122 may be configured to store information mapping the attribute(s) of the data entity to one or more attributes of the other data entity that are to be inherited. The mapping may indicate one or more inheritance paths through which attribute(s) are inherited. An inheritance path may be a sequence of one, two or more steps, each associated with a data entity instance, where each step comprises an indication (e.g., a reference or a pointer) that an attribute of the data entity instance associated with the step is configured to inherit its value from an attribute of another data entity instance associated with a subsequent step. Example inheritance paths are described herein with reference to FIGS. 2A-D and FIGS. 5A-C.

In some embodiments, the inheritance module 122 may be configured to store an indication of a source for inherited attribute(s) of a data entity. The source may be an indication (e.g., a name or other identifier) of a data entity from which the attribute(s) are to be inherited from. In some embodiments, the inheritance module 122 may be configured to allow a user to specify a data entity from which an attribute is to be inherited (e.g., in a GUI for defining the data entity). An example of how the inheritance module 122 manages inheritance among data entities is described herein with reference to FIG. 2A.

In some embodiments, the inheritance module 122 may be configured to configure attributes of data entities to inherit values. For example, the inheritance module 122 may change values in configuration information for an attribute to configure the attribute to inherit its value. In some embodiments, the inheritance module 122 may be configured to determine whether an attribute inherits from another attribute (e.g., using configuration information for the attribute). The inheritance module 122 may be configured to identify where the attribute inherits its value from. The inheritance module 122 may be configured to determine the inherited attribute value(s) using the information indicating the inheritance path(s). For example, the inheritance module 122 may determine: (1) that a first attribute of a first data entity instance is configured to inherit its value from a second attribute of a second data entity instance; and (2) a value of the first attribute by determining the value of the second attribute using a reference stored in the first data entity instance. An example of how the inheritance module 122 manages inheritance among data entity instances is described herein with reference to FIG. 2C and FIG. 5A. Examples of how the inheritance module 122 manages inheritance among data entity instances are illustrated by the graphical user interfaces (GUIs) of FIGS. 4A-G and FIGS. 6A-D.

In some embodiments, the inheritance module 122 may be configured to store information indicating whether an attribute value of the data entity instance is inherited. For example, the inheritance module 122 may store information identifying a data entity and/or data entity instance from which one or more attributes of the data entity instance are configured to inherit value(s) from. In some embodiments, the inheritance module 200 may be configured to store the information within the data entity instance. For example, the inheritance module 200 may store one or more attributes in the data entity instance indicating one or more other data entity instances from which the data entity instance inherits attribute values. In some embodiments, the inheritance module 200 may be configured to store the information separate from the data entity instance. For example, the inheritance module 200 may store the information in a separate data object (e.g., a file) associated with the data entity instance.

In some embodiments, the inheritance module 122 may be configured to determine values of one or more inherited attribute values of a data entity instance. For example, the inheritance module 122 may determine the values in response to a request for information about the first data entity instance that requests the values of the inherited attribute value(s). The inheritance module 122 may be configured to determine a value of a first attribute of a first data instance by accessing a value of a second attribute from a second data entity instance that the first attribute is configured to inherit its value from. The inheritance module 122 may be configured to output the determined value (e.g., to generate a response to a request for information about the first data entity instance).

In some embodiments, the override module 124 may be configured to manage overrides of inherited attributes of data entities. In some embodiments, the override module 124 may be configured to set whether an attribute is configurable to override an inherited value (e.g., by setting a value in configuration information of the attribute). For example, the override module 124 may set a variable (e.g., a Boolean or integer value) in a data entity for an attribute indicating whether the attribute is configurable to override an inherited value. In some embodiments, the override module 124 may be configured to allow a user to specify whether an attribute is configurable to override an inherited value (e.g., in a GUI for defining a data entity). The override module 124 may be configured to allow overriding of attribute values in instances of the data entity according to a specification of the data entity. An example of how the override module 124 manages attribute overrides of data entities is described herein with reference to FIG. 2B.

In some embodiments, the override module 124 may be configured to override inherited attribute values of a data entity instance. The override module 124 may be configured to override an inherited attribute value by replacing the attribute value with an override value. For example, the override module 124 may replace an inherited attribute value with an override value provided as user input in a GUI of the data processing system 105. In some embodiments, the override module 124 may be configured to output an override value as an attribute value (e.g., to provide a response to a request for the attribute value). An example of how the override module 124 manages overrides of inherited attributes in a data entity instance is described herein with reference to FIG. 2D.

In some embodiments, the override module 124 may be configured to determine whether an attribute of a data entity instance is configurable to override an inherited value. In some embodiments, the override module 124 may be configured to determine whether attribute of the data entity instance is configurable to override an inherited value based on a data entity from which the data entity instance was generated. For example, the override module 124 may determine whether the data entity specifies that the attribute is configurable to override the inherited value. In some embodiments, the override module 124 may be configured to store a value (e.g., a Boolean or integer value) in the data entity instance indicating whether the attribute is configurable to override an inherited value.

In some embodiments, the graphical user interface module 126 may be configured to generate the GUI(s) 112 through which user(s) 102 may interact with the data processing system 105. In some embodiments, the graphical user interface module 126 may be configured to generate a GUI displaying information about a data entity instance. The GUI may be configured to display information about attributes of the data entity instance (e.g., attribute values). In some embodiments, the graphical user interface module 126 may be configured to generate a portion of the GUI that indicates a source of an inherited attribute value. For example, the graphical user interface module 126 may generate an overlaid portion on the GUI indicating a source data entity and/or data entity instance from which an attribute value is inherited.

In some embodiments, the graphical user interface module 126 may be configured to generate a portion of the GUI that indicates whether an inherited attribute is configurable to override an inherited value. For example, the graphical user interface module 126 may generate a first icon (e.g., a pencil icon) indicating that the attribute is configurable to override an inherited value, and a second icon (e.g., a lock icon) indicating that the attribute is not configurable to override an inherited value. In some embodiments, the graphical user interface module 126 may be configured to generate a portion of the GUI that states whether an attribute is configurable to override an inherited value. For example, in response to a user hovering a cursor over the first icon, the module 126 may generate a message indicating that the inherited attribute value can be overridden.

In some embodiments, the graphical user interface module 126 may be configured to generate a GUI that allows a user to define a data entity. The GUI may allow the user to define inheritance of attributes and indicate whether attributes are configurable to override an inherited value. The graphical user interface module 126 may provide user input to the GUI to the inheritance module 122 and override module 124.

In some embodiments, the lineage module 128 may be configured to manage lineage information for data managed by the data processing system 105. The lineage module 128 may be configured to manage the entity relations stored in data persistence layer 150. In some embodiments, the lineage module 128 may be configured to determine relations among data entity instances. In some embodiments, the lineage module 128 may be configured to determine relations among the data entity instances based on inheritance of attribute values among the data entity instances. In some embodiments, the linage module 128 may be configured to determine relations among data entity instances based on other factors instead of or in addition to inheritance of attribute values. For example, the lineage module 128 may be configured to determine relations based on how data (e.g., data entity instance(s)) was obtained, how the data has changed over time, and/or how the data is used. In some embodiments, the lineage module 128 may be configured to automatically generate lineage information. Aspects of generating lineage information are described in U.S. Pat. No. 10,489,384, entitled “SYSTEMS AND METHODS FOR DETERMINING RELATIONSHIPS AMONG DATA ELEMENTS”, which is incorporated herein by reference in its entirety.

In some embodiments, the permissions module 130 may be configured to manage permissions of users using the data processing system 105. The permissions module 105 may be configured to determine whether a user can edit an attribute value in a data entity instance. The permissions module 130 may be configured to determine whether a user can override an inherited attribute value (e.g., using the override module 124). In some embodiments, the permission module 130 may manage access to data. For example, the permission module 130 may determine which data entity instances a user can request access for according to a role (e.g., administrator or manager) of the user. In some embodiments, the permission module 130 may provide access to a user according to the role. For example, the permissions model 130 may be configured to determine read, update, create, and/or delete permissions based on a user role.

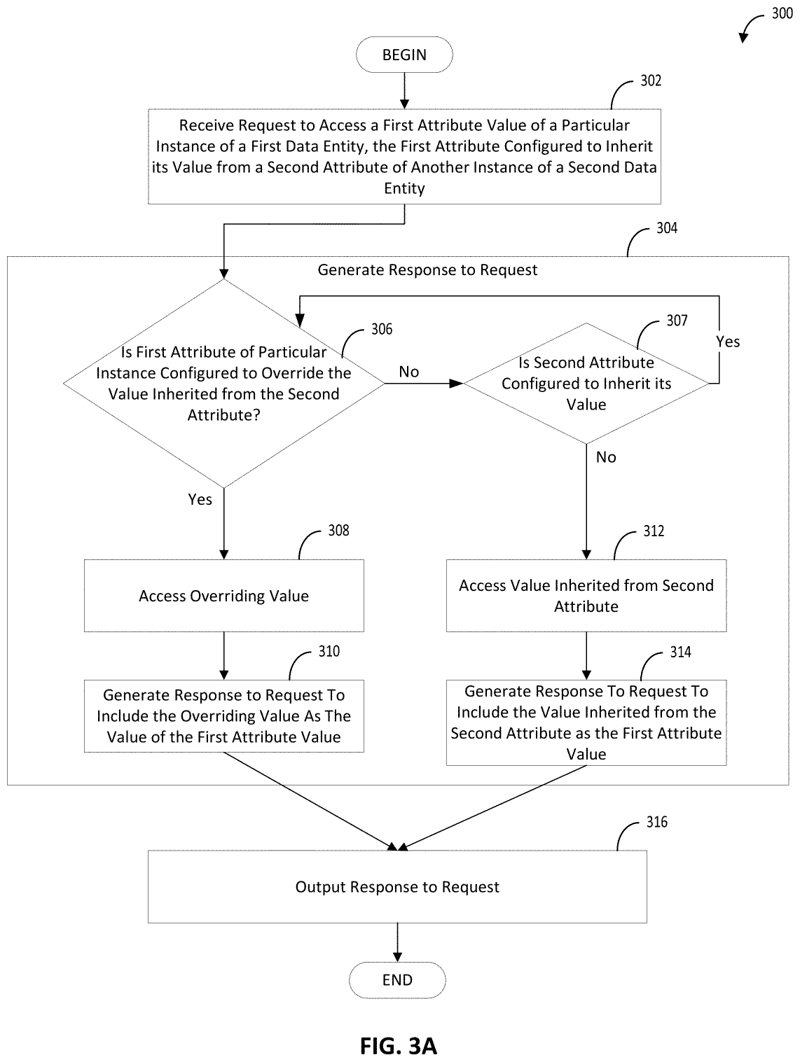

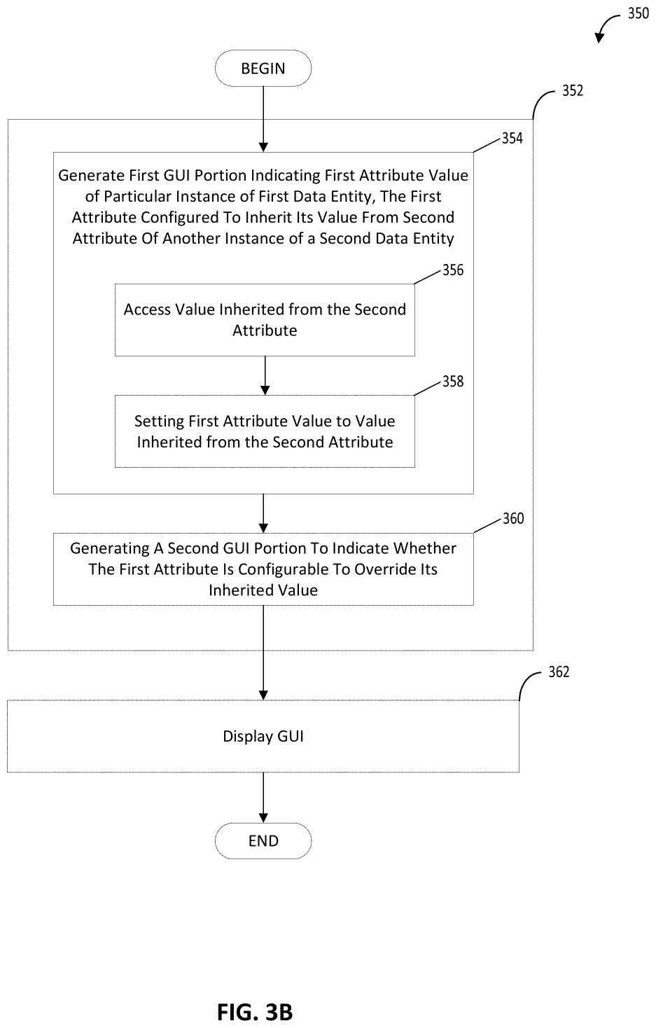

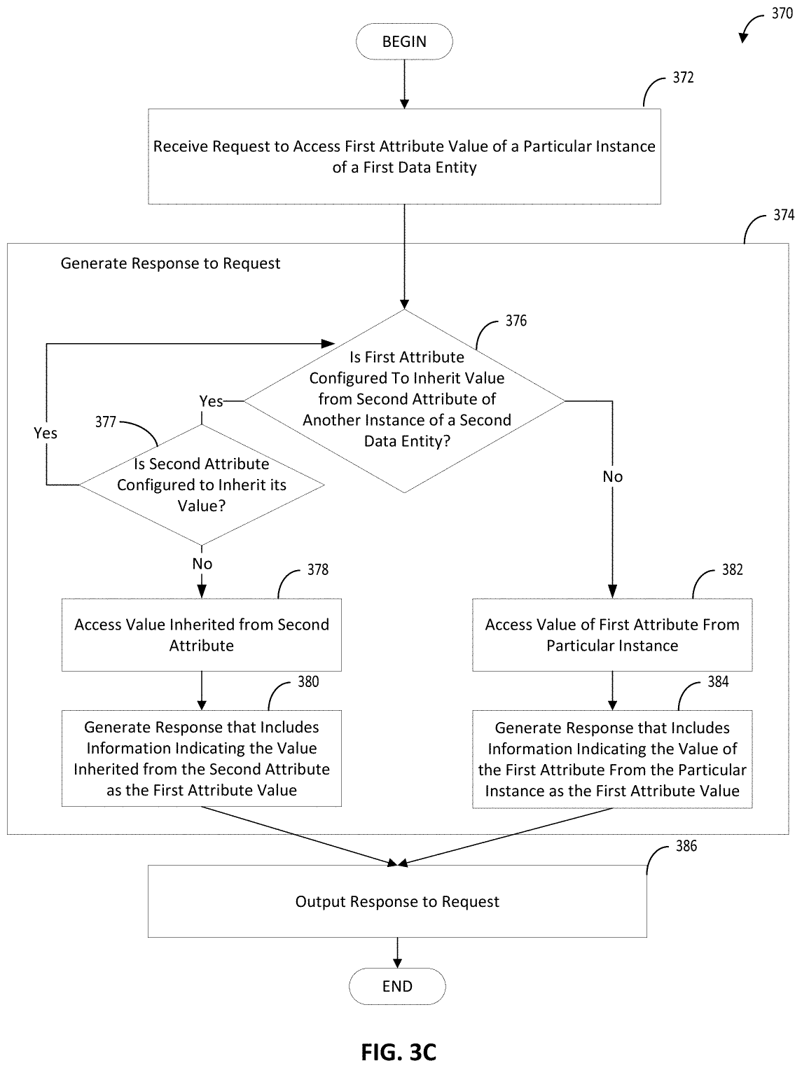

In some embodiments, the report generation module 132 may be configured to generate information about data entities and/or instances thereof stored by the data processing system 105. In some embodiments, the report generation module 132 may be configured to output information in response to a request submitted by a user. The request may be a query for information about one or more data entity instances. For example, the query may be an executable structured query language (SQL) query. The report generation module 132 may be configured to output attribute values of data entity instances requested by a user. Example processes for generating a response to a request are described herein with reference to FIGS. 3A-C.

In some embodiments, the data access module 140 may be used by the data processing system to access data stored by the system (e.g., in the data persistence layer 150). As shown in FIG. 1H, the data access module 140 may be configured to submit a data request 142 to the data persistence layer 150 and receives data in response to the data request 142. In some embodiments, the data access module 140 may be configured to submit a query for data. For example, the data access module 140 may submit an SQL query for data. In some embodiments, the data 144 may be data specified by the request. For example, the data 144 may be one or more values requested in a query. The data access module 140 may be used by other modules of the data entity access system 120 to obtain and store data. In some embodiments, the data access module 140 may be configured to submit multiple queries (e.g., SQL queries).

In some embodiments, the query may be customized in a vendor-specific manner. For example, different vendors (e.g., MICROSOFT, ORACLE, IBM, POSTGRESQL, etc.) may implement different dialects of SQL and/or provide extensions to the SQL standard. In such situations, the executable query may be generated for a target database system (e.g., ORACLE) using the syntax and/or commands implemented by the target database system (e.g., using any special syntax and/or commands implemented by ORACLE). Additionally or alternatively, the query may include optimizations to the query that may be supported using the target database system. Accordingly, in some embodiments, a query for one type of database (e.g., an executable SQL query for MICROSOFT SQL SERVER database) may be different from a query for another type of database (e.g., an executable SQL query for IBM DB2) even where both queries would be generated from the same underlying intermediate representation.

In some embodiments, the data access module 140 may be configured to request one value of one attribute of a data entity instance, multiple values of multiple attributes of a data entity instance, and one or more values of one or more attributes of multiple data entity instances. In some embodiments, the data access module 140 may be configured to request values of 1-10, 5-20, 10-30, 50-100, 100-500, 500-1000 attributes, or any other suitable range within these ranges. In some embodiments, the data access module 140 may be configured to request one, tens, hundreds, thousands, millions, tens of millions, and/or hundreds of millions of data entity instances. For example, the data access module 140 may request 1-10, 10-100, 100-1000, 1000-10,000. 10,000-100,000, 100,000-1,000,000, 1,000,000-10,000,000, 10,000,000-100,000,000, 100,000,000-1,000,000,000 data entity instances, or any other suitable range within these ranges.

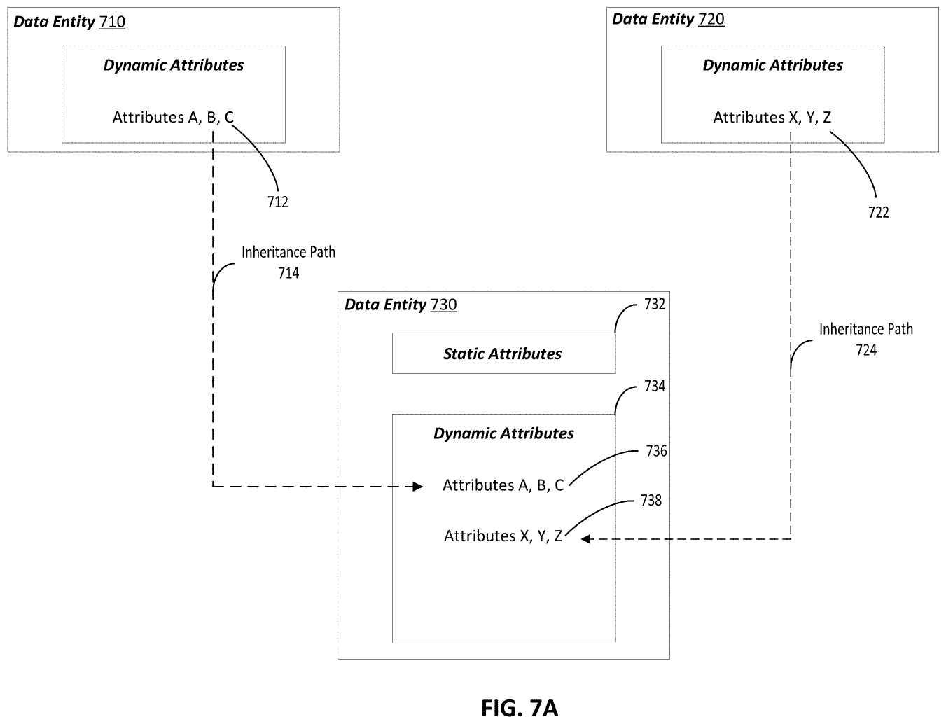

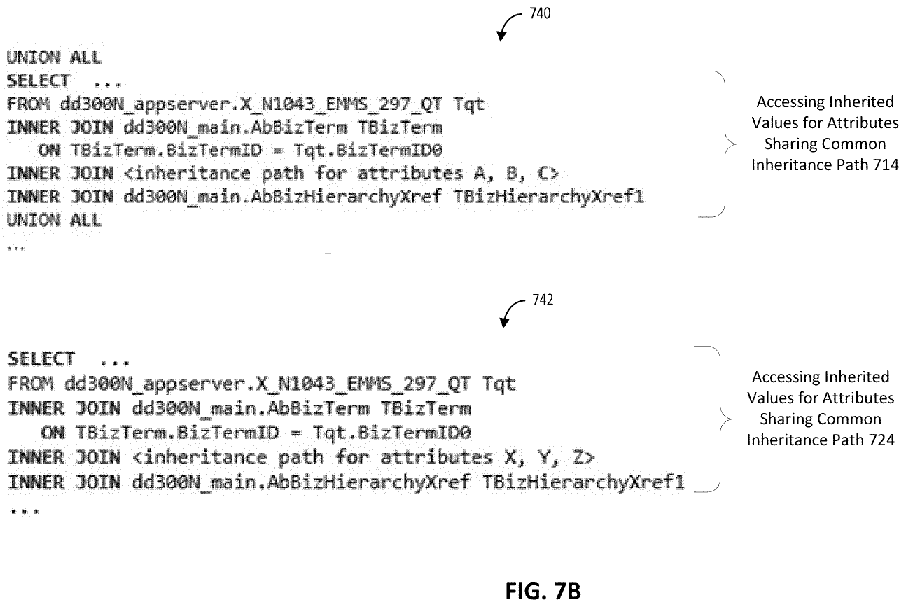

More generally, when values of multiple different attributes are being retrieved, in some embodiments, the data processing system may be configured to generate a separate query (e.g., SQL query) to obtain the values of each attribute. As indicated by the example of FIGS. 7A-B below, in some embodiments, rather than generating a separate query for each attribute, the data processing system may group attributes into one or more groups (using any suitable criterion, examples of which are provided herein) and generate a query for each of the groups. By generating separate queries for different groupings of attributes, the data entity access module 140 may reduce the overall number of queries being generated and executed. That, in turn, may reduce the computational burden on the data processing system when retrieving attribute values. One example of a criterion for grouping attributes, as described below, is to group attributes that share a common inheritance path into a single group. Other examples of criterion for grouping attributes include data type (e.g., integer, string, or other data type), attributes whose values are stored in the same table, attributes whose values are overridden, and/or any other suitable criterion for grouping attributes.

In some embodiments, multiple attributes that are configured to share a common inheritance path may be grouped together in a query. This is described in more detail next with reference to FIGS. 7A and 7B.

In some embodiments, a data entity's attribute may be configured to inherit its value from a corresponding attribute of another data entity. For example, as shown in FIG. 7A, Data Entity 730 may include static attributes 732 and dynamic attributes 734. Among the dynamic attributes 734, attributes “A, B, C” 736 are configured to inherit their values from corresponding attributes 712 of data entity 710, as indicated by a common inheritance path 714. That is, attributes of a data entity or data entity instance share a common inheritance path if the attributes are configured to inherit their values from attributes of the same other data entity or data entity instance. Attributes “X”, “Y”, “Z” 738 are configured to inherit their values for corresponding attributes 722 of data entity 720, as indicated by common inheritance path 724. Thus, in response to a request or a query for the values of the attributes 734 of an instance of data entity 730, the values of attributes 736 and of attributes 738 need to be obtained. Since the attributes A, B, and C are configured to inherit their values along a common inheritance path 714 (e.g., from the same instance of data entity 710)), a single query (e.g., an SQL query) may be used to access the inherited values for these attributes. Query 740 in FIG. 7B is an example of such a query. Similarly, since the attributes X, Y, and Z are configured to inherit their values along a common inheritance path 724 (e.g., from the same instance of data entity 720), a single query may be used to access the inherited values for these variables. Query 742 in FIG. 7B is an example of such a query.

In some embodiments, the data access module 140 may be configured to access information about a data entity instance, wherein the information includes one or more values of one or more attributes of the data entity instance. The data access module 140 may be configured to access a value of an attribute by determining whether the attribute is configured to inherit its value from another data entity instance. In some embodiments, the data access module 140 may be configured to: (1) use a first mechanism to access the value of the attribute when it is determined that the attribute is configured to inherit its value; and (2) use a second mechanism to access the value of the attribute when it is determined that the attribute is configured to not inherit its value. For example, the data access module 140 may use a first query (e.g., a first SQL query) to access the value when the attribute is configured to inherit its value and use a second type of query (e.g., a second SQL query) when the attribute is not configured to inherit its value.

In some embodiments, the data access module 140 may be configured to access a value of an attribute configured to inherit its value by: (1) determining whether the attribute is configured to override its inherited value; and (2) accessing the value of the attribute based on whether the attribute is configured to override its inherited value. The data access module 140 may be configured to access the value of the attribute by accessing an overriding value when it is determined that the attribute is configured to override its inherited value. For example, the data access module 140 may submit a first query (e.g., a first SQL query) to the data persistence layer 150 when the attribute is configured to override its inherited value and a second query (e.g., a second SQL query) when the attribute is not configured to override its inherited value.

In some embodiments, the data access module 140 may be configured to provide functionality through which data entities can be defined. For example, the data entity access system 120 may use the data access module 140 to configure a new data entity, modify an existing data entity, or delete a data entity. In some embodiments, the data access module 140 may be configured to provide functionality for the data entity access system 120 to create, update, delete, and/or query data entity instances. For example, the data access module 140 may provide an application program interface (API) through which the functionality may be performed.

As shown in the example embodiment of FIG. 1H, the data persistence layer 150 includes a data store for storing data entities 152, data entity instances 153, and data entity relations 154. In some embodiments, a data store may include a relational database system so that data may be stored in tables of the relational database system. However, a data store is not limited to being relational database systems, as a data store may be configured to store data in any suitable way. For example, a data store may comprise an object-oriented database, a distributed database, a NoSQL database and/or any other suitable database.

In some embodiments, each of the data store may include one or multiple storage devices storing data in one or more formats of any suitable type. For example, the storage device(s) part of a data store may store data using one or more database tables, spreadsheet files, flat text files, and/or files in any other suitable format (e.g., a native format of a mainframe). The storage device(s) may be of any suitable type and may include one or more servers, one or more database systems, one or more portable storage devices, one or more non-volatile storage devices, one or more volatile storage devices, and/or any other device(s) configured to store data electronically. In embodiments where a data store includes multiple storage devices, the storage devices may be co-located in one physical location (e.g., in one building) or distributed across multiple physical locations (e.g., in multiple buildings, in different cities, states, or countries). The storage devices may be configured to communicate with one another using one or more networks of any suitable type, as aspects of the technology described herein are not limited in this respect.

As shown in the example embodiment of FIG. 1H, the data persistence layer 150 stores data entities. The data persistence layer 150 may be configured to store information defining a data entity. For example, a data entity may specify an identifier of the data entity, attributes in the data entity, type of value for the attributes, inheritance of attributes of the data entity, and/or override setting for an inherited attribute. The data persistence layer 150 may be configured to store information about data entities that the data entity inherits attributes from. For example, the data persistence layer 150 may store name of a data entity from which attributes are inherited.

As shown in the example embodiment of FIG. 1H, the data persistence layer 150 stores data entity instances 153 in a data store. The data store may be configured to store attribute values of data entity instances, inheritance paths for attribute value inheritance, identifiers for the data entity instances, permissions for the data entity instances, and other information about the data entity instances. The data store is configured to store relations 154 among data entity instances. The data store may be configured to store relations among data entity instances determined by the lineage module 128. For example, the data store may store information mapping data entity instances based on linage information determined by the linage module 128.

FIG. 2A is a diagram illustrating a data entity A 200 with attributes configured to inherit values from data entity B 210 and data entity 220 C in a data processing system, in accordance with some embodiments of the technology described herein. For example, the data entities 200, 210, 220 may be data entities configured in data processing system 105 described herein with reference to FIGS. 1A-I.

As shown in FIG. 2A, each of the data entities 200, 210, 220 includes a respective set of attributes. Data entity A 200 includes: (1) static attributes including attributes 202 A1 203 and A2 204; and (2) dynamic attributes 205 including attributes A3 206 and A4 207. Data entity B 210 includes: (1) static attributes 212 including attributes B1 213 and B2 214; and (2) dynamic attributes 215 including attributes B3 216, and B4 217. Data entity C includes: (1) static attributes 222 including attributes C1 223 and C2 224; and (2) dynamic attributes 225 including attributes C3 226 and C4 227. Each of the data entities 200, 210, 220 may include other attributes not shown in FIG. 2A.

In some embodiments, one or more attributes of a data entity may be configured to inherit values from one or more other data entities. As shown in the example of FIG. 2A: (1) attribute A3 206 of data entity A 200 is configured to inherit its value from data entity B 210 through inheritance path 219; and (2) attribute A4 207 of data entity A 200 is configured to inherit its value from data entity C 220 through inheritance path 229. Accordingly, in an instance of data entity A 200: (1) a value of attribute A3 206 is determined according to a value of attribute B3 216 in an instance of data entity B 210; and (2) a value of attribute A4 207 is determined according to a value of attribute C4 227 in an instance of data entity C 220. When a value of attribute B3 216 in an instance of data entity B 210 is set (e.g., entered and/or modified), the value may be propagated to an attribute A3 206 of an instance of data entity A 200. When a value of attribute C3 226 in an instance of data entity C 220 is set, the value may be propagated to an attribute A4 207 of the instance of data entity A 200.

In some embodiments, a data processing system may be configured to allow an attribute of a data entity instance to inherit its value from an attribute of another data entity instance. As shown in FIG. 2A, a user 230 may access the data processing system using a computing device 232. The data processing system may be configured to allow the user 230 to define inheritance of attributes in data entity A 200. For example, the data processing system may generate a graphical user interface (GUI) that allows the user 230 to define data entity A 200. In another example, a software application may programmatically define data entity A 200. In another example, the data processing system may allow defining of the data entity A 200 through a configuration file, an application program interface (API) call, or any other suitable way. As shown in table 235, data entity A 200 specifies that the source of the value of attribute A3 206 is an attribute of data entity B 210, and the source of the value of attribute A4 207 is data entity C 220. Accordingly, data entity A 200 specifies that the value of attribute A3 206 is inherited from data entity B 210, and value of attribute A4 207 is inherited from data entity C 220.

In some embodiments, a data processing system may be configured to allow overriding of an inherited attribute value. As shown in FIG. 2A, the data processing system may provide a configuration option that allows the user 230 to override an inherited attribute value. As shown in table 235 of FIG. 2A, attributes of data entity A 200 may be configured to be overridable. The attribute A3 206 is set to be overridable as indicated by the first entry of “Edit?” in the “Override?” column, and the attribute A4 207 is set to be not overridable as indicated by the second entry of “Locked” in the “Override?” column. It should be appreciated that an attribute being configured as overridable does not necessitate that a value inherited by the attribute must be overridden. Rather, an attribute configured as overridable has the option of being overridden (e.g., by a user through a GUI, a configuration file, an API call, or any other suitable way).

FIG. 2B is a diagram illustrating an override of a value inherited by an attribute of data entity A 200 shown in FIG. 2A, in accordance with some embodiments of the technology described herein. In FIG. 2A, inheritance path 219 indicates that attribute A3 of data entity A 200 is configured to inherit its value from attribute B3 of data entity 210. In FIG. 2B, the inheritance of attribute A3 206 from attribute B3 216 is overridden as indicated by the “X” in inheritance path 219. As a result of the override, the attribute A3 206 may be determined to be an override value (e.g., a user input override value) instead of the value of attribute B3 216. For example, as a result of the override, a data processing system may set a value of attribute A3 206 in an instance of data entity A 200 to the override value instead of inheriting the value from attribute B3 216 of an instance of data entity B 210.

In some embodiments, a data processing system may be configured to override an inherited value of an attribute in a data entity when a user 230 uses a computing device 232 to override an inherited attribute value. In some embodiments, the data processing system may be configured to provide a graphical user interface (GUI) that allows the user to override the inherited value and enter an override value. Example GUIs that allows a user to override an inherited attribute are described herein with reference to FIGS. 4A-4G. In some embodiments, the data processing system may be configured to allow overriding of the inherited value with an override value by a configuration file, an API call, programmatically by a software application, or any other suitable way. Prior to an override, attribute A3 206 is configured to inherit its value from data entity B 210 as indicated in the first row of table 235 shown in FIG. A. When the inherited value of attribute A3 206 has been overridden, the data processing system may be configured to change the source of the value of attribute A3 206 as shown in the highlighted portion of table 235 shown in FIG. 2B. As shown in table 235, the source of attribute A3 206 has been updated from “Data Entity B” to “Data Entity A” indicating that attribute A3 206 is no longer configured to inherit its value from data entity B 210.

In some embodiments, one or more attributes of a data entity may be configured to prevent overriding of values inherited by the attribute(s). In the example of FIG. 2B, the value inherited by attribute A4 207 of data entity A 200 cannot be overridden as indicated by the “Locked” setting in the “Override?” column of FIG. 2B. Accordingly, the data processing system may not allow overriding of a value of attribute A4 207 inherited from attribute C4 227 of data entity 220. Thus, the data processing system may not allow overriding a value of attribute A4 207 in an instance of data entity A 200. In some embodiments, the data entity A 200 may be configured to store configuration information indicating that the attribute A4 207 is not configurable to be overridden. Thus, an instance of the data entity A 200 may not have the option of overriding a value inherited by the attribute A4 207 in the instance. In some embodiments, the data processing system may be configured to provide a GUI through which attributes can be configured as being overridable an inherited value. An example GUI through which an attribute can be configured as overridable is described herein with reference to FIG. 4C and FIG. 6B. In some embodiments, the attributes can be configured as being overridable by an API, configuration file, programmatically by a software application, or in any other suitable way.

FIG. 2C shows a diagram of the data entity instance “Credit Score” 158 with attributes that are configured to inherit values from the data entity instance “Credit Risk” 270, in accordance with some embodiments of the technology described herein. For example, the data entity instances 158, 270 may be data entity instances managed by data processing system 105 described herein with reference to FIGS. 1A-I.

As shown in the example of FIG. 2C, “Credit Score” 158 has a set of static attributes 252 and dynamic attributes 255. The static attributes 252 include “Name” 253 and “Definition” 254. The dynamic attributes 255 include data governance attributes 256 and data ownership attributes 260. The data governance attributes 256 include “Functional Area” 257 and “Data Domain” 258. The data ownership attributes 260 include “Business Data Owner” 261, “Business Data Steward” 262, and “Subject Matter Expert” 263. As indicated by the dotted lines, the data entity instance “Credit Score” 158 may have other attributes in addition or instead of those shown in FIG. 2C.

As shown in the example of FIG. 2C, the data entity instance “Credit Risk” 270 has attributes 272 including a set of data ownership attributes 274. The data ownership attributes 274 include “Business Data Owner” 275, “Business Data Steward” 276, and “Subject Matter Expert” 277. The data ownership attributes 260 of the data entity instance “Credit Score” 158 are configured to inherit values from the data ownership attributes 274 of the data entity instance “Credit Risk” 270. “Business Data Owner” 261 is configured to inherit the value “Bob Owen” from “Business Data Owner” 275 through inheritance path 265a, “Business Data Steward” 262 is configured to inherit the value “Bill Smith” from “Business Data Steward” 276 through inheritance path 265b, and “Subject Matter Expert” 263 is configured to inherit the value “Sam Elk” from “Subject Matter Expert” 277 through inheritance path 265c.

As shown in the example embodiment of FIG. 2C, the values inherited by the attributes of the data entity instance “Credit Score” 158 are not stored in the data entity instance “Credit Score” 158. When the values are to be retrieved (e.g., to respond to a request for information about the data entity instance 158), the values may be retrieved from the data entity instance “Credit Risk” 270. In some embodiments, the inherited values may be programmatically copied from the data entity instance “Credit Risk” 270 to the attributes of the data entity instance “Credit Score” 158. In some embodiments, the data entity instance “Credit Score” 158 may be configured to store information indicating the values that are to be inherited from the data entity instance “Credit Risk” 270. For example, the data entity instance “Credit Score” 158 may include one or more attributes whose value(s) are reference(s) to attributes of the data entity instance “Credit Risk” 270 from which values are to be inherited. In some embodiments, information indicating attribute values to be inherited from the data entity instance “Credit Risk” 270 may be stored separate from the data entity instance “Credit Score” 158. For example, a separate data entity instance may store information indicating attributes of the data entity instance “Credit Risk” 270 that attributes of the data entity instance “Credit Score” 158 are configured to inherit values from.

Table 284 of FIG. 2C shows an example configuration of the attributes of “Credit Score” 158 (e.g., defined by the user 280 in the data processing system using computing device 282). For example, table 284 may be shown in a GUI displaying information about the data entity instance “Credit Score” 158. As indicted in the “Source” column of table 284, the “Business Data Owner” 261, “Business Data Steward” 262, and “Subject Matter Expert” 263 attributes are all configured to inherit values from the data entity instance “Credit Risk” 270. As indicated in the “Inherited Value” column of table 284, “Business Data Owner” 261 is configured to inherit a value of “Bob Owen”, “Business Data Steward” 262 is configured to inherit a value of “Bill Smith”, and “Subject Matter Expert” 263 is configured to inherit a value of “Sam Elk”. As indicated in the “Override” column of table 284, “Business Data Owner” 261 and “Business Data Steward” 262 can be overridden while “Subject Matter Expert” 263 cannot be overridden (e.g., it is “Locked”). In some embodiments, the attributes of “Credit Score” 158 can be configured through a GUI (e.g., as described herein with reference to FIGS. 4A-G). In some embodiments, the attributes of “Credit Score” 158 can be programmatically configured by a software application. In some embodiments, the attributes of “Credit Score” 158 can be configured by an API call, a configuration file, or any other suitable way.

FIG. 2D is a diagram illustrating overriding of values inherited by attributes of the data entity instance “Credit Score” 158, in accordance with some embodiments of the technology described herein. As indicated by the “X” in inheritance path 265a, the attribute “Business Data Owner” 261 of the data entity instance “Credit Score” 158 is configured to override a value inherited from the attribute “Business Data Owner” 275 of the data entity instance “Credit Risk” 270. As shown in table 284, in the row indicating the configuration for “Business Data Owner” 261, the entry under “Source” has changed from “Credit Risk” to “Credit Score” and the entry under “Override?” has changed to “Yes”. The value for “Business Data Owner” 261 in the data entity instance “Credit Score” 158 is an override value of “Ben Oscar” (e.g., specified by the user 280 using computing device 282).

As shown in the example embodiment of FIG. 2D, the data entity instance “Credit Score” 158 may be configured to store the override value of the attribute “Business Data Owner” 261. In some embodiments, the override value of the attribute “Business Data Owner” 261 may be stored in a separate data entity instance. In some embodiments, the override value of the attribute “Business data Owner” 261 may be stored in a separate type of data structure (e.g., a table or other data structure) of override values.

FIG. 3A is a flowchart of an illustrative process 300 for generating a response to a request to obtain information about a data entity instance, in accordance with some embodiments of the technology described herein. Process 300 may be performed by any suitable computing device(s). For example, process 300 may be performed by data processing system 105 described herein with reference to FIGS. 1A-I. In one example, the process 300 may be performed by data entity access system 120 of data processing system 105.

Process 300 begins at block 302, where the system receives a request to access a first attribute value of a particular instance of a first data entity. The first attribute is configured to inherit its value from a second attribute of another instance of a second data entity. For example, the request may include a request for a value of the “Business Data Owner” attribute 261 in the data entity instance “Credit Score” 158 of FIG. 2C. In some embodiments, a user may submit the request. For example, a user may submit the request to view the information in a graphical user interface (GUI). In some embodiments, the request may be programmatically submitted by a software application. For example, a software application of a bank may generate the request in order to access metadata about credit score data. In some embodiments, the system (e.g., data processing system 105 or module thereof) may be configured to generate the request.

Next, process 300 proceeds to block 304, where the system generates a response to the request. At block 306 within block 304, the system determines whether the first attribute of the particular instance is configured to override the value inherited from the second attribute. In other words, the system determines whether the first attribute is configured to override a value inherited from the second attribute of the other instance. In some embodiments, the system may be configured to determine whether the first attribute is configured to override the inherited value by determining whether a stored override setting for the first attribute in the particular instance has been set. For example, the system may determine whether a Boolean value indicating whether the first attribute is configured to override the value inherited from the second attribute of the other instance.

If, at block 306, the system determines that the first attribute of the particular instance is configured to override the value inherited from the second attribute (e.g., “Business Data Owner” 261 of “Credit Score” 158 in FIG. 2D), then process 300 proceeds to block 308, where the system accesses the overriding value. In some embodiments, the system may be configured to transmit a query (e.g., to a data persistence layer) to obtain the overriding value. In some embodiments, the overriding value may be stored in the particular instance. For example, the overriding value may be stored as a value of the first attribute. In another example, the overriding value may be stored as a separate attribute in the particular instance. In some embodiments, the override value may be stored separate from the particular instance. After accessing the overriding value at block 308, process 300 proceeds to block 310, where the system generates a response to the request to include the overriding value as the first value of the first attribute. In some embodiments, the system may be configured to generate the response by generating data (e.g., a vector, array, or other data structure) indicating the overriding value as the first value of the first attribute.

If, at block 306, the system determines that the first attribute of the particular instance is not configured to override the value inherited from the second attribute (e.g., “Business Data Steward” attribute 262 of “Credit Score” 158 in FIG. 2D), then process 300 proceeds to block 307, where the system determines whether the second attribute is configured to inherit its value. For example, the second attribute may be configured to inherit its value from a third attribute of an instance of a third data entity different from the first data entity and the second data entity. In some embodiments, the system may be configured to make the determination by determining whether the second attribute is configured to inherit its value from the third attribute of the instance of the third data entity. For example, the system may access the second data entity to determine whether it specifies that the second attribute is configured to inherit its value from the third attribute of the third data entity. In some embodiments, the system may be configured to make the determination by checking whether the other instance stores information (e.g., an attribute value) indicating the third attribute of the instance of the third data entity from which the second attribute is configured to inherit its value.

If, at block 307, the system determines that the second attribute is configured to inherit its value, then process 300 returns to block 306, where the system determines whether the second attribute is configured to override a value inherited from the third attribute of the instance of the third data entity. If so, then the data processing system would further check whether the third attribute of the instance of the third data entity is configured to inherit its value from an instance of yet another data entity and so on until the system identifies a value. In this manner, the system may be configured to recursively follow an inheritance path to obtain the first attribute value.

If, at block 307, the system determines that second attribute is not configured to inherit its value, then process 300 proceeds to block 312, where the system accesses the value inherited from the second attribute. In some embodiments, the system may be configured to access the value inherited from the second attribute by reading a value of the second attribute stored in the other instance. For example, the system may locate the other instance from memory of the system, and read the value of the second attribute in the other instance. In some embodiments, the system may be configured to submit a query (e.g., to a data persistence layer) to read the value of the second attribute in the other instance. After accessing the value inherited from the second attribute at block 312, process 300 proceeds to block 314, where the system generates a response to the request including the value inherited from the second attribute as the first attribute value. In some embodiments, the system may be configured to generate the response by generating data (e.g., a vector, array, or other data structure) indicating the value inherited from the second attribute as the first attribute value.

After generating a response to the request at block 304, process 300 proceeds to block 316, where the system outputs the generated response to the request. In some embodiments, the system may be configured to output the response in a graphical user interface (GUI) displayed on a display of a computing device. In some embodiments, the system may be configured to output the response to a software application that submitted the request. For example, the system may output the response through an application program interface (API) to the software application.

FIG. 3B is a flowchart of an illustrative process 350 for generating graphical user interface (GUI) displaying a data entity instance, in accordance with some embodiments of the technology described herein. Process 350 may be performed by any suitable computing device. For example, process 350 may be performed by data processing system 105 described herein with reference to FIGS. 1A-I. In one example, the process 350 may be performed using interfaces 110 of data processing system 105.

Process 350 includes a first block 352, in which the system generates the GUI. In block 352, process 350 begins at block 354, where the system generates a first GUI portion indicating a first attribute value of a particular instance of a first data entity. The first attribute is configured to inherit its value from a second attribute of another instance of a second data entity. At block 356, the system accesses the value inherited from the second attribute. In some embodiments, the system may be configured to access the value inherited from the second attribute by: (1) locating the other instance in memory; and (2) reading the value of the second attribute from the other instance. After accessing the value inherited from the second attribute, process 350 proceeds to block 358, where the system sets the first attribute value to the value inherited from the second attribute.

After generating the first GUI portion at block 354, process 350 proceeds to block 360, where the system generates a second GUI portion to indicate whether the first attribute is configurable to override its inherited value. In some embodiments, the system may be configured to generate a GUI element adjacent a displayed first attribute value (e.g., in the first GUI portion) indicating whether the first attribute is configurable to override its inherited value. For example, the system may generate: (1) a first icon (e.g., a pencil icon) indicating that the first attribute is configurable to override its inherited value; and (2) a second icon (e.g., a lock icon) indicating that the first attribute is not configurable to override its inherited value.

After generating the GUI in block 352, process 350 proceeds to block 362, where the system displays the generated GUI. In some embodiments, the system may be configured to display the GUI in a display (e.g., a monitor) of a computing device. A user of the computing device may be able to recognize from the displayed GUI: (1) whether the first attribute inherits its value from another data entity instance; and (2) whether the first attribute is configurable to override its inherited value. Example GUIs are described herein with reference to FIGS. 4A-G.

FIG. 3C is a flowchart of an illustrative process 370 for generating a request to obtain information about a data entity instance, in accordance with some embodiments of the technology described herein. Process 370 may be performed by any suitable computing device. For example, process 370 may be performed by data processing system 105 described herein with reference to FIGS. 1A-I. In one example, the process 370 may be performed by data entity access system 120 of data processing system 105.

Process 370 begins at block 372, where the system obtains a request to access first attribute value of a particular instance of a first data entity. For example, the request may include a request for a value of the “Business Data Owner” attribute 261 in the data entity instance “Credit Score” 158 of FIG. 2C. In some embodiments, the request may be a database query (e.g., an SQL query). For example, a user may enter a query indicating the request to obtain information. In some embodiments, the request may be programmatically submitted by a software application. For example, a software application of a bank may generate the request in order to access information related to a person's credit score. In some embodiments, the system (e.g., data processing system 105 or a module thereof) may be configured to generate the request.

Next, process 370 proceeds to block 374, where the system generates a response to the request. In block 374, the system proceeds to block 376, where the system determines whether the first attribute is configured to inherit its value from a second attribute of another instance of a second data entity different from the first data entity. In some embodiments, the system may be configured to make the determination by determining whether the first data entity is configured such that the first attribute is configured to inherit its value from the second attribute of the second data entity. For example, the system may access the first data entity (e.g., configuration information in the first data entity) to determine whether the first attribute is configured to inherit its value from the second attribute. In some embodiments, the system may be configured to make the determination by determining whether the particular instance stores information (e.g., a reference) indicating that the first attribute inherits its value from the second attribute of the other instance.

If at block 376, the system determines that the first attribute is configured to inherit its value from the second attribute of the other instance, then process 370 proceeds to block 377, where the system determines whether the second attribute is configured to inherit its value. For example, the second attribute may be configured to inherit its value from a third attribute of an instance of a third data entity different from the first data entity and the second data entity. In some embodiments, the system may be configured to make the determination by determining whether the second attribute is configured to inherit its value from a third attribute of an instance of the third data entity. For example, the system may access the second data entity to determine whether it specifies that the second attribute is configured to inherit its value from the third attribute of the third data entity. In some embodiments, the system may be configured to make the determination by checking whether the other instance stores information (e.g., an attribute value) indicating the third attribute of the instance of the third data entity from which the second attribute is configured to inherit its value.

If, at block 377, the system determines that the second attribute is configured to inherit its value from the third attribute of the instance of the third data entity, then process 370 proceeds to block 376, where the system accesses the value inherited from the third attribute. If so, then the data processing system would further check whether the third attribute of the third data entity instance is configured to inherit its value from a fourth data entity instance at block 377 and so on until the system identifies a value. In this manner, the system may be configured to recursively follow an inheritance path to obtain the first attribute value.

If, at block 377, the system determines that the second attribute is not configured to inherit its value, then process 370 proceeds to block 378, where the system accesses the value inherited from the second attribute of the other instance. In some embodiments, the system may be configured to access the value of the second attribute by: (1) locating the other instance from which the particular instance inherits its first attribute value; and (2) accessing the value of the second attribute in the other instance. For example, the system may locate the other instance in a memory of the system, and access the value of the second attribute. After accessing the value inherited from the second attribute at block 378, process 370 proceeds to block 380, where the system generates a response to the request to include the information indicating the value inherited from the second attribute as the first attribute value. In some embodiments, the system may be configured to generate the response by generating data (e.g., a vector, array, or other data structure) indicating the value inherited from the second attribute as the first attribute value.

If at block 376, the system determines that the first attribute is not configured to inherit its value, then process 370 proceeds to block 382, where the system accesses a value of the first attribute from the particular instance. For example, the particular instance may store a value (e.g., a number, string, or other type of value) for the first attribute. The system may access the value stored by the particular instance for the first attribute. After accessing the value stored in the particular instance, process 370 proceeds to block 384, where the system generates a response to include the value as the first attribute value.

After generating a response to the request at block 374, process 370 proceeds to block 386, where the system outputs the generated response to the request. In some embodiments, the system may be configured to output the response in a graphical user interface (GUI) displayed on a display of a computing device. In some embodiments, the system may be configured to output the response to a software application that submitted the request. For example, the system may output the response through an application program interface (API) to the software application.

FIG. 4A is an illustration of a GUI displaying information about the instance “Credit Score” 402 of the data entity “Business Term” 404, in accordance with some embodiments of the technology described herein. “Credit Score” 402 is an instance of the “Business Term” data entity as indicated by label 404. The GUI 400 indicates a data domain 406 from which “Credit Score” 402 obtains data. In the example of FIG. 4A, “Credit Score” 402 obtains data from the data domain “Credit Risk”. The GUI 400 displays attribute values of “Credit Score” 402. The attribute values include values of data ownership attributes 408. The data ownership attributes include business “Data Owner”, “Business Data Steward”, and “Subject Matter Expert”. Each of the data ownership attributes may have one or more respective values. In the example of FIG. 4A, in “Credit Score” 402, the value of the “Business Data Owner” attribute is “Wade L. Register”, the value of the “Business Data Steward” attribute is “Kaitlyn C. Ogawa”, and the value of “Subject Matter Expert” attribute is “Hugo J. Poiter” and “Donald D. Mace”.

FIG. 4B is an illustration of a GUI displaying information about a data entity instance “Credit Risk” 412 from which attributes of the data entity instance “Credit Score” 402 of FIG. 4A inherits values, in accordance with some embodiments of the technology described herein. The GUI 410 displays attribute values of “Credit Risk” 412. The attribute values include values of data ownership attributes 414. The data ownership attributes 414 include: “Business Data Owner”, “Business Data Steward”, and “Subject Matter Expert”. The data ownership attributes 414 of “Credit Risk” 412 have the following values: the value of “Business Data Owner” is “Wade L. Register”, the value of “Business Data Steward” is “Kaitlyn C. Ogawa”, and the value of “Subject Matter Expert” is “Donald D. Mace” and “Hugo J. Potter”. The data ownership attributes 408 of “Credit Score” 402 are configured to inherit their values from the data ownership attributes 414 of “Credit Risk” 412. Thus, the data ownership attributes 408 of “Credit Score” 402 have the same values as the data ownership attributes 414 of “Credit Risk” 412.

FIG. 4C is an illustration of a GUI for configuring attributes of the data entity “BizTerm” 404 of which “Credit Score” 402 is an instance, in accordance with some embodiments of the technology described herein. The GUI 420 allows configuring attributes of the data entity to inherit values from another data entity. In the example of FIG. 4C, the GUI 420 shows that the attributes “Business Data Owner” 424, “Business Data Steward” 425, and “Subject Matter Expert” 426 of the “BizTerm” data entity 422 are configured to inherit their values from the data entity “Data Domain” as indicated in column 427. For example, “Credit Score” 402 of FIG. 4A is an instance of “BizTerm” 422. The data ownership attributes 408 are configured to inherit their values from an instance of the “Data Domain” data entity. In this example, in “Credit Score” 402 the data ownership attributes 408 are configured to inherit their values from “Credit Risk” 412, which is an instance of the data entity “Data Domain”.

FIG. 4D is an illustration of the GUI 400 of FIG. 4A with a portion 422 indicating information about an attribute of the data entity instance “Credit Score” 402 that is configured to inherit its value, in accordance with some embodiments of the technology described herein. As shown in FIG. 4D, the GUI 400 includes an overlaid GUI portion 422 indicating information about the “Business Data Owner” attribute. The GUI portion 422 indicates that the value of the attribute “Business Data Owner” is inherited from “Credit Risk” 412, which is an instance of the Data Domain data entity. In some embodiments, the GUI 400 may be configured to generate the portion 422 in response to a user input. For example, the GUI 400 may generate the portion 422 when a user hovers a mouse over a displayed attribute name.

FIG. 4E is an illustration of a GUI portion 430 indicating whether attributes of the data entity instance “Credit Score” 402 of FIG. 4A are configurable to override their inherited values, in accordance with some embodiments of the technology described herein. GUI 430 may be generated as a portion of the GUI 400 of FIG. 4A (e.g., when a user selects the “edit” option for the data ownership attributes in FIG. 4A). The GUI 430 displays indications of whether inherited attribute values can be overridden. In the example of FIG. 4E, the GUI 430 displays indications for values of the attributes “Business Data Owner”, “Business Data Steward”, and “Subject Matter Expert”. The lock icon 432 adjacent to the value of the “Business Data Owner” attribute indicates that the value cannot be overridden. The pencil icon 432 next to the value of the “Business Data Steward” attribute indicates that the value can be overridden. The GUI 430 also displays a pencil icon next to the value of the “Subject Matter Expert” attribute. As shown in FIG. 4E, when a user hovers a cursor over the pencil icon, the GUI 430 displays an indication 434 that the value is inherited, and that it can be overridden. The indication 434 states that the user can click to override the inherited value. For example, in response to clicking the pencil icon, the GUI 430 may generate a menu that allows the user to override the inherited value of the attribute “Subject Matter Expert”.

FIG. 4F is another illustration of a GUI portion 440 indicating whether attributes of the data entity instance “Credit Score” 402 of FIG. 4A are configurable to override their inherited values, in accordance with some embodiments of the technology described herein. GUI 440 may be generated as a portion of the GUI 400 of FIG. 4A (e.g., when a user selects the “edit” option for the data ownership attributes in FIG. 4A). As shown in FIG. 4F, when a user hovers a cursor over the lock icon adjacent the value of the “Business Data Owner” attribute, the GUI 440 displays an indication that the attribute is not configurable to override an inherited value.

FIG. 4G is an illustration of a GUI portion 450 indicating information about the source from which an attribute of the data entity instance “Credit Score” 402 of FIG. 4A is configured to inherits its value, in accordance with some embodiments of the technology described herein. GUI 450 may be generated as a portion of the GUI 400 of FIG. 4A (e.g., when a user hovers a cursor over a name of an attribute). GUI 450 includes a portion 452 indicating a data entity instance “Credit Risk” from which the attribute inherits its value. The portion 452 indicates a data entity “Data Domain” that “Credit Risk” is an instance of.

FIG. 5A is a diagram illustrating attribute value inheritance paths among a set of three data entity instances 500, 158, 520, in accordance with some embodiments of the technology described herein. The data entity instances of FIG. 5A may be data entity instances managed by data processing system 105 described herein with reference to FIGS. 1A-I. FIG. 5A shows data entity instance “Customer Credit Score” 500, data entity instance “Credit Score” 158, and data entity instance “Credit Risk” 520.

As shown in FIG. 5A, each of the data entity instances 500, 158, 520 includes a respective set of attributes. Data entity instance “Customer Credit Score” 500 includes a set of static attributes 502 and a set of dynamic attributes 505. The static attributes 502 include the attributes “Name” 503 and “Definition” 504. The dynamic attributes 505 include “Business Data Steward” 506 and “Subject Matter Expert” 507. Data entity instance “Credit Score” 158 includes a set of static attributes 252 and a set of dynamic attributes 255. The static attributes 252 include “Name” 253 and “Definition” 254. The dynamic attributes 255 include “Business Data Steward” 262 and “Subject Matter Expert” 263. Data entity instance “Credit Risk” 520 includes a set of static attributes 522 and a set of dynamic attributes 525. The static attributes 522 include “Name” 523 and “Description” 524. The dynamic attributes 525 include “Business Data Steward” 526 and “Subject Matter Expert” 527.

In the example embodiment of FIG. 5A, the attribute “Business Data Steward” 506 of data entity instance “Customer Credit Score” 500 is configured to inherit its value from attribute “Business Data Steward” 262 of data entity instance “Credit Score” 158 through inheritance path 508a. The attribute “Business Data Steward” 262 is configured to inherit its value from the attribute “Business Data Steward” 526 of data entity instance “Credit Risk” 520 through inheritance path 518a. The attribute “Subject Matter Expert” 507 of data entity instance “Customer Credit Score” 500 is configured to inherit its value from attribute “Subject Matter Expert” 263 of data entity instance “Credit Score” 158 through inheritance path 508b. The attribute “Subject Matter Expert” 263 is configured to inherit its value from the attribute “Subject Matter Expert” 527 of data entity instance “Credit Risk” 520 through inheritance path 518b. In the example configuration of FIG. 5A, the attributes “Business Data Steward” 526 and “Subject Matter Expert” 527 of data entity instance “Credit Risk” 520 may determine: (1) values of attributes “Business Data Steward” 262 and “Subject Matter Expert” 263 of data entity instance “Credit Score” 158; and (2) values of attributes “Business Data Steward” 506 and “Subject Matter Expert” 507 of data entity instance “Customer Credit Score” 500. Accordingly, the “Business Data Steward” 526 and “Subject Matter Expert” 527 are the highest level of inheritance while the attributes “Business Data Steward” 506 and “Subject Matter Expert” 507 are at the lowest level of inheritance.

FIG. 5A shows a computing device 535 through which a user 530 may access information about the data entity instances 500, 158, 520. For example, the user 530 may access information about data entity instance “Customer Credit Score” 500. Table 535 shows a configuration of attributes “Business Data Steward” 506 and “Subject Matter Expert” 507 of data entity instance “Customer Credit Score” 500. The “Source” column of table 535 indicates that the attribute “Business Data Steward” 506 is configured to inherit the value “Bill Smith” from the data entity instance “Credit Risk” 520, and that the attribute “Subject Matter Expert” 507 is configured to inherit the value “Sam Elk” from the data entity instance “Credit Risk” 520. As indicated in the “Override” column of table 535, the attribute “Business Data Steward” 506 is configurable to override an inherited value while the attribute “Subject Matter Expert” 507 is not configurable to override an inherited value.

FIG. 5B is a diagram illustrating an override of a value inherited by an attribute of a data entity instance “Customer Credit Score” 500 of FIG. 5A, in accordance with some embodiments of the technology described herein. The “X” in inheritance path 508a indicates an override of a value of the attribute “Business Data Steward” 262 of data entity instance “Credit Score” 158 inherited by the attribute “Business Data Steward” 506 of the data entity instance “Customer Credit Score” 500. As shown in highlighted portion of table 535, the attribute “Business Data Steward” 506 is overridden and now has a source of “Customer Credit Score”. Accordingly, the attribute “Business Data Steward” 526 of data entity instance “Credit Risk” 520 may not determine a value of the attribute “Business Data Steward” 506 in the data entity instance “Customer Credit Score” 500 in which the override illustrated in FIG. 5B is performed. As shown in FIG. 5B, the attribute “Business Data Steward” 506 of data entity instance “Customer Credit Score” 506 is now populated with the value “Bob Stewart” within the data entity instance “Customer Credit Score” 500.

FIG. 5C is a diagram illustrating an override of a value inherited by an attribute of a data entity instance “Credit Score” 158 of FIG. 5A, in accordance with some embodiments of the technology described herein. The “X” in inheritance path 518a indicates an override of a value of the attribute “Business Data Steward” 526 of data entity instance “Credit Risk” 520 inherited by the attribute “Business Data Steward” 262 of data entity instance “Credit Score” 158. As the attribute “Business Data Steward” 262 has been configured to override the value inherited from the attribute “Business Data Steward” 526, the override modifies the source from which the attribute “Business Data Steward” 506 of data entity instance “Customer Credit Score” 500 inherits its value. As shown in the highlighted portion of table 535, as a result of the override, the source of the attribute “Business Data Steward” 506 has changed from “Credit Risk” (as shown in FIG. 5A) to “Credit Score”. In the configuration illustrated in FIG. 5C, the attribute “Business Data Steward” 506 inherits the override value of “Ben Samuel” from the attribute “Business Data Steward” 262 of data entity instance “Credit Score” 158.

FIG. 6A is an illustration of a GUI 600 displaying information about an instance “Customer Credit Score” 602 of the “Business Data Element” data entity, in accordance with some embodiments of the technology described herein. “Customer Credit Score” 602 includes various attributes. The attributes include a business term attribute with a value of “Credit Score” 604. “Credit Score” 604 is another data entity instance from which attributes of “Customer Credit Score” 602 are configured to inherit values. In the example of FIG. 6A, data owner ship attributes 608 of “Customer Credit Score” 602 are configured to inherit values from “Credit Score” 604. The data ownership attributes 608 include “Business Data Owner”, “Business Data Steward”, “Subject Matter Expert”, and “Technical Data Steward”. The “Customer Credit Score” 602 also includes a “Data Domain” attribute 606. The value of the “Data Domain” attribute 606 may indicate a category to which the “Customer Credit Score” 602 belongs. “Customer Credit Score” 602 is within the credit risk category, which is under the corporate risk hierarchy.

FIG. 6B is an illustration of a GUI 620 displaying information about a configuration of attributes of the data entity instance “Customer Credit Score” 602 of FIG. 6A, in accordance with some embodiments of the technology described herein. In rows 622, 624, and 626, each of the “Business Data Owner”, “Business Data Steward”, and “Subject Matter Expert” attributes is configured to inherit its value from an instance of the “BizTerm” data entity. An example instance of the “BizTerm” data entity is “Credit Score” 402 described herein with reference to FIG. 4A. Attributes of Customer “Credit Score” 602 may be configured to inherit values of the data ownership attributes 608 from “Credit Score” 402. The data ownership attributes 408 of “Credit Score” 402 may be configured to inherit values from data ownership attributes 414 of “Credit Risk” 412 described herein with reference to FIG. 4B. When there is no override in place, the values of the data ownership attributes 608 may be configured to inherit the values of the data ownership attributes 414 of “Credit Risk” 412.

FIG. 6C is an illustration of a GUI 630 displaying information about an attribute of “Customer Credit Score” 602, in accordance with some embodiments of the technology described herein. As shown in FIG. 6C, the GUI 630 includes an overlaid portion 632 displaying information about the “Business Data Steward” attribute. The overlaid portion 632 indicates that the attribute value is inherited from the data entity instance “Credit Score”, which is an instance of the Business Term data entity. For example, the “Business Data Steward” attribute value inherited by “Credit Score” 402 from “Credit Risk” 412 may be overridden (e.g., due to a user override). Accordingly, in this example, the overlaid portion 632 indicates that the source of the attribute value is “Credit Score”. In some embodiments, the GUI 630 may be configured to generate the overlaid portion 632 in response to a user input in the GUI. For example, the GUI 630 may generate the overlaid portion 632 when the user hovers a cursor over the name of the attribute in the GUI 430.

FIG. 6D is an illustration of a GUI 640 displaying information about an attribute of “Customer Credit Score” 602, in accordance with some embodiments of the technology described herein. As shown in FIG. 6D, the GUI 640 includes an overlaid portion 642 displaying information about the “Subject Matter Expert” attribute. The overlaid portion 642 indicates that the attribute value is inherited from “Credit Risk”, which is an entity of the Data Domain data entity. For example, the “Subject Matter Expert” attribute may be configured to inherit its value from the data entity instance “Credit Score”, which is configured to inherit its value from the data entity instance “Credit Risk”. In this example, there is no override and thus the overlaid portion 642 indicates that the source of the attribute value is the data entity instance “Credit Risk”.

In some embodiments, the GUI 640 may be configured to generate the overlaid portion 642 in response to a user input in the GUI. For example, the GUI 640 may generate the overlaid portion 642 when the user hovers a cursor over the name of the attribute in the GUI 440.

### Example Computer System

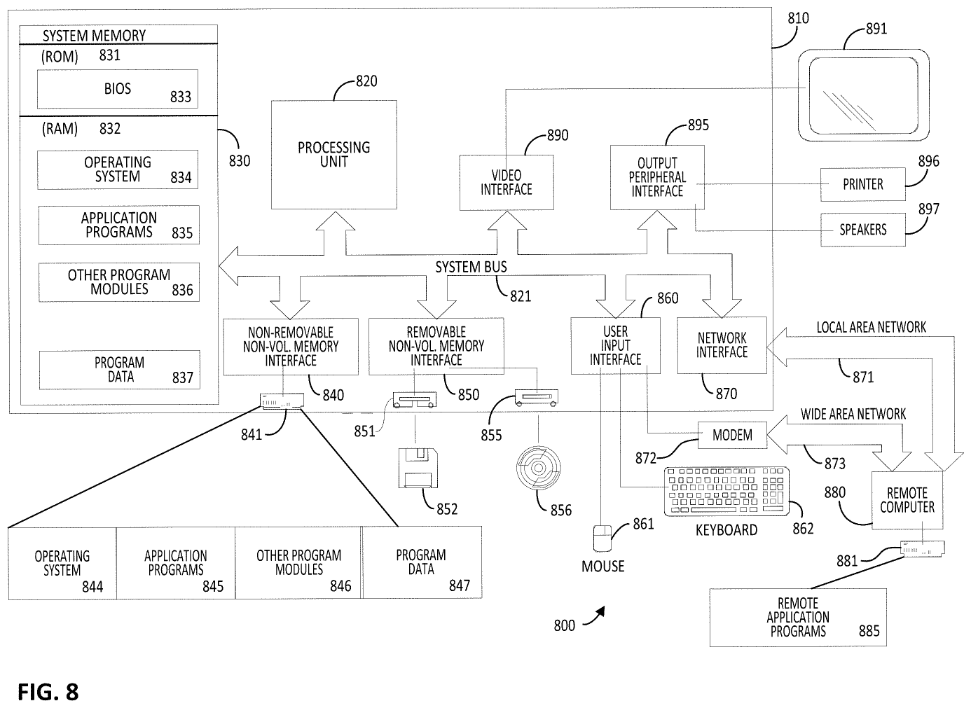

FIG. 8 illustrates an example of a suitable computing system environment 800 on which the technology described herein may be implemented. The computing system environment 800 is only one example of a suitable computing environment and is not intended to suggest any limitation as to the scope of use or functionality of the technology described herein. Neither should the computing environment 800 be interpreted as having any dependency or requirement relating to any one or combination of components illustrated in the exemplary operating environment 800.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 8, an exemplary system for implementing the technology described herein includes a general purpose computing device in the form of a computer 800. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a flash drive 851 that reads from or writes to a removable, nonvolatile memory 852 such as flash memory, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media described above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. An actor may enter commands and information into the computer 810 through input devices such as a keyboard 862 and pointing device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include a local area network (LAN) 881 and a wide area network (WAN) 883, but may also include other networks. Such networking environments are commonplace in offices, enterprise-wide computer networks, intranets and the Internet.

When used in a LAN networking environment, the computer 810 is connected to the LAN 881 through a network interface or adapter 880. When used in a WAN networking environment, the computer 810 typically includes a modem 882 or other means for establishing communications over the WAN 883, such as the Internet. The modem 882, which may be internal or external, may be connected to the system bus 821 via the actor input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on memory device 881. It will be appreciated that the network connections shown are exemplary and other means of establishing a communications link between the computers may be used.

Having thus described several aspects of at least one embodiment of the technology described herein, it is to be appreciated that various alterations, modifications, and improvements will readily occur to those skilled in the art.

Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. As used herein, the term “computer-readable storage medium” encompasses only a non-transitory computer-readable medium that can be considered to be a manufacture (i.e., article of manufacture) or a machine. Alternatively or additionally, aspects of the technology described herein may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion amongst a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 3 and 7. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by an “actor” or a “user”. It should be appreciated that an “actor” or a “user” need not be a single individual, and that in some embodiments, actions attributable to an “actor” or a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method performed by a data processing system for accessing data, in a computationally efficient manner, according to inheritance relationships among attributes of data entities, where such inheritance can be overridden, the method comprising:
using at least one computer hardware processor of the data processing system to perform:
receiving a request to access a first attribute value of a particular instance of a first data entity, wherein:
the first data entity comprises a plurality of attributes including the first attribute,
the particular instance comprises a value for zero, one, or more of the plurality of attributes of the first data entity, and
the first attribute of the particular instance is configured to inherit its value from a second attribute of another instance of a second data entity different from the first data entity,
determining whether the first attribute of the particular instance is configured to override the value inherited from the second attribute; and
when it is determined that the first attribute is configured to override the value inherited from the second attribute:
accessing an overriding value for overriding the value inherited from the second attribute;
generating a first response to the request that includes information indicating the overriding value as the first attribute value; and
outputting the first response; and
when it is determined that the first attribute is not configured to override the value inherited from the second attribute:
accessing the value inherited from the second attribute;
generating a second response to the request that includes information indicating the value inherited from the second attribute as the first attribute value; and
outputting the second response.

2. The method of claim 1, wherein the first data entity includes information indicating: (i) that the first attribute inherits its value from the second attribute; and (ii) whether the first attribute is configurable to override its inherited value.

3. The method of claim 1, wherein:
the data processing system comprises at least one data store configured to store instances of the data entities, the instances of the data entities including the particular instance and the other instance; and
the request comprises an executable query.

4. The method of claim 3, wherein the executable query comprises an executable structured query language (SQL) query.

5. The method of claim 1, wherein the particular instance comprises multiple attribute values, wherein each of at least some of the multiple attribute values is inherited from a respective instance of a different data entity.

6. The method of claim 1, wherein the second attribute of the other instance is configured to inherit its value from a third attribute of an instance of a third data entity different from the second data entity and the first data entity.

7. The method of claim 6, wherein accessing the value inherited from the second attribute comprises:
determining whether the second attribute of the other instance is configured to override the value inherited from the third attribute; and
when it is determined that the second attribute of the other instance is configured to override the value inherited from the third attribute:
accessing another overriding value for overriding the value inherited from the third attribute as the value inherited from the second attribute; and
when it is determined that the second attribute of the other instance is not configured to override the value inherited from the third attribute:
accessing the value inherited by the second attribute from the third attribute.

8. The method of claim 1, wherein the outputting comprises:
generating a graphical user interface (GUI) that displays:
the first attribute value; and
information indicating whether the first attribute value is inherited.

9. The method of claim 1, wherein the particular instance includes respective values for a first plurality of attributes including the first attribute, the first plurality of attributes being configured to inherit their values from a respective second plurality of attributes of the other instance, wherein the request comprises a request to access the values of the first plurality of attributes, and wherein the method further comprises:
grouping the first plurality of attributes into a single group; and
generating a single executable query for the single group in accordance with the request, wherein the single executable query, when executed by the data processing system, causes the data processing system to generate a response to the request.

10. The method of claim 9, wherein grouping the first plurality of attributes into the single group comprises grouping the first plurality of attributes into the single group using a grouping criterion.

11. The method of claim 9, wherein the grouping criterion is to group attributes that inherit values from a common instance into the single group.

12. The method of claim 1, wherein the data processing system comprises at least one data store configured to store information defining relationships among multiple data entity instances.

13. The method of claim 1, wherein the data processing system manages the data, wherein the data managed by the data processing system comprises information describing data stored in distributed databases of a distributed network of computing systems.

14. The method of claim 13, wherein the data processing system is configured to store an instance for each of multiple datasets stored by the distributed databases of the distributed computing system and/or for each of multiple software applications configured to be executed by the distributed computing systems.

15. The method of claim 1, wherein the method further comprises:
generating a first portion of a graphical user interface (GUI) indicating the first attribute value;
setting the first attribute value indicated by the GUI to the second attribute value; and
displaying the GUI.

16. The method of claim 15, wherein the method further comprises:
determining whether the first attribute is configurable to override its inherited value; and
generating a second portion of the GUI indicating that the first attribute is configurable to override its inherited value when it is determined that the first attribute is configurable to override its inherited value.

17. The method of claim 16, wherein generating the second portion of the GUI comprises:
enabling a user to specify, through the second portion of the GUI, the overriding value for overriding the value inherited from the second attribute.

18. The method of claim 16, wherein the method further comprises:
generating a second portion of the GUI indicating that the first attribute is not configurable to override its inherited value when it is determined that the first attribute is not configurable to override its inherited value.

19. The method of claim 1, wherein the method further comprises:
preventing overriding of the value inherited from the second attribute of the other instance.

20. The method of claim 1, wherein the method further comprises:
generating a GUI allowing a user to configure the first data entity such that the first attribute inherits its value from the second attribute.

21. The method of claim 1, wherein the method further comprises:
generating a GUI displaying information indicating a source of the first attribute value.

22. The method of claim 21, wherein the GUI is configured to display the information indicating the source of the first attribute value in response to a mouse-over event.

23. The method of claim 21, wherein the information indicating the source of the first attribute value indicates that the source is the second attribute of the other instance or that the source is an overriding value.

24. At least one non-transitory computer-readable medium storing instructions that, when executed by a data processing system, cause the data processing system to perform a method for accessing data according to inheritance relationships among attributes of data entities, where such inheritance can be overridden, the method comprising:
receiving, by the data processing system, a request to access a first attribute value of a particular instance of a first data entity, wherein:
the first data entity comprises a plurality of attributes including the first attribute,
the particular instance comprises a value for zero, one, or more of the plurality of attributes of the first data entity, and
the first attribute of the particular instance is configured to inherit its value from a second attribute of another instance of a second data entity different from the first data entity;
determining whether the first attribute of the particular instance is configured to override the value inherited from the second attribute;
when it is determined that the first attribute is configured to override the value inherited from the second attribute:
accessing an overriding value for overriding the value inherited from the second attribute;
generating a first response to the request that includes information indicating the overriding value as the first attribute value; and
outputting the first response; and
when it is determined that the first attribute is not configured to override the value inherited from the second attribute:
accessing the value inherited from the second attribute;
generating a second response to the request that includes information indicating the value inherited from the second attribute as the first attribute value; and
outputting the second response.

25. A method performed by a data processing system for accessing data according to inheritance relationships among attributes of data entities, the method comprising:
using at least one computer hardware processor of the data processing system to perform:
receiving a request to access a first attribute value in a particular instance of a first data entity, wherein:
the first data entity comprises a plurality of attributes including the first attribute; and
the particular instance comprises a value for zero, one, or more of the plurality of attributes of the first data entity;
determining that the first attribute of the particular instance is configured to inherit its value from a second attribute of another instance of a second data entity different from the first data entity;
accessing the value inherited from the second attribute;
generating a response to the request that includes information indicating the value inherited from the second attribute as the first attribute value; and
outputting the generated response.

26. A data processing system for accessing data according to inheritance relationships among attributes of data entities, where such inheritance can be overridden, the data processing system comprising:
at least one computer hardware processor; and
at least one non-transitory computer-readable medium storing instructions that, when executed by the at least one computer hardware processor, cause the at least one computer hardware processor to perform a method comprising:
receiving a request to access a first attribute value of a particular instance of a first data entity, wherein:
the first data entity comprises a plurality of attributes including the first attribute,
the particular instance comprises a value for zero, one, or more of the plurality of attributes of the first data entity, and
the first attribute of the particular instance is configured to inherit its value from a second attribute of another instance of a second data entity different from the first data entity,
determining whether the first attribute of the particular instance is configured to override the value inherited from the second attribute; and
when it is determined that the first attribute is configured to override the value inherited from the second attribute:
accessing an overriding value for overriding the value inherited from the second attribute;
generating a first response to the request that includes information indicating the overriding value as the first attribute value; and
outputting the first response; and
when it is determined that the first attribute is not configured to override the value inherited from the second attribute:
accessing the value inherited from the second attribute;
generating a second response to the request that includes information indicating the value inherited from the second attribute as the first attribute value; and
outputting the second response.
